(19) United States
(12) Patent Application Publication
(10) Pub. No.: US 2016/0117372 A1
(43) Pub. Date: Apr. 28, 2016

(54) SOFTWARE APPLICATION THAT DETERMINES THE OPTIMAL TIMES FOR OUTDOOR ACTIVITIES BASED ON OUTDOOR CONDITIONS

(71) Applicant: KrafftlT AB, Los Angeles, CA (US)

(72) Inventor: Fredrik Krafft, Los Angeles, CA (US)

(21) Appl. No.: 14/526,399

(22) Filed: Oct. 28, 2014

(51) Int. Cl. G06F 17/30; G06F 3/0484; G06F 3/0488; G06F 3/0482

(52) U.S. Cl. CPC G06F 17/30572; G06F 3/0482; G06F 3/04842; G06F 3/04847; G06F 3/04886; G06F 2203/04803; G06F 2203/04808

(57) ABSTRACT

Users of mobile devices may be concerned about outdoor conditions while engaged in outdoor activities. A software application for mobile devices can provide access to data representing various outdoor conditions, such as pollution, pollen, weather, sun. etc., and can suggest to the user optimal times in which to engage in the activity and avoid one or more of the undesirable conditions. In various embodiments, the software application may display the data on a graph and/or a map. The software application may also determine the accumulated value of the data for a given time period, and provide the lowest accumulated value and the time at which it occurs, the highest accumulated value and the time at which it occurs, and/or a minimum accumulated value for one or more periods of one or more days. The software application may also display these values on a meter.

### INTRODUCTION

Users of mobile devices may be concerned about conditions out-of-doors while engaging in outdoor activities. Users may be concerned about, for example, air pollution, pollen levels, sun exposure, rain, temperature, the time of sunrise or sunset, traffic, crime, and other conditions he or she may encounter when outside. Users thus may wish to time their activities to coincide with the lowest occurrence of one or more of the conditions of concern. Users, however, may not have access to the necessary data to determine when the optimal times are, and if they do have access to the data, it may not be available in a convenient way for making decisions. A software application for mobile devices can provide access to the data, as well as an interface that allows users to quickly enter the user's desired timeframes to engage in an activity. The software application can thus suggest to the user optimal times in which to engage in the activity and avoid one or more of the undesirable conditions.

Users of mobile devices may also be concerned about air quality indoors. Indoor air quality can be affected by airflow thrown open windows and doors. Users may wish to track indoor air quality, but may not have access to the necessary data to do so. A software application for mobile devices can provide access to the data, as well as provide users with an estimation of the current indoor air quality of a given location.

### FIGURES

The novel features of the embodiments described herein are set forth with particularity in the appended claims. The embodiments, however, both as to organization and methods of operation may be better understood by reference to the following description, taken in conjunction with the accompanying drawings as follows:

FIG. 1A illustrates one embodiment of the main screen of a software application for mobile devices that provides users with suggested times for engaging in an activity for a given duration and in a specified location, based one or more conditions;

FIG. 1B illustrates an embodiment of the main screen when the current accumulated value is greater than the accumulated value for the selected timeframe;

FIG. 1C illustrates one embodiment of the main screen with a pop-up window for selecting the data type;

FIG. 1D illustrates one embodiment of a multiple selections screen;

FIG. 1E illustrates one embodiment of a small map screen of the software application for mobile devices;

FIG. 1F illustrates one embodiment of a large map screen for the software application for mobile devices;

FIG. 1G illustrates one embodiment of a main screen with heart rate monitoring activated;

FIG. 1H illustrates one embodiment of the main screen with a pop-up window for setting a location;

FIG. 1I illustrates one embodiment of a first help or tutorial screen;

FIG. 1J illustrates one embodiment of an active timeframe screen;

FIGS. 1K and 1L illustrate an embodiment of the active timeframe screen where the graph has been configured to display the accumulated exposure value;

FIG. 1M illustrates an embodiment of sensor screen;

FIG. 2A illustrates one embodiment of the main screen of a software application for mobile devices that provides users with suggested times for engaging in an activity for a given duration and in a specified location, based on outdoor conditions;

FIG. 2B illustrates the main screen when the current accumulated value is greater than the accumulated value for the selected timeframe;

FIG. 2C illustrates one embodiment of a small map screen of the software application for mobile devices;

FIG. 2D illustrates one embodiment of a large map screen for the software application for mobile devices;

FIG. 2E illustrates one embodiment of a suggestion screen for the software application for mobile devices;

FIG. 2F illustrates one embodiment of a pop-up window for selecting a time period on the suggestion screen;

FIG. 2G illustrates one embodiment of the main screen with heart rate monitoring activated;

FIG. 2H illustrates one embodiment of a main screen with multiple displays;

FIG. 2I illustrates one embodiment of an active timeframe screen;

FIG. 3A illustrates another embodiment of the main screen of a software application for mobile devices that provides users with suggested times for engaging in an activity for a given duration and in a specified location based on outdoor conditions;

FIG. 3B illustrates an embodiment of the main screen with alternate location data;

FIG. 3C illustrates a first help or tutorial screen for the main screen;

FIG. 3D illustrates a second help or tutorial screen for the main screen;

FIG. 3E illustrates a third help or tutorial screen for the main screen;

FIG. 3F illustrates one embodiment of a suggestion screen;

FIG. 3G illustrates a help or tutorial screen for the suggestion screen;

FIG. 3H illustrates a location selection screen;

FIG. 3I illustrates one embodiment of a multiple selections screen;

FIG. 3J illustrates a first help or tutorial screen for the multiple selections screen;

FIG. 3K illustrates a second help or tutorial screen for the multiple selections screen;

FIG. 3L illustrates an embodiment of a daily total value screen;

FIG. 3M illustrates one embodiment of a small map screen;

FIG. 3N illustrates one embodiment of a large map screen;

FIG. 4A illustrates another embodiment of the main screen;

FIG. 4B illustrates an embodiment of the main screen with alternate location data;

FIG. 4C illustrates a first help or tutorial screen for the main screen;

FIG. 4D illustrates a second help or tutorial screen for the main screen;

FIG. 4E illustrates a third help or tutorial screen;

FIG. 4F illustrates one embodiment of a multiple selections screen;

FIG. 4G illustrates a first help or tutorial screen for the multiple selections screen;

FIG. 4H illustrates an embodiment of a daily total value screen;

FIG. 4I illustrates an embodiment of a help or tutorial screen for the daily total value screen;

FIG. 5A illustrates another embodiment of the main screen of a software application for mobile devices that provides users with suggested times for engaging in an activity for a given duration and in a specified location based on outdoor conditions;

FIG. 5B illustrates a first help or tutorial screen for the main screen;

FIG. 5C illustrates one embodiment of a suggestion screen;

FIG. 6 illustrates another embodiment of the main screen of a software application for mobile devices;

FIG. 7A illustrates an embodiment of a main screen of a software application for mobile devices;

FIG. 7B illustrates one embodiment of a suggestion screen;

FIG. 8 illustrates an embodiment of a main screen of a software application for mobile devices;

FIG. 9A illustrates another embodiment of the main screen of a software application for mobile devices that provides users with suggested times for engaging in an activity for a given duration and in a specified location based on outdoor conditions;

FIG. 9B illustrates one embodiment of a suggestion screen;

FIG. 10 illustrates another embodiment of a main screen for the software application for mobile devices;

FIG. 11A illustrates one embodiment of a main screen of a software application for mobile devices that may have a lower resolution and/or smaller display area such as may be found, for example, on a wrist-worn mobile device;

FIG. 11B illustrates one embodiment of a main screen for mobile device that may have a lower resolution and/or smaller display area, with multiple displays;

FIG. 11C illustrates one embodiment of an active timeframe screen for a mobile device that may have a lower resolution and/or smaller display area;

FIG. 11D illustrates one embodiment of the active timeframe screen for a mobile device that may have a lower resolution and/or a smaller display area, with multiple displays;

FIG. 11E illustrates one embodiment of a main screen for a mobile device that may have a lower resolution and/or a smaller display area, with a single display;

FIG. 11F illustrates one embodiment of a suggestion screen for a mobile device that may have a lower resolution and/or a smaller display area;

FIG. 12A illustrates one embodiment of a process that may be implemented by any of the main screens described above, such as for instance the main screen of FIG. 1A;

FIG. 12B illustrates one embodiment of a process that may be implemented by any of the map screens described above, such as for instance the small map screen of FIG. 1E;

FIG. 12C illustrates one embodiment of a process that may be implemented by any of the active timeframe screens described above, such as for instance the active timeframe screen of FIG. 1L;

FIG. 13 illustrates one embodiment of a process for using an image of the sky to extrapolate the air quality of a location;

FIG. 14A is a schematic view of an illustrative electronic device capable of implementing the systems and methods described herein;

FIG. 14B shows one embodiment of the input/output subsystem of the electronic device shown in FIG. 14A;

FIG. 14C shows one embodiment of the communication interface; and

FIG. 14D shows one embodiment of the memory subsystem;

### DESCRIPTION

Before explaining the various aspects of a software application for mobile devices that provides users with suggested times for engaging in an activity for a given duration and in a specified location, based on outdoor conditions in detail, it should be noted that the various aspects disclosed herein are not limited in their application or use to the details of construction and arrangement of parts illustrated in the accompanying drawings and description. Rather, any disclosed aspect of the software application may be positioned or incorporated in other aspects, variations, and modifications thereof, and may be practiced or carried out in various ways. Accordingly, aspects of the software application disclosed herein are illustrative in nature and are not meant to limit the scope or application thereof. Furthermore, unless otherwise indicated, the terms and expressions employed herein have been chosen for the purpose of describing the aspects for the convenience of the reader and are not to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

In the following description, like reference characters designate like or corresponding parts throughout the several views. Also, in the following description, it is to be understood that terms such as front, back, inside, outside, top, bottom and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

### BACKGROUND

The present disclosure describes various embodiments directed to software applications that improve the usefulness of mobile devices and mobile device systems by providing the user of a mobile device with information about the user's environment and suggesting optimal times for certain activities related to the user's environment.

Mobile devices include electronic computing devices that are portable and provide users with a display and input interface. A mobile device may include a processor, an operating system, a display device, an input device, memory, communications interfaces, and related hardware and software. Examples of mobile devices include laptops, netbooks, personal digital assistants, smartphones, smart watches, tablet computers, and all other electronic computing devices capable of operating without a hardwired connection to power sources and/or communications mediums. Mobile device systems include a mobile device and one or more additional devices that are operable to communicate with the mobile device, either by a wired or wireless connection. Such additional devices may include another mobile device, such as a smartphone or smart watch, or other electronic devices, such as sensors, switches, monitors, and the like.

A user of a mobile device may be concerned about the air quality when the user is out of doors. For example, the user may wish to engage in an outdoor activity for a certain duration of time (for instance 1.5 hours) and may wish to know when, possibly between today and tomorrow, the accumulated air pollution is the lowest. Various embodiments described herein provide a software application for providing the user with air quality information and optimal times to be out of doors for an activity, which will allow the user to decide when would be an appropriate time to be outside.

A user of a mobile device may also desire traffic information to decide when would be a more or less better time to travel. For example, a user traveling from work to home may wish to know at what time traffic is optimal for making the trip. For example, traffic in the user's region may be lowest between 4:00 pm and 5:00 pm. Various embodiments of a software application provide the user with traffic information and optimal times to avoid traffic between specified destinations, which help the user to decide when may be an optimal time to go to a defined destination. Additionally, various embodiments describe how current traffic information changes what would otherwise be normal or average conditions. In various embodiments, the software application may provide the user with suggested times to go to a specific place, as well as a best route, based on statistical data about traffic over time. The user may be able to specify a start and end destination, and the software application may be able to estimate how much time the trip would take at different times of the day. Based on this information, the software application may be able to suggest a minimum travel time and/or route based on traffic conditions.

A user of a mobile device may wish to visit a neighborhood or area with which he or she is not familiar, and thus may be concerned about personal safety. Various embodiments of a software application provide the user with crime statistics for a specified area at given times, so that the user can decide on the most appropriate time to visit the area. Users who live in or frequent areas with recorded levels of high crime may use such information to adjust their plans to avoid unnecessary risks. Users who visit areas known to have high crime rates may use the information to plan the statistically safest times for their visits. Crime statistics may be available from public data sources, such as police maps indicating where and when crimes have happened. Such data can be used by the software application to show crime levels in a given area at various times of the day. The software application can further suggest an optimal time to engage in an activity in the designated area. The software application may further display crime rates on a map.

A user of a mobile device may be concerned about the weather and/or degree of sun exposure the user may encounter in a specific area. Various embodiments of a software application provide the user with information about the degree of sun exposure he or she will encounter at given times of the day, and further provides suggestions for optimal times for the user to visit an area. In various embodiments, the software application provides an estimate of the total amount of rain the user may encounter at a certain time and place; the degree of cloud cover and, by extension, the degree of sun exposure at a certain time and place; the times of sunset and sunrise, possibly illustrated on a graph and/or a map; and the total sun exposure between a start time and end time, given the predicted weather.

The software applications described above may be standalone, independent applications, and/or may be incorporated into a single encompassing application. The encompassing application may provide a database for the data upon which each individual application runs, and may further provide data delivery to each of the individual applications. The encompassing application may improve the usability of a mobile device by providing the user with an extensive array of information about the user's immediate environment.

Further embodiments describe additional improvements to the usefulness of mobile devices. Various embodiments provide a software application for purchasing products at a store. For example, the user can scan the barcode, International Article Number (EAN) code, or other identifying information located on the desired product. When the user is ready to pay, the user can scan a code at the pay station, pay through an application on the mobile device, and receive a paper receipt or a digital receipt sent directly to the mobile phone. The user can alternatively pay at the pay station with another form of payment.

Various embodiments provide a software application for tracking the movement of bulk-packaged products. Bulk-packaged products may comprise, for example, food packed in plastic pallets, or non-perishable merchandise packed on wooden pallets. A mobile device that incorporates Near-Field Communication (NFC) can communicate with a pallet that includes an NFC radio chip to register the pallet and/or the company that has current responsibility for it. Alternatively or additionally, the mobile device can scan a barcode or EAN code associated with the pallet to register the pallet. Alternatively or additionally, the mobile device can take a photograph of the pallet to register the pallet.

### Overview

In various embodiments, a software application for mobile devices that provides users with suggested times for engaging in an activity for a given duration and in a specified location, based on one or more conditions. Various embodiments of the software application provide pollution prediction, pollen prediction, weather and/or sun prediction, and/or direct advertising.

In some embodiments, the software application provides pollution prediction. The software application may provide users with suggested times and/or locations for engaging in an activity, based on pollution levels at those times and locations. In areas where pollution levels are a concern, users of mobile devices may wish to time their errands or outdoor activities according to the current pollution level. The software application can assist these users by suggesting an optimal time to engage in an activity based on the user's schedule and the duration of the activity. The software application may provide the total accumulated pollution for the given duration, in addition to providing the pollution level at a particular instance of time. The software application may suggest timeframes several days into the future, such as for instance up to four days into the future. Pollution data may be provided by government sources, and/or sensors in communication with the mobile device.

In some embodiments, the software application provides pollen prediction. Users of mobile devices who are allergy sufferers may wish to time outdoor activities for periods when the pollen level is the lowest. The software application may assist these and other users by suggesting an optimal time to engage in an activity based on the user's schedule and the duration of the activity. The software application may suggest timeframes several days into the future, such as for instance up to four days from the present day. Pollen data may be provided by government sources, and/or sensors in communication with the mobile device.

In some embodiments, the software application provides weather and/or sun predictions. The software application may provide users of mobile devices with current and predicted weather for a given locale, as well as the times of sunrise and sunset. Additionally, the software application may provide users with an estimation of the total sun exposure for a given duration and location. The software application may also provide users with an estimation of the total rain fall for a given duration and location. The software application may assist users by suggesting an optimal time to engage in an activity based on the user's schedule and the duration of the activity.

In some embodiments, the software application provides useful suggestions to the user in the form of targeting advertising. The software application may be aware of the user's activities and location, and suggest useful local products or services. For example, the software application may be aware the that the user is jogging; thus when the user is near a grocery store, the software application may suggest to the user that he or she can buy an energy bar at the grocery store. The targeted advertising may be useful not only to the user, but also to the grocery store and the provider of the energy bar.

### Features

In various embodiments, the software application for mobile devices provides various features based on the data and functionality described in greater detail below. Various embodiments of the software application provide suggested lowest pollution time, suggested lowest pollen time, maps and suggested lowest pollution and/or pollen in an area, outdoor conditions, more precise pollution data, more precise pollen data, average pollution and/or pollen information, the relative risk of engaging in a physical activity given outdoor conditions, indoor pollution and/or pollen conditions, exercise tracking and suggestions, activity history, the ability to share and/or export data, various method of specifying a location, health tips, and/or advertise to the user based on the user's activity and/or location. The pollution and/or pollen level is also referred to herein as the overall air quality, though it is understood that the overall air quality may describe factors other than pollution and/or pollen, such as for instance air temperature, dust, humidity, smoke, etc.

In some embodiments, the software application may provide suggested times for when the overall pollution level in a given location is the lowest. The software application may provide a time and date for a given activity, such that the activity can be undertaken when the pollution level is the lowest. The suggestions may be, for example, as far as four days into the future.

In some embodiments, the software application may provide suggested times for when the overall pollen level in a given location is the lowest. The software application may provide a time and date for a given activity, such that the activity can be undertaken when the pollen level is the lowest. The suggestions may be, for example, as far as four days into the future.

In some embodiments, the software application may provide maps and suggest areas where the pollution and/or pollen levels are the lowest. The software application may suggest that the overall air quality level in one area is lower than in an area designated by the user. The user may limit the suggestions by distance and/or travel time. The suggestions may be displayed on a map.

In some embodiments, the software application may provide outdoor conditions, such as for instance the current weather in a designated area, and/or the sunrise and sunset times.

In some embodiments, the software application may provide more precise pollution information. For example, the software application may provide the level of specific pollution types, as well as the overall pollution level. The software application may also provide predictions of the pollution level for smaller areas.

In some embodiments, the software application may provide more precise pollen information. For example, the software application may provide the level of specific pollen types, as well as the overall pollution level. The software application may also provide predictions of the pollution level for smaller areas.

In some embodiments, the software application may provide average pollution and/or pollen information. For example, the software application may track the average exposure of the user to pollution and/or pollen over time, and display these averages in a table or on a graph. The software application may also track the suggested times it has given to the user, and optionally display these times in the same table or on the same graph. In some embodiments, the software application may also provide the user's accumulated exposure to pollution and/or pollen over time.

In some embodiments, the software application may provide an estimate of the relative risk of engaging in a physical activity given outdoor conditions. The estimate of the relative risk can be based on, for example, how much pollution and/or pollen the user will be exposed to for a given duration and location, as well as the intensity of the user's activity. The estimate can additionally or alternatively be based on the weather and/or amount of sun the user may be exposed to.

In some embodiments, the software application may provide indoor pollution and/or pollen conditions. The software application may be operable to estimate the level of pollution and/or pollen present within a building. The software application may also be operable to manually and/or automatically open or close windows and/or doors based on the level of pollution and/or pollen within the building or immediately outside the building.

In some embodiments, the software application may provide exercise tracking and suggestions. The software application may suggest where to engage in an exercise activity specified by the user as well as how long to engage in that activity, where the suggestion is based on the overall air quality in the area for the given duration. The software application may also collect exercise data, such as for instance where the user went while engaging in the exercise and the calories burned. The software application may also be operable to suggest routes in the area selected by the user for engaging in the exercise. The software application may also suggest routes having a particular quality, such as for instance, routes have a large amount of vegetation (e.g., “green” routes). In such embodiments, the software application may access images of an area, analyze the images to determine which exhibit the desired quality, and include only paths that exhibit the desired quality in determining a suggested route.

In some embodiments, the software application may provide the activity history of the user. The software application may track the user's usage of the software applications features, so that the user can recreate a routine.

In some embodiments, the software application may provide the ability to share and/or export the user's data. The software application may provide the user with the option to share information about an activity the user wishes to engage in, as well as plan activities based on the shared information of other users. The ability to export the user's data may allow the user to back up his or her data and/or add the activity to a calendar application. The software application may also use calendar information to when providing suggested times to the user, such that the suggestions take into account when the user's unscheduled or free time.

In some embodiments, the software application may provide various methods with which the user can specify a location. The user may be able to specify a zip code, a street address, a longitude and latitude, a geographical feature (such as a mountain, river, ocean forest, etc.), a man-made feature (such as a building, monument, park, street, business, etc.), and/or a GPS position.

In some embodiments, the software application may provide health tips. The software application may use, for example, overall air quality information, weather information, and/or sun exposure information to make health suggestions to the user. The software application may also suggest products and/or services to the user based on this information, and/or the user's tracked activity.

In some embodiments, the software application may provide advertisements to the user based on the user's current activity and location. For example, the software application may suggest to a user who is jogging near a grocery store that the user buy an energy bar from the grocery store.

### Data Overview

The various features described above make use of various generally publically available data, including pollution data, pollen data, weather data, and/or sunrise and sunset data, among others. The data is generally provided as discreet data over time, that is, a data value for each time interval, such as for instance per minute, per ten minutes, per thirty minutes, hourly, daily, etc.

Pollution data may include ozone (O3) and fine particle (PM2.5) data. Such data may be available on an hourly basis for up to, for example, two or four days. Pollution data may also include dust, fire, smoke, nitrogen dioxide (NO2), sulfur dioxide (SO2), carbon monoxide (CO), and/or particle pollution (PM10). The pollution data may include an average of each pollution type and/or all pollution types. The pollution data may for a large area or a relatively small area. Pollution data may be provided by geographic region and/or on maps.

Pollen data may include various different kinds of pollen that may be found in a given area, such as flower pollens, tree pollens, grass pollens, etc. The pollen data may be for large areas or relatively small areas. Pollen data may be provided by geographic region and/or on maps.

The data may also include an average of pollution and pollen for a given area.

Weather data may include temperature, humidity, precipitation, wind strength and direction, etc. for a given area. Sun data includes the sunrise and sunset times at a given location.

### Tools Overview

Various tools operate on the above-described data to provide the various features described above.

A location tool provides the user with an interface to specify a location and/or inform the user where he or she is presently located. The specified location may subsequently be used by other tools. In some embodiments, the location tool may use a zip code to specify a location. In other embodiments, the location tool may use a more precise method to specify a location, such as a street address, a longitude and latitude, a geographical feature, a man-made feature, and/or a relative position.

A graph tool may display any of the described data over time. The graph tool may also display one or more timeframes, including the start and end times and duration of each timeframe. The graph tool may allow the user to change the selected timeframe, including the start time and end time. In some embodiments the graph tool may allow the user to select multiple timeframes and with the same or different durations. Other tools may then make comparisons between the selected timeframes. The graph tool may also provide an option to set an alarm when a selected timeframe is imminent or has been reached.

A share and/or export and/or import tool provides the user with the ability to share and/or export his or her data. A share tool may allow the user to share, for instance, an activity the user is or will engage in and at what time. An export tool may also allow the user to export data to another application; for example the export tool may allow the user to put a planned activity in a calendar application. An import tool may allow the user to import data from other applications; for example, the import tool may import data from a calendar application, and include the user's unscheduled time in determining suggested timeframes.

A meter tool displays how a selected timeframe relates to all other possible timeframes. A timeframe comprises a start time and duration or period of time. The meter tool may compare a selected timeframe against all other possible timeframes of the same duration, and show to the user if the user's selected timeframe is better or worse, and how much so, than all other possible timeframes of the same duration. In some embodiments, the meter tool may also include in the comparison the present or current time, such that the user can evaluate engaging in an activity now as against engaging in that activity at a future time. In some embodiments, the meter tool may allow the user to select multiple timeframes to compare against all possible timeframes. In some embodiments, the meter tool may also display to the user the possible risk—meaning possible total exposure to a condition—in engaging in activity at the selected time and for the selected duration, and for the expected intensity of the activity.

A map tool displays the various data described above over a map, where the map may display the area immediately around the user, or an area selected by the user. The map tool may display, for example, the level of pollen in an area, including gradations in the levels of pollen across the area. The map tool may additionally display the change in time of various data, such as pollen levels. The map tool may also suggest to the user an area where, for example, the pollen level is the lowest.

A suggestion tool allows the user to enter one or more parts of one or more days, and provides the user with a suggested timeframe within those timer periods. The user can, for example, use the suggestion tool to indicate that he or she wishes to engage in a 2-hour activity between 10:00 am and 8:00 pm. The suggestion tool may take this information to determine a suggested, for example, 2-hour timeframe between 10:00 am and 8:00 pm, starting at 4:30 pm. This suggestion may be displayed on a graph. In some embodiments, the suggestion tool also allows the user to specify a location; the suggestion tool will then determine a suggested timeframe for that location. In some embodiments, the suggestion tool also allows the user to save previous time and/or location settings for later reuse.

An indoor prediction tool provides an estimate of the overall air quality indoors. In some embodiments, the software application is part of a system that includes air quality sensors and/or automated mechanisms to open and close windows and/or doors. In such an embodiment, when the outdoor air quality falls below a specified threshold, the indoor prediction tool may also open and close windows automatically. The indoor prediction tool may also allow the user to use the window and/or door opening and closing mechanism by providing selections to manually open and close the windows and/or doors.

A quick suggestion tool provides the user with a method to suggest a timeframe with the selection of a single button. The quick selection tool, when selected, will provide the user with a suggested timeframe on the same day between the current time and the end of the day, where the time period for the timeframe may be, for example one hour and the end of the day may be, for example, 9:00 pm. When there is not enough time for the time period in the current day, the quick suggestion tool may suggest a timeframe between the end of the day and midnight, and/or in the next day. The user may change the time period used by the quick selection tool, as well as what time should be the end of the day through, for example, a settings tool provided by the software application. In embodiments that allow the user to select multiple timeframes, the meter tool may also incorporate the quick-suggest timeframe into the comparison provided by the meter tool, and update the data displayed by the meter tool.

An exercise or “runkeeper” tool provides the user with information for engaging in exercise. The runkeeper tool may suggest a route for the user that goes through areas with the most favorable conditions as given by the discreet data over time, such as for example the best overall air quality. Additionally, the runkeeper tool may adjust the route to avoid undesirable roads, such as roads with poor surface conditions or heavy traffic. In some embodiments, the runkeeper tool may also provide a connection to a streaming audio service, such as for example radio services, Pandora™, and/or Spotify™, so that the user can listen to news or music while exercising.

A history tool provides the user with methods to use the user's activity history. The user's activity history is a record of the actions the user has executed in using the software application. The user's activity history can by used through the history tool to repeat the same activities, and thereby, for example, allow the user to develop routines. For example, the user may usually exercise between 9:00 am and 5:00 pm each Tuesday, and between 11:00 am and 8:00 pm every Thursday; the history tool may automatically display these options every Monday and Wednesday, so that the user can plan for the next day.

An image tool provides an image or photograph of a chosen location. The image tool may thus assist the user in recognizing a landmark, finding a location, and/or inspecting a location before visiting.

A bicycling tool provides specific assistance to bicyclists. To avoid flat tires, bicyclists desire a low ozone level within the tire. The bicycling tool may suggest to the user times when the ozone level in a specified area is low, and thus optimal for filling a bicycle tire with air. In some embodiments, the bicycling tool also provides the user with an optimal tire pressure, given the size of the tire, the weight of the bicycle and the rider, and/or the tire's usage conditions (i.e., off-road riding versus on-road riding, mountain bike versus road bike, etc.).

And advertisement tool displays advertisements to the user that are relevant to the user at a given time. For example, if the user is jogging on a hot day, the advertisement tool may suggest a nearby location to buy water. In some embodiments, the advertisement tool may also display relevant health and safety tips, such as scientific information about air quality.

### Software Application

Certain embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present embodiments.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present embodiments.

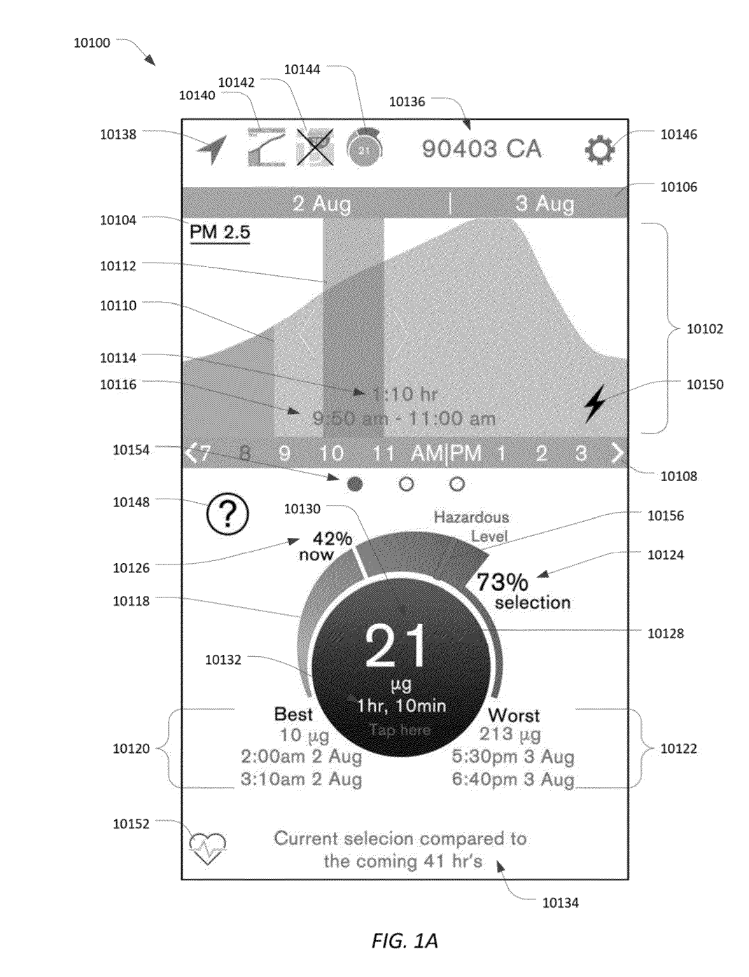

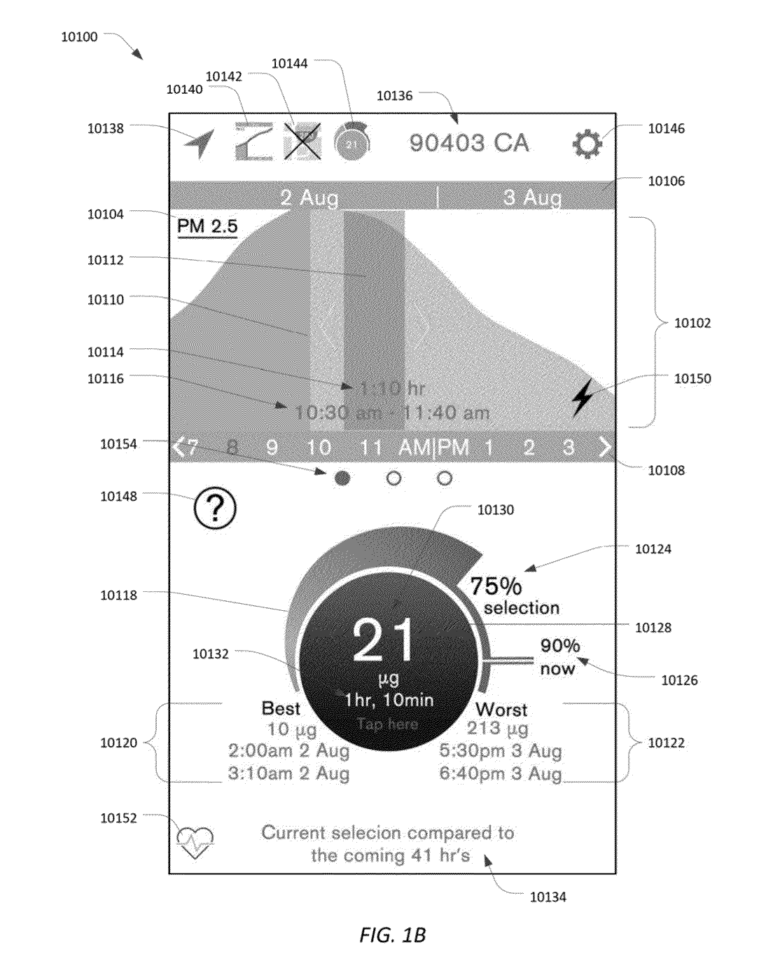

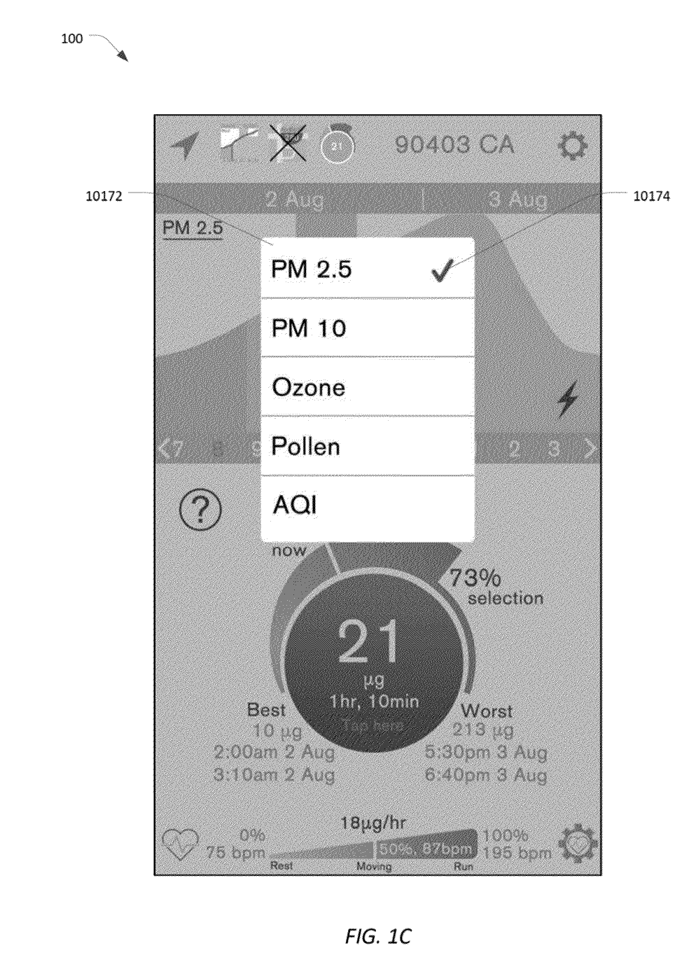

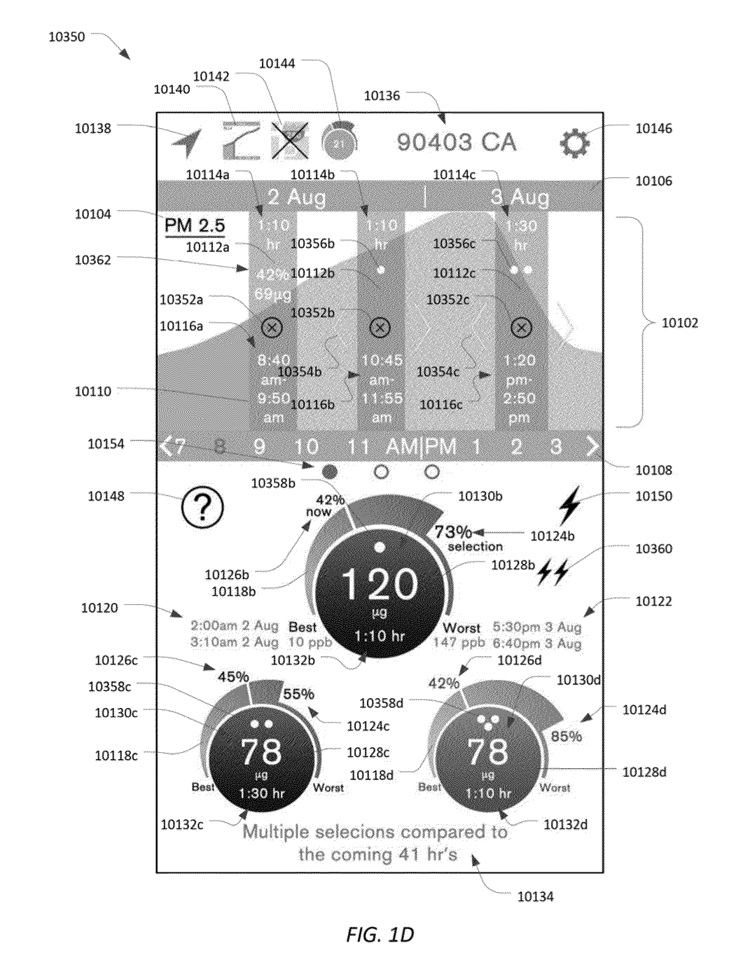

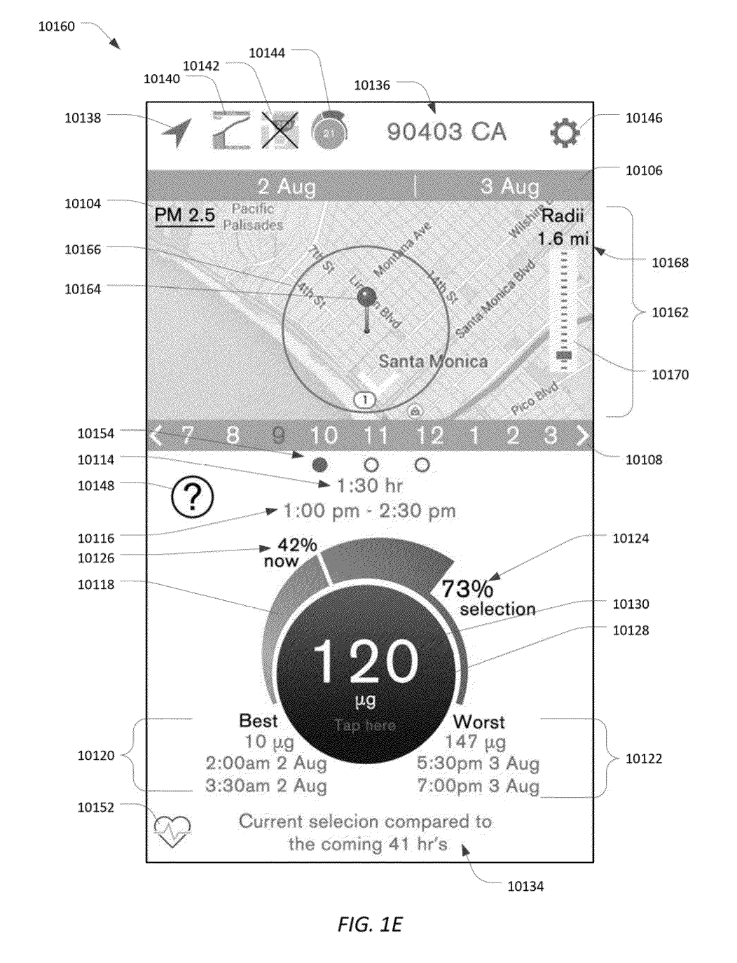

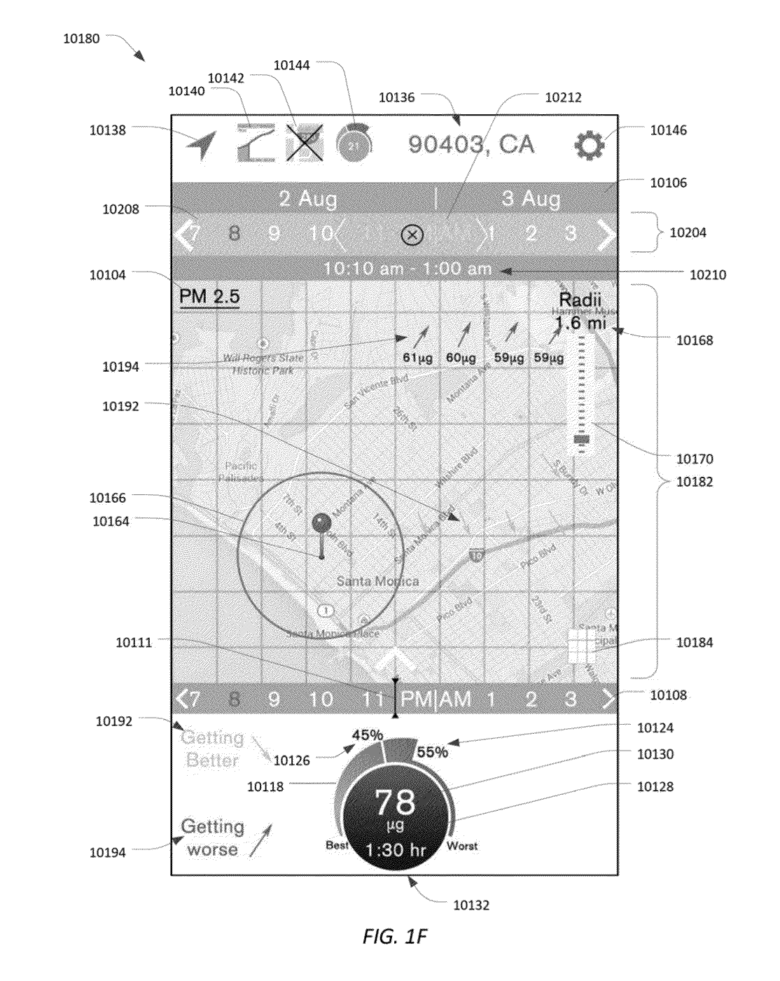

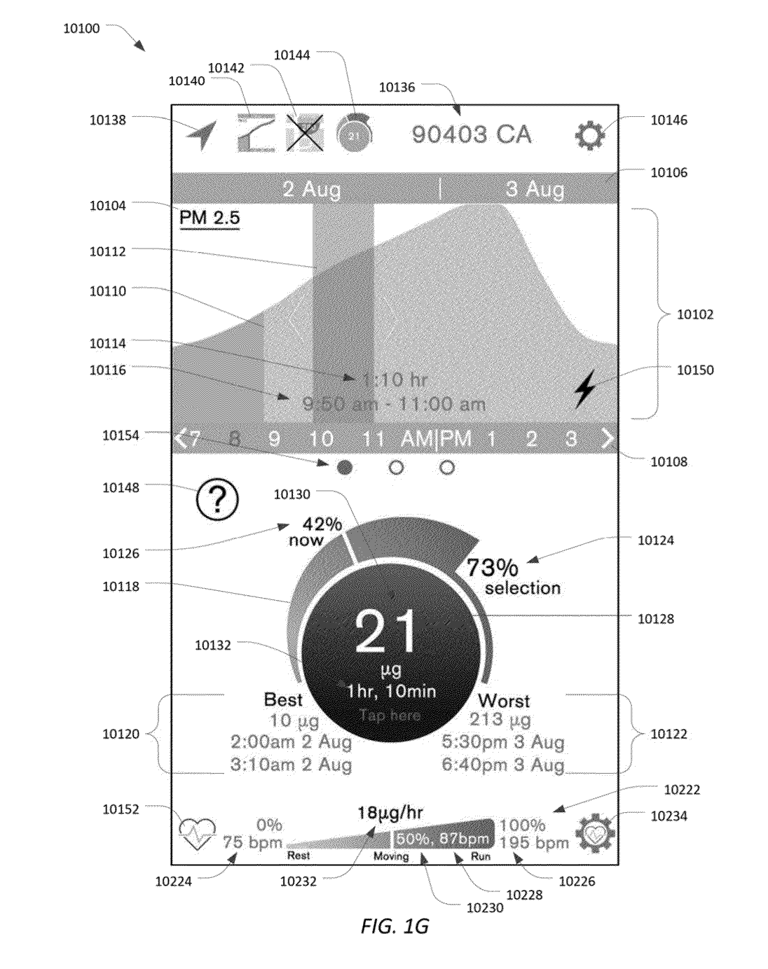

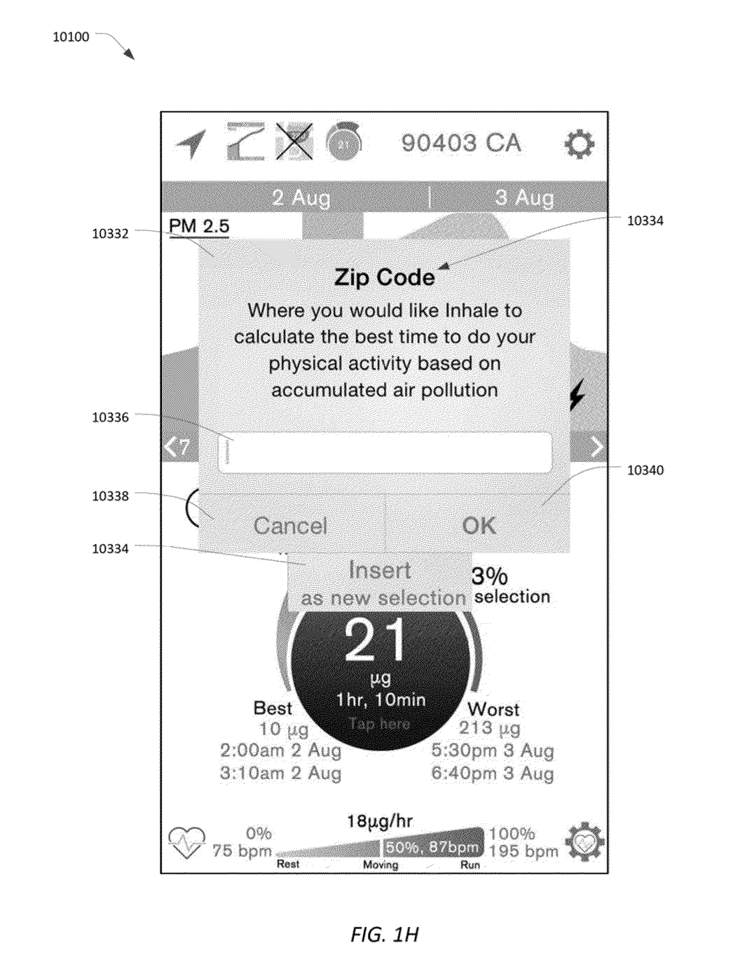

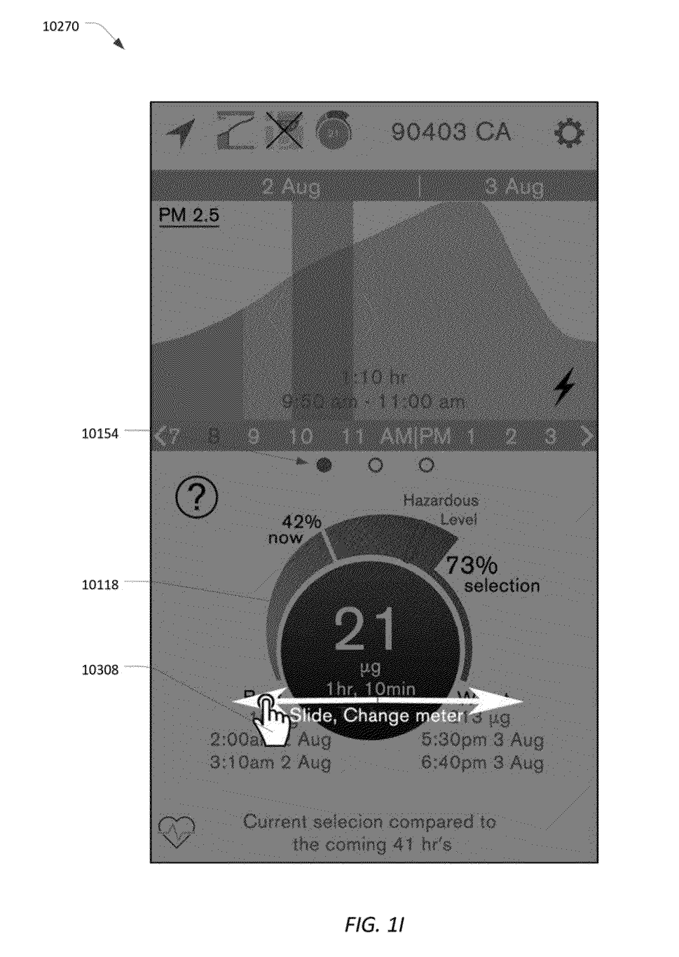

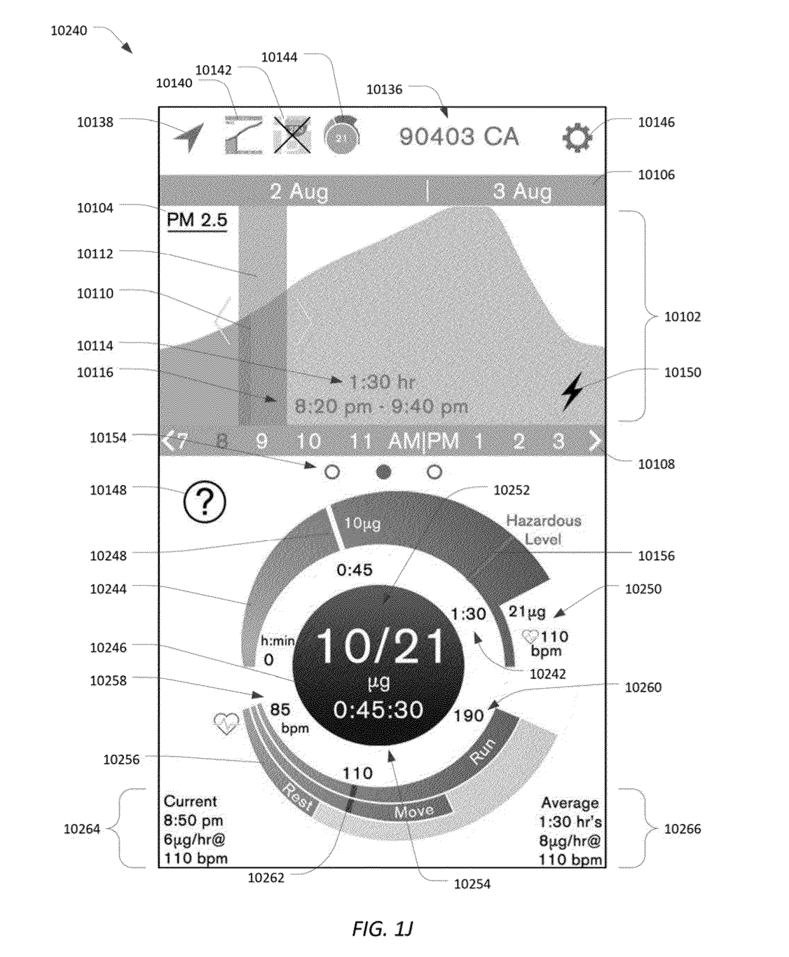

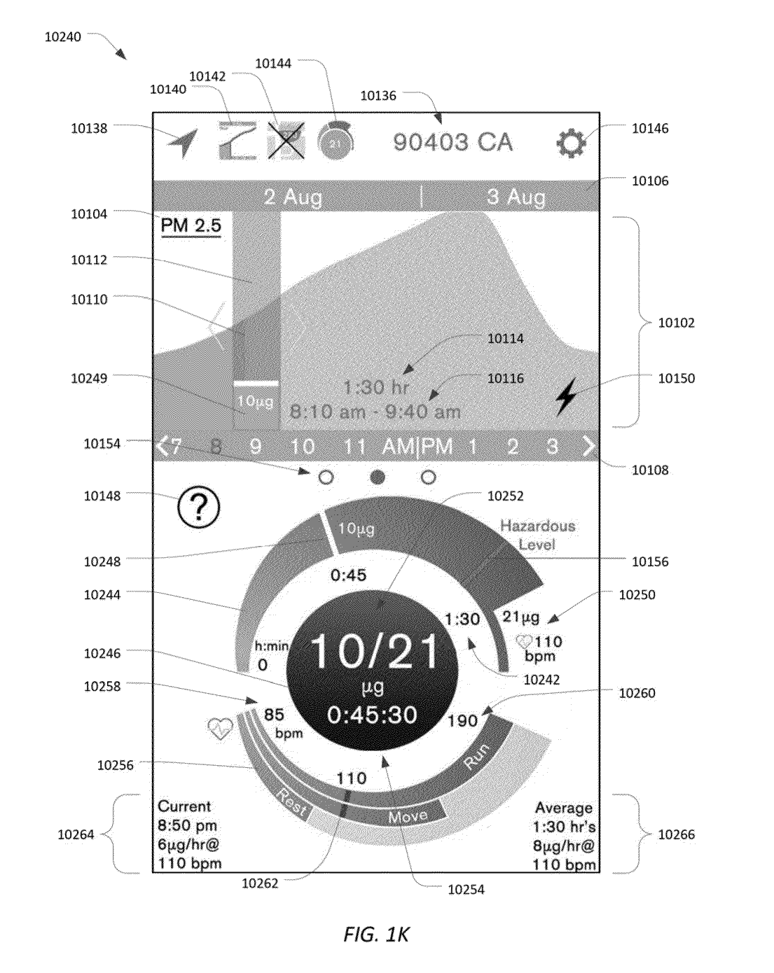

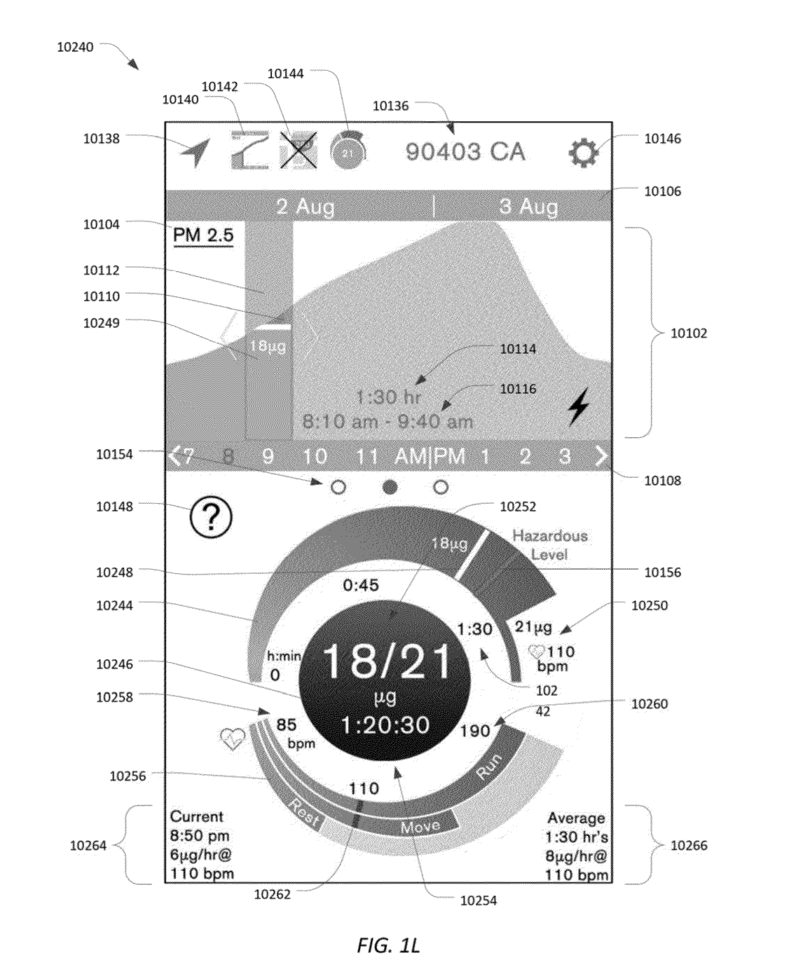

FIG. 1A illustrates one embodiment of the main screen 10100 of a software application for mobile devices that provides users with suggested times for engaging in an activity for a given duration and in a specified location, based one or more conditions. The main screen 10100 displays a graph 10102 of data representing a condition over time. The data can be, for example, pollution levels, pollen levels, temperature, rain, amount of sun exposure and/or cloudiness, etc., and/or a combination of these data types. The data type 10104 is displayed by the graph 10102. In the illustrated example, the data type 10104 is fine particle (PM2.5) levels over time. The graph 10102 includes the date and/or a range of dates 10106 that is displayed by the graph 10102. The date 10106 may include the current date and/or one or more days in the past or into the future. The graph 10102 also displays the hours 10108 that are included by the graph 10102. The current time 10110 to the present is highlighted or indicated by a different color in the hours 10108 indicator. On the graph 10102 the current time 10110 is indicated by a line or a change in color of the display. The current time 10110 indicator may update continuously as time advances. A selected timeframe 10112 is indicated on the graph 10102 by a horizontal bar or shaded area, where the width of the bar indicates the duration of the selected timeframe 10112. A numerical value for the time duration 10114 in hours and minutes is also displayed by the graph 10102. The start and end times 10116 of the timeframe 10112 are also displayed.

The data displayed by the graph 10102 is associated with a specific geographical area, meaning that the data may represent, for example, the fine particle levels in a particular zip code. The main screen 10100 displays an indicator of the specified location 10136. The user can set the location 10136 to his or her current location be selecting a current location button 10138.

The main screen 10100 also provides an exposure meter 10118 indicating how the accumulated value of the data 10130 over the selected timeframe 10112 compares to all other possible timeframes within the available data. For example, in the illustrated example, the graph 10102 displays fine particle (PM2.5) levels over the course of two days, and a timeframe starting at 9:50 am (10116) and lasting one hour and ten minutes (10114) has been selected on the graph 10102. In the illustrated example, the accumulated value of the data 10030 over the selected timeframe is the accumulated fine particle levels for an hour and ten minutes starting at 9:10 pm (21 micrograms, in the illustrated example). The meter 10118 displays the absolute value of accumulated value of the data 10030, as well as the relative value, as further explained below.

In some embodiments, the accumulated data value 10130 is also a function of the user's heart rate, where the heart rate may represent the level of intensity of an activity. The user's heart rate may be derived from a heart rate monitor and/or the user may enter his or her heart rate or relative level of intensity manually, such as for instance by selecting the heart rate monitor button 10152. The software application may use a default value of 50% intensity when it cannot obtain a heart rate.

The exposure meter 10118 displays a comparison of the user's selected timeframe 112 against all other possible timeframes, and includes a multi-function button 10128. The software application determines when, over the course of the selected days and/or over all days for which data is available, the accumulated value of the data for the same time duration 10114 as the selected timeframe 10112 is the lowest; this “best” 10120 value and/or starting and ending times is displayed by the exposure meter 10118, and is assumed to be 0% exposure. Similarly, the software application determines when the accumulated value of the data for the same time duration is the highest; this “worst” 10122 value and/or starting and ending times is also displayed by the exposure meter 10118, and is assumed to be 100% exposure. The accumulated value 10130 for the user's selected timeframe 10112 can be compared to the best 10120 and worst 10122 values as a percentage 10124 between the best 10120 value (0%) and the worst 10122 value (100%), which is displayed by the exposure meter 10118. In some embodiments, the current accumulated value 10126, that is, the accumulated value for a timeframe starting at the present time, is also displayed by the exposure meter 10118 as a percentage relative to the best 10120 and worst 10122 possible values. The exposure meter 10118 thus allows the user to compare the total exposure to, for example, fine particle matter for the selected 10124 timeframe against the best 10120 and worst 10122 timeframes, as well as a current 10126 timeframe. The accumulated exposure values may be given in micrograms GO or in some other unit, and the unit may be specified by the user.

In some embodiments, the exposure meter 10118 may also indicate a level at which exposure to the condition represented by the data is considered hazardous 10156. For example, the exposure meter 10118 may indicate that exposure over a certain percentage 10156, as between the best possible value 10120 and worst possible value 10122, may be hazardous. The level exposure considered hazardous may be determined by generally accepted practice, expert data, governmental data, or may be set by the user.

The exposure meter 10118 may also include a multi-function button 128. The multi-function button 10128 may display the absolute value of the accumulated value 10130 of the data over the selected timeframe 10112. For example, in the illustrated example, the multi-function button 10128 indicates accumulated fine particle levels of 21 micrograms for the selected timeframe. The multi-function button 10128 may also display the selected time duration 10132 (shown as one hour and ten minutes). The multi-function button 10128 can also be selected to go to the suggestion screen 200 discussed below.

The main screen 10100 also provides a quick suggestion button 10150. The quick suggestion button 10150, when selected, provides the user with a suggested timeframe to engage in an activity for a given time period, such as one hour. The time period used by the quick suggestion button 10150 can be set by the user through, for example, a settings screen. The graph 10102 and exposure meter 10118 may be updated with the data of the quick-suggested timeframe.

The main screen 10100 also includes text 10134 indicating what is being displayed by the main screen 10100. In the illustrated example, the text 10134 indicates that the exposure meter 118 is displaying a comparison of the selected timeframe 10112 as compared to all timeframes over the next forty-one hours.

The main screen 10100 may also display other meter types, described in further detail below. The currently displayed meter is indicated by a display indicator 10154. The displayed meter may be changed, for example, by selecting a point on the display indicator 10154, and/or by selecting and sliding (that is, “swiping”) across the currently displayed meter.

The main screen 10100 also provides a heart rate monitor button 10152. The heart rate monitor button 10152 enables heart rate monitoring for mobile devices and/or mobile device systems that are capable of monitoring the user's heart rate. Such mobile device systems may include external heart rate monitors, such as for instance chest-worn or wrist-worn heart rate monitoring devices capable of communicating with a mobile device. For mobile devices and/or mobile device systems that do not support heart rate monitoring, the heart rate monitor button 10152 may provide the user with the option of manually entering his or her heart rate. Alternatively, for such devices the heart rate monitor button may be disabled or not displayed.

The main screen 10100 also provides a settings button 10146 that, when selected provides the user with a settings screen. The main screen 10100 also provides a help button 10148 that, when selected takes the user to a help screen and/or tutorial program, described below.

The main screen 10100 also provides buttons 10140, 10142, 10144 to toggle what is displayed. A graph button 10140 toggles display of the graph 10102. A map button 10142 toggles display of a map. As illustrated by the example of FIG. 1A, an X across the map button 10142 indicates that a map is not presently displayed on the main screen 10100. Similarly, when the graph 10102 is not displayed, the graph button 10140 will have an X across it. A meter button 10144 toggles display of the exposure meter 10118. In some embodiments, the size and shape of each of the graph, map, and/or meters may be adjusted to fit available space on the main screen 10100.

FIG. 1A illustrates one embodiment of the main screen 10100 when the exposure meter 10118 displays a current accumulated value 10126 that is less than the accumulated value 10124 for the selected timeframe 112. FIG. 1B illustrates an embodiment of the main screen 10100 when the current accumulated value 10126 is greater than the accumulated value 10124 for the selected timeframe 10112. In all other aspects, the main screen 10100 of FIG. 1B illustrates the same elements as are illustrated in FIG. 1A.

FIG. 1C illustrates one embodiment of the main screen 10100 with a pop-up window 10172 for selecting the data type 10104. The user can change the data type 10104 by selecting or tapping on the data type 10104 displayed by the graph 10102. Doing so directs the user to a pop-up window 10172, that is, a window that overlays what is currently displayed on the screen, for selecting the data type. The pop-up window 10172 displays a list or menu or drop-down menu containing the various data types available. The selected data type is indicated 10174, for example, by highlighting or a mark. In some embodiments, more than one data type can be selected, in which case the data displayed by the main screen 10100 is a combination of the selected data types. Selecting a data type may dismiss the pop-up window 10172.

FIG. 1D illustrates one embodiment of a multiple selections screen 10350. The multiple selections screen 10350 may be displayed when the user inserts more than one timeframe 10112 on the graph 10102, for instance, from the main screen 10100. The user can insert additional timeframes 10112 onto the graph 10102 by selecting or tapping and holding down on the graph 10102; a new timeframe 10112 may be inserted at the selected time. In some embodiments, the newly added timeframe 10112 is centered on the graph 10102, such that the graph 10102 display is shifted so that the newly added timeframe 10112 can be displayed in the center. The time period of the new timeframe 10112 may be the same as the time period of a previously inserted timeframe 10112, may be a default time period, or may be some other predetermined value. Any number of timeframes 10112 may be inserted. When more than one timeframe 10112 is displayed on the graph 10102, the multiple selections screen 10350 may be automatically displayed. Each timeframe 10112 is represented by a vertical bar or shaded area whose width approximates the time period of the timeframe 10112 and whose location on the graph indicates the start and end times of the timeframe. A numerical value of the time period 10114 is displayed with each timeframe. The start and times 10116 for each timeframe 10112 are also displayed. The start and end times 10116 for each timeframe 10112 can be changed by selecting and sliding arrow buttons 10354 on either side of the timeframe 10112. Each timeframe 10112 also includes a delete button 10352 that, when selected or tapped, will remove the timeframe 10112 from the graph 10102. A timeframe 10112 may also include an identifier 10356 for associating the timeframe 10112 with an exposure meter 10118. A timeframe 10112a corresponding to the present time, that is, beginning with or including the current time is indicate by the absence of an identifier 100356. The timeframe 10112a corresponding to the present time may also display its accumulated data value 10362 as an absolute value and/or as relative to the best 10120 and worst 10122 accumulated values.

The multiple selections screen 10350 displays multiple exposure meters 10118. In some embodiments, the multiple selections screen 10350 may display up to three exposure meters 10118. The primary exposure meter 10118b display the same information as the exposure meter 10118 and multi-function button 10128 of the main screen 10100, except that the primary multi-function button 10128b includes an identifier 10358b for associating the exposure meter 10118b with a timeframe 10112 on the graph 10102. In the illustrated example, the primary exposure meter 10118b are displaying the data for the timeframe 10112b identified 10356b with a single dot. In some embodiments, the timeframe 10112b associated with the primary exposure meter 10112b and multifunction button 10128b is always centered on the graph 10102.

The secondary 10118c and tertiary 10118d exposure meters display the same information as the primary exposure meter 10118b, except that the best 10120 and worst 10122 accumulated data is the same for all, and is therefore not displayed by the secondary 10118c and tertiary 10118d displays. The timeframe 10112 associated with an exposure meter 10118 may not be currently displayed by the graph 10102; this is indicated by the exposure meter 10118 by, for example, changing the opacity or color of the exposure meter 10118 and/or adding a symbol to the display, or some other means. In the illustrated example, the timeframe 10112 for the tertiary exposure meter 10118d is not displayed by the graph 10102; as illustrated, none of the timeframes 10112 have the same three-dot identifier 10358d as the tertiary multi-function button 10128d, and the exposure meter 10118d has a lower opacity.

In some embodiments, the secondary 10118c and tertiary 10118d exposure meters can be selected and made primary. For example, the secondary exposure meter 10118c can be selected and slid into the location of the primary exposure meter 10118b, causing the two displays to exchange places. In some embodiments, this may also cause the graph 10102 to center on the timeframe 10118c of the now primary display. Alternatively or additionally, clicking or tapping on a secondary 10118c or tertiary 10118d exposure meter may have the same effect.

The multiple selections screen 10350 also includes a daily quick suggestion button 10360. When selected, the daily quick suggestion button 10360 will clear all timeframes 10112 from the graph 10102 and select a timeframe 10112 on each available day 10106, using the time period 10132b from the primary multi-function button 10128b. The secondary 10118c and tertiary 10118d displays may also be updated. The user can thus compare the exposure data for the same time on different days.

The multiple selections screen 10350 otherwise provides similar elements as the main screen 10100, including a location indicator 10136, current location update button 10138, display toggle buttons 10140, 10142, 10144, and a settings button 10146, among others.

FIG. 1E illustrates one embodiment of a small map screen 10160 of the software application for mobile devices. The small map screen 10160 may be presented by, for example, selecting the map button 10142 on the main screen 10100. The small map screen 10160 displays a small map 10162. The small map 10162 may display the same data that is displayed by the graph 10102 but over a geographic area as well as over time. The graph 10102, in contrast, displays only the data over time for a designated single location 10136. Thus the user can see how the data changes over time over a geographic area by, for example, selecting the date range 10106 or hours 10108 indicator and sliding them left or right. The area displayed by the small map 10162 can be changed by selecting and sliding the map in north, south, east, or westward directions. The area can also be changed by decreasing the viewable area (such as, for instance, with a pinching-in motion) or increasing the viewable area (such as, for instance, with a spreading-out motion).

The small map 10162 may include a pin 10164 indicating a location. When the user comes to the small map screen 10160 from the main screen 10100, the pin 10164 may be placed according the location 10136 displayed by the main screen 10100. Alternatively or additionally, the pin 10164 may be placed at the user's current location, as determined by, for example, a GPS location, cellular triangulation, and/or Internet triangulation, or some other functionality in the mobile device. The small map 10162 may also include a circle 10166 of a certain radius around the pin 10164 indicating an area a certain distance 10168 around the user's location 10164. The circle 10166 may indicate the area within which the accumulated value 10130 for the selected timeframe is to be measured, wherein the center point of the selected timeframe is indicated by the intersection of the pin 10164 and the hours 10108 display. The small map 10162 may display a numerical value 10168 of the radius of the circle 10166. The small map 10162 may also provide a slider bar 10170 to modify and set the radius of the circle 10166. In some embodiments, the radius of the circle 10166 can also be changed by selecting the circle 10166 and sliding it in or out. In all other aspects, the small map screen 10160 includes the same or similar elements as the main screen 10100. Should the user return to the graph 10102, the location of the pin 10164 may be used to select a new current position 10136.

In some embodiments, the small map 10162 can be used by the user to select an area over which to measure the accumulated data value 10130. The time period 10114 over which the accumulated data value 10130 is to be calculated may be a default value, such as one hour, or may be set by the user, such as by selecting or tapping the displayed time period 10114 display. The time period 10114 is given as centered on the hours 10108 display. The accumulated data value 10130 thus measured may be compared on the exposure meter 10118 against the best 10120 and worst 10122 timeframes. The user can also select the quick suggestion button 10150 to obtain a suggestion location for a given time period. The time period may be, for example, one hour, or a time period set by the user. The time period is assumed to start at the present time, and the suggest location may be within a default distance, such as five miles, from the user's present location, or within a distance set by the user.

In some embodiments, the user can place multiple pins 10164 on the small map 10162 to specify and compare exposure levels in different locations. One pin 10164, possibly the first or the last, may be considered the selected pin 10164 and may be used to generate the data for display on the meter 10118. Placement of multiple pins 10164 may initiate a multiple meter display, such as illustrated in FIG. 1D. When more than one pin 10164 is placed in the same location, the visible pin 10164 may display a number, or otherwise indicate how many pins 10164 are placed at that location. Selecting a pin 10164 may present the user with information about the pin 10164 (such as an address or description of the location) and/or the option to make the pin 10164 the selected pin. If no pin 10164 is selected, then the pin 10164 closest in time to the center of the hours 10108 indicator is assumed to be the selected pin.

FIG. 1F illustrates one embodiment of a large map screen 10180 for the software application for mobile devices. The large map screen 10180 may be presented by, for example, by selecting or tapping on the map 10162 of the small map screen 10160. The large map screen 10180 displays a large map 10182 displaying a larger area than is displayed by the small map 10162. The large map 10182 may display the same information and have the same capabilities as the small map 10162. The large map 10182 may also display a grid button 10184 that toggles display of a grid overlaying the large map 10182. In both the large map 10182 and the small map 10162, each rectangle of the grid may represent a data value (i.e. pollution level, pollen level, degree of sun exposure, etc.) Each grid location may be able to display an absolute or relative, in percentage, value as compared to the best 10122 and worst 10120 calculated values. In some embodiments, the user may be able to reduce the size of the grid to finer delineations, and thus see data values over smaller areas.

The large map 10182 may be accompanied by a date and time selector 10204. The date and time selector 10204 allows the user to select a timeframe 10212 over which to calculate the accumulated value of the data 10130 for the area specified by the circle 10166. The date and time selector 10204 includes the days and/or range of dates 10106 and a time bar 10208 that, together, can be used to set the selected timeframe 10212. The start and end times 10210 of the selected timeframe 10212 are also displayed by the date and time selector 10204. A timeframe indicator 10111 on the hours 10108 display may update to indicate the midpoint of the timeframe 10212.

The large map 10182 may also display a general direction in which the accumulated levels (e.g., accumulated levels of fine particles) are trending downwards decreasing 10192. The decreasing levels 10192 are indicated with arrows of a particular color and direction, as indicated by a displayed legend. The large map 10182 may also display a general direction in which the accumulated levels are trending upwards or increasing 10194. The increasing levels 10194 are indicated with arrows of a particular color and direction, as indicated by a displayed legend. The trending arrows may be associated with specific rectangles of the grid, and may be accompanied by an absolute value for that grid location.

In all other aspects, the large map screen 10180 includes the same or similar elements as the mains screen 10100, possibly reduced in size to accommodate the size of the large map 10182.

FIG. 1G illustrates one embodiment of a main screen 10100 with heart rate monitoring activated. Heart rate monitoring is activated by selecting or tapping the heart rate monitor button 10152, which may enable a heart rate monitor display 10222. The heart rate monitor display 10222 may include the user's resting heart rate 10224 (assumed to be 0% heart rate) and maximum active heart rate 10226 (assumed to be 100% heart rate). The user's resting heart rate 10224 and maximum active heart rate 10226 can be entered into the software application by the user, or can be obtained or derived from data or another application present on the mobile device. The heart rate monitor display 10222 also displays the user's current heart rate 10228, as well as the user's relative heart rate 10230 as a percentage between the user's resting heart rate 10224 and maximum active heart rate 10226. The heart rate monitor display 10222 may also display the user's exposure over time 10232 to the element or quantity represented on the graph 10102. In some embodiments, a heart rate monitor settings button 10234 directs the users to settings for the heart rate monitor display 10222 and/or a heart rate monitor, including for example controls for pairing with a external heart rate monitoring device.

FIG. 1H illustrates one embodiment of the main screen 10100 with a pop-up window 10332 for setting a location. The pop-up window 10132 may be presented to the user when the user selects or taps the current location 10136 on the main screen 10100. The pop-up window 10132 indicates how 10134 the user can enter a location; for example, the user may be able to enter a zip code, street address, GPS coordinates, etc. The pop-up window 10132 includes a text box 10136 in which the user can enter his or her desired location. In embodiments where the mobile device supports on-screen keyboards, an on-screen keyboard (not shown) may be presented to the user for entering text into the text box 10136. The pop-up window 10132 also includes a “Cancel” button 10138, which, if selected, will dismiss the pop-up window 10132 without accepting the entry in the text box 10136. The pop-up window 10132 also includes an “OK” button 10340 that will accept the user's entry and dismiss the pop-up window 10132; the graph 10102 and/or meter 10118 may be updated to display the data for the newly selected location. In some embodiments, the pop-up window 10132 also includes an “Insert as New Selection” button 10334 that, when selected, has the same effect as the OK button 10340 and additionally suggests an optimal timeframe for the newly selected location. The thusly suggested timeframe may be displayed on the graph 10102 and its accumulated data values may be displayed on the meter 10118. The previously selected timeframe may also be displayed, and multiple meters may be displayed.

FIG. 1I illustrates one embodiment of a first help or tutorial screen 10270. The first help screen 10270 indicates that the displayed meter 10118 can be changed 10308 by selecting any area overlaying the meter 10118 and sliding to the left or right. A different meter, as described below, may then be displayed, with the displayed meter being indicated by the display indicator 10154.

FIG. 1J illustrates one embodiment of an active timeframe screen 10240. The active timeframe screen 10240 can be activated, or may activate automatically, when the timeframe 10112 selected by the user is reached. In the illustrated example, on the graph 10102 the selected timeframe 10112 overlaps the current time 10110. In some embodiments, the software application provides an alarm that can be triggered when the selected timeframe 10112 is reached. The active timeframe screen 10240 replaces the exposure meter 10118 of the main screen 10100 with an active exposure meter 10244, which includes a lapsed time meter 10242 and accumulated value indicator 10246. The current exposure meter 10244 indicates the user's accumulated exposure 10248 to the element or quantity represented by the data on the graph 10102 as a function of time, meaning that the value of the accumulated exposure 10248 indicates how much exposure the user has accumulated at a given time, as indicated by the lapsed time meter 10242. The lapsed time meter 10242 displays time intervals in minutes and/or hours, starting at zero and ending at the time duration 10114 selected by the user. Alternatively, the lapsed time meter 10242 may display time intervals in absolute time. The accumulated exposure 10248 indicator may update continuously or periodically. The active exposure meter 10244 may also indicate a level at which exposure to the condition represented by the data is considered hazardous 10156. The active exposure meter 10244 also displays an expected, estimated accumulated exposure value 10250. The expected accumulated exposure value 10250 may be adjusted according to the intensity of the user's activity, which may assumed from the user's heart rate 10262. The accumulated value indicator 10246 also displays 10252 the user's current 10248 and expected 10250 exposure values, as well as the lapsed time 10254 in hours, minutes, and/or seconds, either counting down or counting up. The display indicator 10154 may indicate that the active exposure meter 10244 is currently being displayed.

In some embodiments, the active timeframe screen 10240 may also display the user's heart rate on a heart rate meter 10256. The heart rate meter 10256 includes the user's resting heart rate 10258 and maximum active heart rate 10260, which can be entered into the software application by the user, or can be obtained or derived from data or another application present on the mobile device. The heart rate meter 10256 also displays the user's current heart rate 10262.

In some embodiments, the active timeframe screen 10240 may also display the user's current information 10264. The current information 10264 may include the current time, the user's current rate of exposure to the element or quantity represented by the on the graph 10102, and/or the user's current heart rate. The active timeframe screen 10240 may also display the user's average information 10266. The average information 10266 may include the time period over which the average is being calculated, the user's average exposure over time, and/or the user's average heart rate.

The active timeframe screen 10240 otherwise has the same or similar elements as the main screen 10100.

FIGS. 1K and 1L illustrate an embodiment of the active timeframe screen 10240 where the graph 10102 has been configured to display the accumulated exposure value 10249. As illustrated in FIG. 1K, the selected timeframe 10112 displays both a level for and a value of the accumulated exposure value 10249. The accumulated exposure value 10249 displayed on the graph 10120 may update discreetly or continuously. FIG. 1L illustrates a later point in time, when the accumulated exposure value 10249 displayed by the graph has increased. The active exposure meter 10244 has also updated its display of the accumulated exposure value 10248.

FIG. 1M illustrates an embodiment of sensor screen 10440. The sensor screen 10440 may be available with mobile device systems that include one or more sensor devices, integrated with the mobile device and/or external to the mobile device. The sensor screen 10440 includes one or more meters by data type 10442. Each meter by data type 10442 displays the accumulated value of the data for that data type for the selected timeframe 10112, similar to relative accumulated value 10124 that is shown on the main exposure meter 10118 The individual meters by data type 10442 also display the value of the data for that data type for a timeframe starting at the current time 10110, similar to the relative accumulated value for the current timeframe 10126 shown by the main exposure meter 10118. In some embodiments, selecting a meter by data type 10442 will change the data type 10104 displayed by the sensor screen 10440, including updating the graph 10102 and the exposure meter 10118 displays. More meters by data type 10442 may be available than can be displayed at one time. A display indicator 10444 indicates which meter by data type 10442, or group of meters by data type 10442, is currently displayed. The user can see additional meters by data type 10442 either selecting or tapping arrow buttons 10446, selecting or tapping the display indicator 10444, and/or selecting the displayed meters by data type 10442 and sliding left or right.

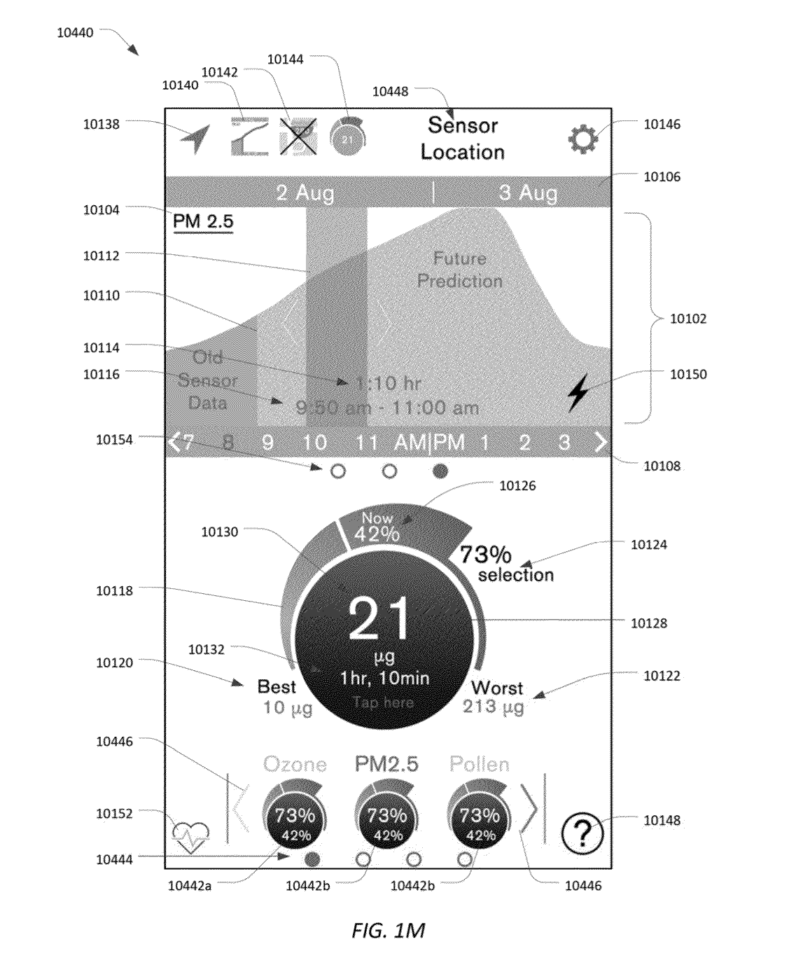

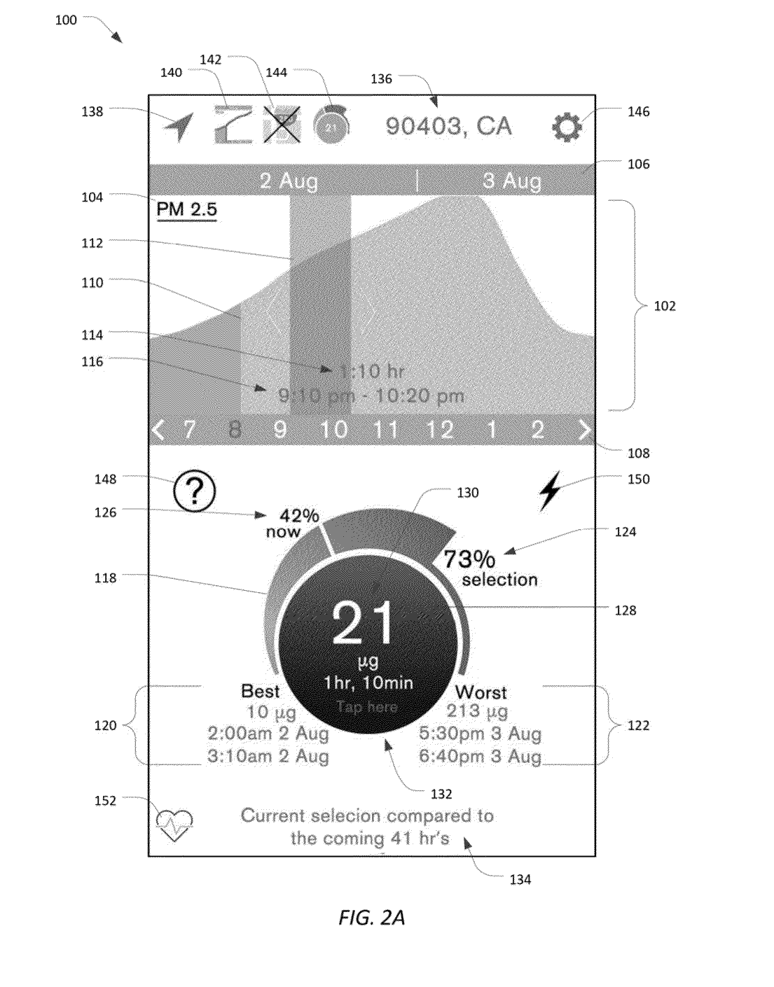

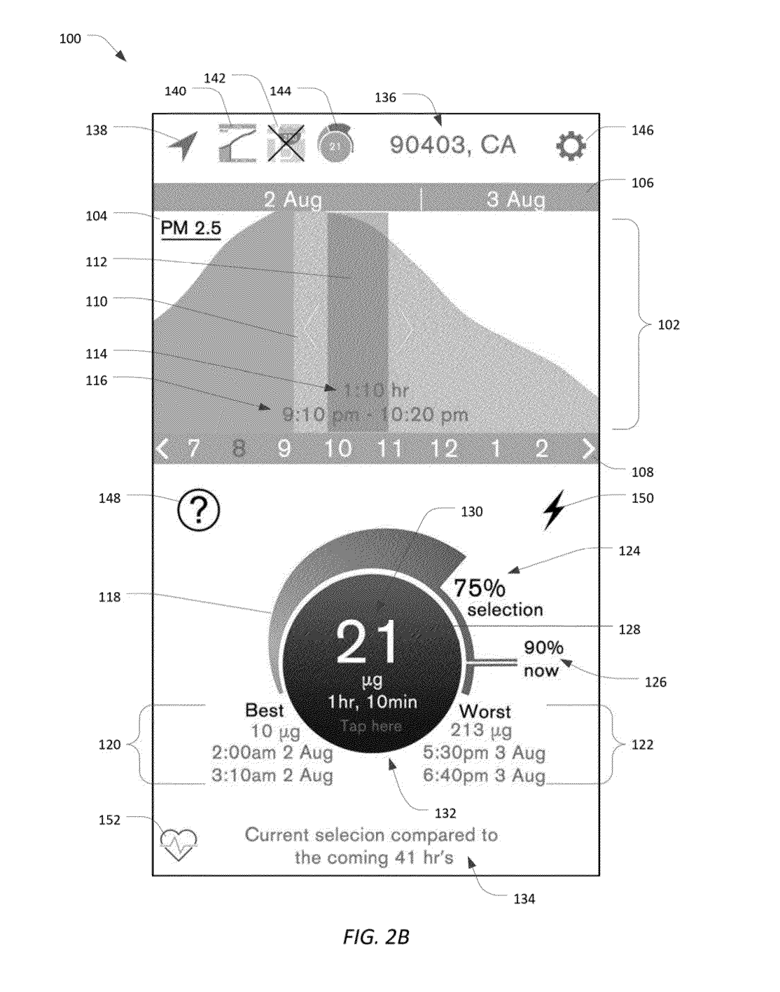

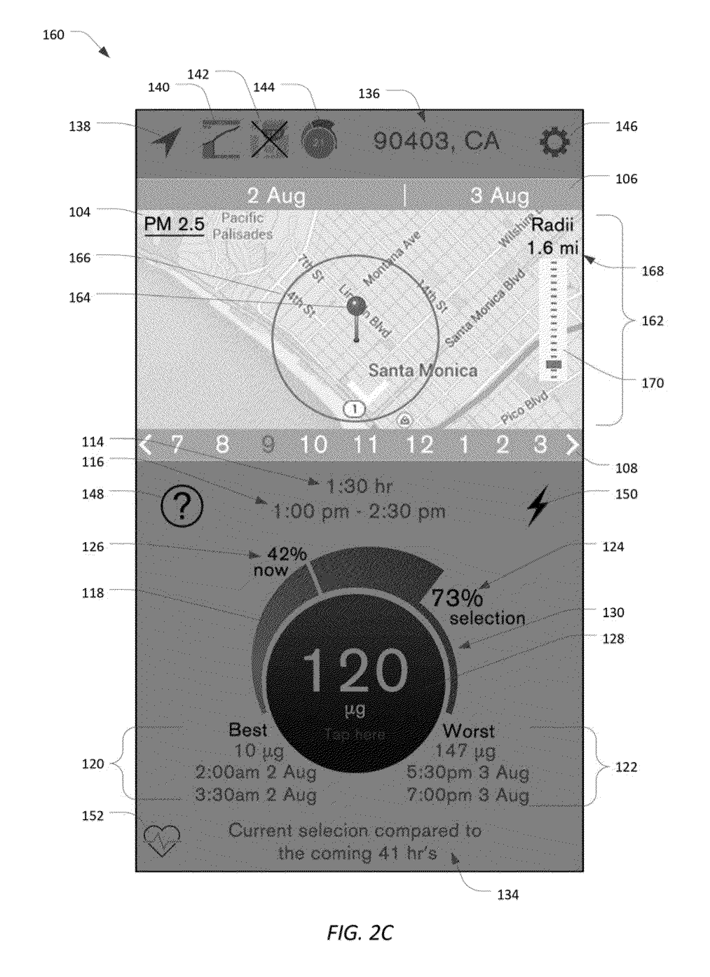

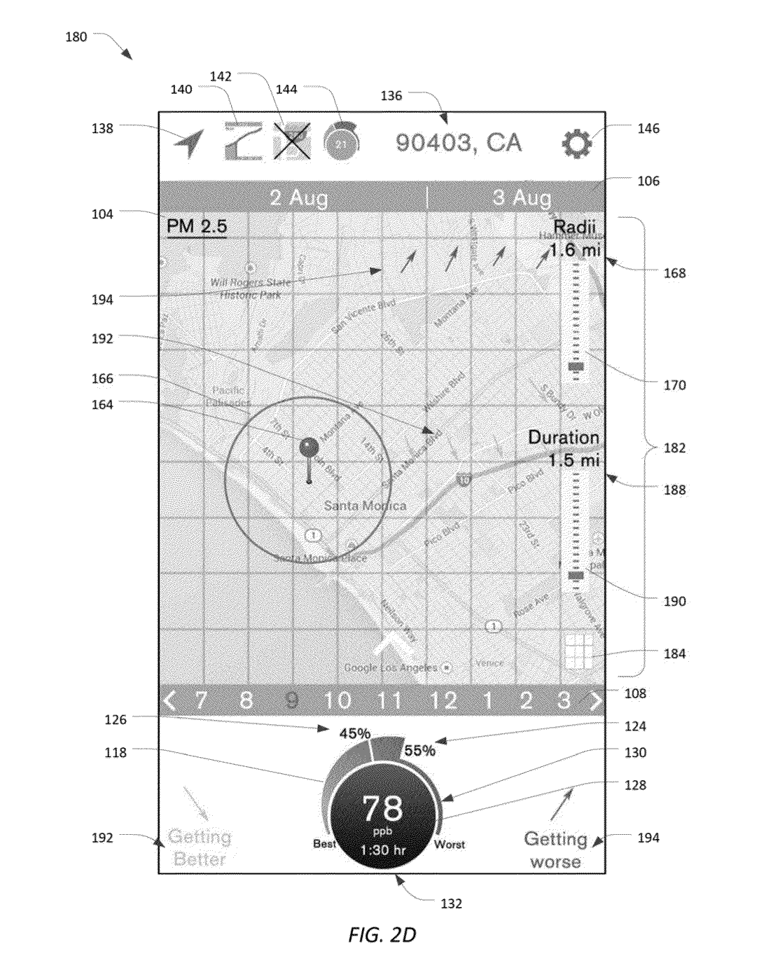

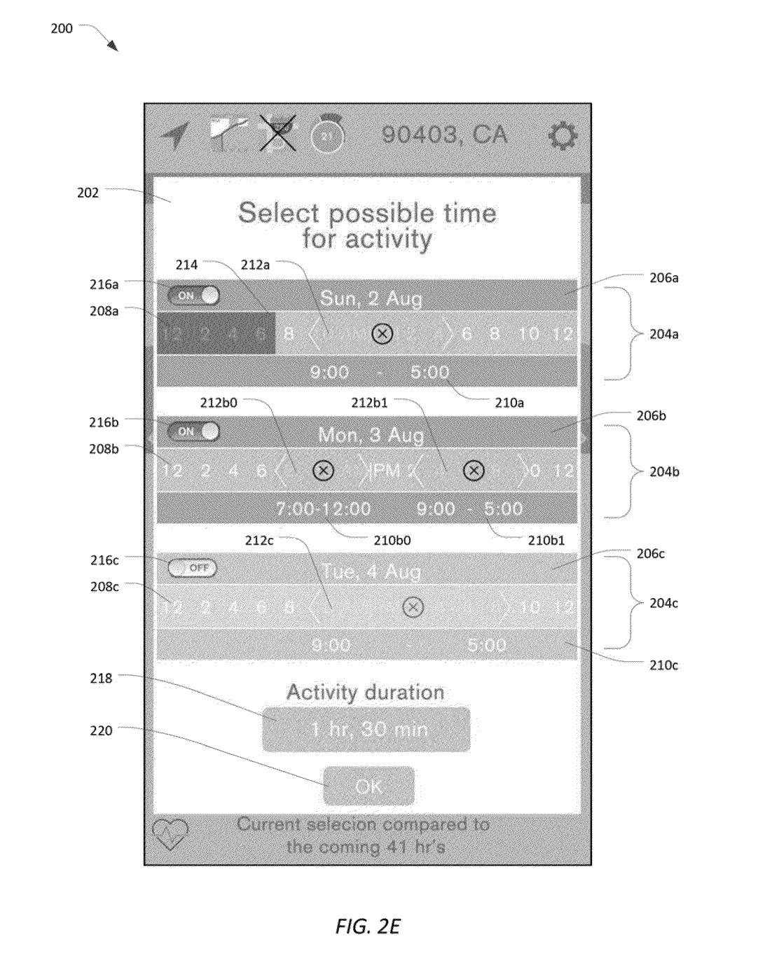

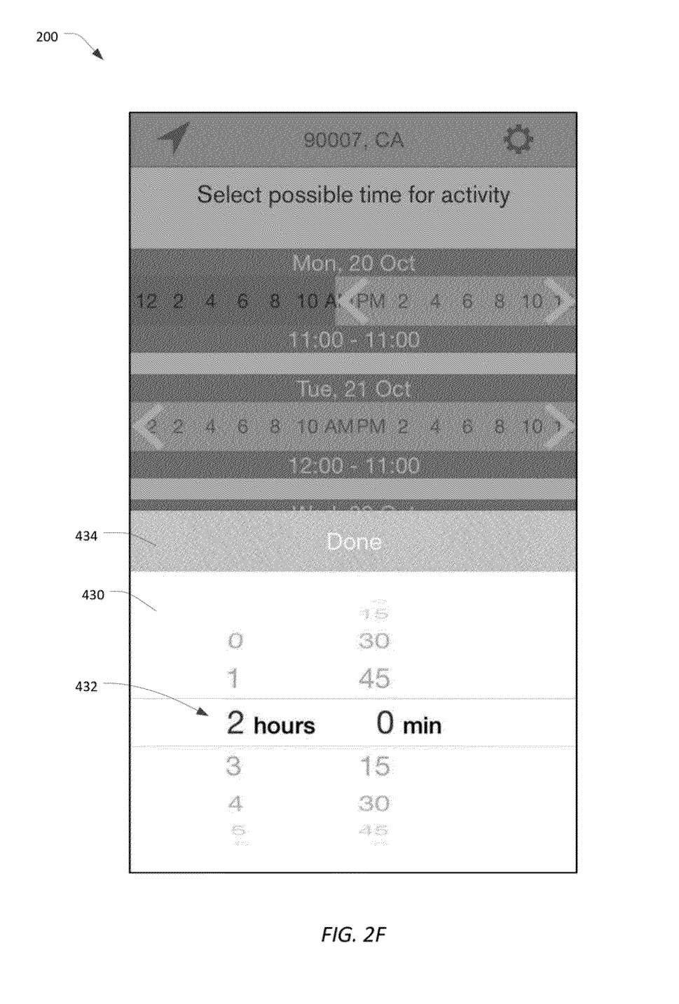

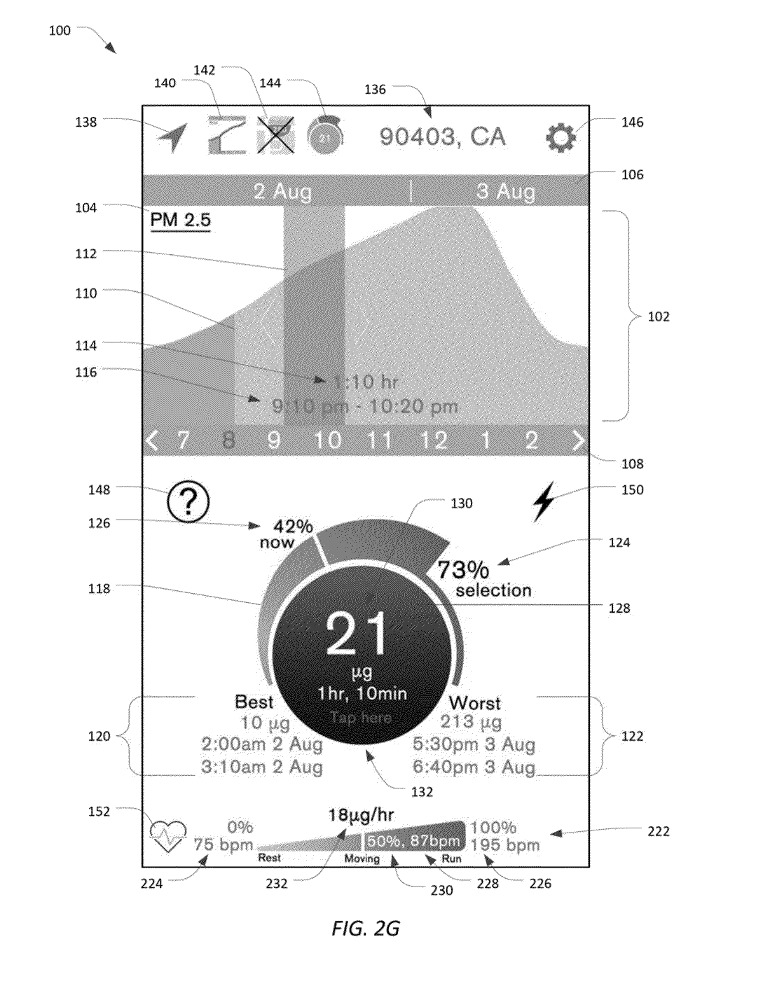

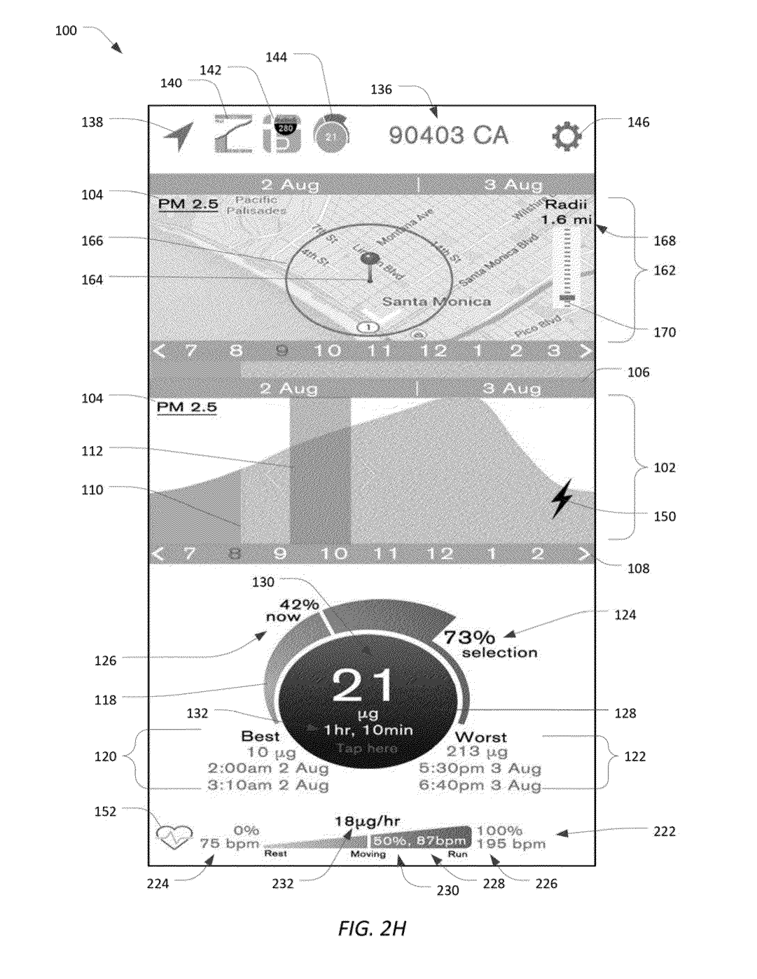

FIG. 2A illustrates one embodiment of a main screen 100 of a software application for mobile devices that provides users with suggested times for engaging in an activity for a given duration and in a specified location based on outdoor conditions. The main screen 100 of FIG. 2A is similar to the main screen 10100 of FIG. 1A, except that the main screen 100 of FIG. 2A does not display a hazardous level indicator or a meter display indicator. The main screen 100 of FIG. 2A thus includes: a graph 102, the graph's 102 data type 104, the date and/or range of dates 106 displayed by the graph 102, the hours 108 displayed by the graph 102, a current time 110 indicator on the graph 102, a selected time frame 112 on the graph 102, the duration 114 of the selected timeframe 112, and the start and end times 114 of the timeframe 112. The main screen 100 also displays an exposure meter 118, including the best 120 accumulated level and timeframe over the selected days, the worst 122 accumulated level and timeframe over the selected days, the percentage accumulated value 124 for the selected timeframe 112, and the percentage accumulated value 126 for the current timeframe 112. The exposure meter 118 also includes a multi-function button 128, which includes the accumulated value 130 for the selected timeframe 112. The main screen 100 also displays text 134 indicating what is presently being displayed on the main screen 100. The main screen 100 also displays the location 136 for the data, and includes an update-to-current-location button 138, a settings button 146, a help button 148, and a quick suggestion button 150.

FIG. 2A illustrates one embodiment of the main screen 100 when the exposure meter 118 displays a current accumulated value 126 that is less than the accumulated value 124 for the selected timeframe 112. FIG. 2B illustrates an embodiment of the main screen 100 when the current accumulated value 126 is greater than the accumulated value 124 for the selected timeframe 112. In all other aspects, the main screen 100 of FIG. 2B illustrates similar elements and has similar functionality as is illustrated in FIG. 2A.

FIG. 2C illustrates one embodiment of a small map screen 160 of the software application for mobile devices. The small map screen 160 is similar to the small map screen 10160 of FIG. 1E except as described below. The small map screen 160 of FIG. 2C includes: a small map 160, a pin 164 indicating a location, a circle 166 indicating a distance around the pin 164, a numerical value 168 for that distance, and a slider 170 to change the distance. The small map screen 160 may also include an exposure meter 118 and related displays. In all other aspects, the small map screen 160 of FIG. 2C illustrates similar elements and has similar functionality as is illustrated in FIG. 1E.

FIG. 2D illustrates one embodiment of a large map screen 180. The large map screen 180 is similar to the large map screen 10180 of FIG. 1F except that the large map screen 180 does not include a date and time selector. Instead, the date and time for the selected timeframe is indicated in a similar fashion as is indicated by the small map 160, that is, by the intersection of the pin 164 and the date 106 and hours 108 displayed. The large map 180 may display a numerical value 188 for the duration of time for the selected timeframe. The large map 180 may also display a slider bar 190 for modifying the duration value 188. In all other aspects, the large map screen 180 of FIG. 2D illustrates similar elements and has similar functionality as is illustrated in FIG. 1F.

FIG. 2E illustrates one embodiment of a suggestion screen 200 for the software application for mobile devices. The suggestion screen 200 may be presented when the user selects or taps on the multi-function button 128 from the main screen 100. The suggestion screen 200 comprises a pop-up window 202. The pop-up window 202 includes one or more date and time selectors 204a, 204b, 204c. FIG. 2E illustrates three date and time selectors 204a, 204b, 204c, but various embodiments of the suggestion screen 200 may have fewer or more date and time selectors 204.

Each date and time selector 204a, 204b, 204c allows the user to specify a part or multiple parts of a day to include in generating a suggested timeframe for engaging in an activity. Each date and time selector 204a, 204b, 204c indicates a date 206a, 206b, 206c. Each date and time selector 204a, 204b, 204c also includes a time bar 208a, 208b, 208c for selecting a part of the day 212. When one of the date and time selectors 204a includes the current time 214, the current time 214 may be indicated on the time bar 208a with a line or shaded area. The start and end times 210 for each selected part of the day 212 are also displayed as part of the date and time selector 204. The selected part of the day 212 is represented by a shaded area or bar overlaying or on top of the time bar 208. The selected part of the day 212 represents an interval of time on the given date 206 during which the user desires to engage in an activity of a specified duration. The selected part of the day 212 can be modified by tapping and/or sliding the ends or arrows at the ends of the selected part of the day 212; the start and end times 210 will update accordingly. In some embodiments, the user can select two or more parts of the day 212b0, 212b1 on the same day 206b. This may be accomplished by tapping the time bar 208b at a time not currently selected by the selected part of the day 212b0. Each date and time selector 204a, 204b, 204c can be disabled with an on/off button 216a, 216b, 216c. Disabling a date and time selector 204a, 204b, 204c allows the user to exclude that date as a day on which he or she wishes to engage in the desired activity. The same effect can be accomplished by removing all selected parts of the day 212 for that date and time selector 204a, 204b, 204c. The pop-up window 202 further includes a duration button 218 for selected the time period of the desired activity. Selecting or tapping the duration button 218 presents the user with a time period selection window, described below. The pop-up window 202 also includes an “OK” button 220, which, when selected or tapped, accepts the user's selections and dismisses the pop-up window 202.

In some embodiments, the suggestion screen 200 includes the capability to save and recover settings (not shown). This allows the user to save the settings for all the date and time selectors 204a, 204b, 204c and recover the settings later. Alternatively or additionally, the suggestion screen may automatically save the user's settings, and/or save a history of the user's settings. The user then may be able to recover settings from the history.

In some embodiments, the suggestion screen 160 allows the user to specify a location (not shown) to use for generating the suggested timeframe. In such embodiments, the software application may suggest a location in addition to a timeframe. The user may also be able to specify a distance from a location. The software application otherwise uses the location 136 set, for example, on the main screen 100. If multiple location-based suggestions are possible, the software application may also provide how far away the suggested locations are, and how long it would take the user to get there.

In some embodiments, the suggestion screen 200 provides an option (not shown) to set a highest concentration limit, meaning the highest concentration of the data type 104 displayed by the graph 102. In such embodiments, the suggestion screen may increase the distance from the location until that concentration limit is reached, and the software application will base a suggested timeframe and location based on the generated distance.

For embodiments employing location-based suggestions, the suggestion screen 200 may also include a limiting element, to limit how far from the user's location the user is will to go. For example, the suggestion screen 200 may include a “Willing to Drive There” button (not shown), which, if selected, informs the software application that the user is willing to go a distance that necessitates driving.

In some embodiments, the suggestion screen 200 allows the user to group selected parts of the day (not shown), such that each group provides a suggested timeframe. All selected parts of the day within a group are used in determining the best suggested timeframe for a given duration (and, in some embodiments, given location). Each group will generate a suggested timeframe. For example, if the user creates three groups, the suggestion screen 200 will produce three suggested timeframes, and possibly display the three suggested timeframes on the graph 102.

In some embodiments, the suggestion screen 200 may be populated by data from the graph 102. For example, when the graph 102 contains multiple selected timeframes 112, the selected parts of the day 212 may each reflect one of the timeframes 112 specified on the graph 102. Selecting multiple timeframes 112 is described in further detail below.

FIG. 2F illustrates one embodiment of a pop-up window 430 for selecting a time period on the suggestion screen 200. The pop-up window 430 may appear when the user selects the duration button 218 from the suggestion screen. The pop-up window displays a time selector 430 that allows the user to select a time period in hours and/or minutes. The pop-up window 430 also includes an “Done” button 434 that, when selected, will accept the entered time and dismiss the pop-up window 430.

FIG. 2G illustrates one embodiment of a main screen 100 with heart rate monitoring activated. The main screen 100 of FIG. 2G is similar to the mains screen 10100 of FIG. 1G, except as described below. The main screen 100 of FIG. 2G includes a heart rate monitor display 222 that includes the user's resting heart rate 224, the user's maximum active heart rate 226, the user's current heart rate 228, and the user's heart rate relative 230 to his or her resting 224 and maximum 226 heart rates. In all other aspects, the main screen 100 illustrates similar elements and has similar functionality as is illustrated in FIG. 1G.

FIG. 2H illustrates one embodiment of a main screen 100 with multiple displays. In the example illustrated by FIG. 2H, the main screen 100 displays both a graph 102 and a small map 162, instead of one or the other. This display may be achieved by selecting both the map button 142 and the graph button 140. The exposure meter 118 is also displayed, as is indicated by lack of an X on the meter button 144. The various displays may be adjusted in size to accommodate the display area. In some embodiments, the graph 102, small map 162, and exposure meter 118 may also maintain synchronization between each other, such that modifying values on one may cause the others to update to reflect the change. In all other respects, the graph 102 includes similar elements and functionality as the graph 102 of FIG. 2A, and the small map 162 includes similar elements and functionality as the small map 162 of FIG. 2C.

FIG. 2I illustrates on embodiment of an active timeframe screen 240. The active timeframe screen 240 is similar to the active timeframe screen 10240 of FIG. 1L, except as described below. The active timeframe screen 240 of FIG. 2C includes an active exposure meter 244, which includes a lapsed time meter 242 and accumulated value indicator 246. The active exposure meter 244 displays the accumulated exposure 248 since the timeframe 112 began, as well as the expected accumulated exposure 250 for the whole timeframe 112, possibly adjusted for the user's heart rate 262. The active exposure meter 244 also indicates the lapsed time 254 since the start of the timeframe 112. In some embodiments, the active timeframe screen 240 also includes a heart rate meter 256, which displays the user's resting heart rate 258 and maximum active heart rate 260, as well as the user's current heart rate 262. The active timeframe screen 240 may also display the user's current information 264 (i.e., the current time and current rate of exposure), as well as average information 266 (i.e., average rate of exposure). In all other respects, the active timeframe screen 240 includes similar elements and similar functionality as the active timeframe screen of FIG. 1L.

In some embodiments, the software application provides a tool (not shown) for the user to enter the type of activity he or she wishes to engage in. Alternatively or additionally, the tool may allow the user to enter the level of activity instead of or in addition to a specific type, the level being specified in degrees of strenuousness. In some embodiments, the software application may use the user's designated activity or activity level to suggest a maximum recommended duration for that activity, given current conditions. For example, the software application may use an Air Pollution Dispersion Model and Borg Scale of Perceived Exertion to calculate the recommended duration. The recommended duration may also take into account the Air Quality Index (AQI); for example, an AQI below 100-150 may be considered low risk. The software application may base the recommended duration on multiple factors (such as, for instance a maximum acceptable ozone exposure of 314 micrograms per hour or PM2.5 exposure of 101 micrograms per hour) either alone or in combination. In some embodiments, the software application may also take as input physiological characteristics of the user, such as lung capacity, resting heart rate, age, weight, and/or gender.

In some embodiments, the software application includes a tool (not shown) to share and/or export the data entered by the user into the software application, or selected by the user from suggestions generated by the software application. Sharing and exporting data may assist users in planning activities, possibly with one another, and to keep track of the data. The data that can be shared may include the timeframe 112 selected by the user, include the start time, end time, and/or duration of the timeframe 112, the accumulated level 130 of exposure to the selected data type 104, and/or the user's planned activity during the timeframe 112. The shared data can be shared, for example, by email as text and/or graphics, as a calendar object, as a link, to a website, to a push service, etc., or any combination thereof. Alternatively or additionally, the shared data can be shared by text, or through social media platforms such as Facebook™, Twitter™, etc. In some embodiments, the shared data may include an invitation to join in the designated activity, at the designated time. A user that has received shared data may import the data into his or her own mobile device software application.

In some embodiments, the software application may also enable the user to set a beacon, waypoint, or location indicator for the location where he or she will engage in the activity. The beacon data may also be included in the shared data. The software application may use the beacon data to alert the user that he or she is close to the designated location. The software application may also use beacon data to indicate to the user that a “friend” or user who has received shared data is nearby. Alternatively or additionally, the software application may indicate to the user where a friend is located. The software application may also create “groups” of friends, that is, groups of users sharing data.

In some embodiments, the user's selection data can be exported to another application, such as for instance a calendar program. The user's selected timeframe 112 can be entered into the calendar. In some embodiments, the software application may import calendar data, and use the calendar data in determining the suggested timeframe. For example, the software application may suggest only timeframes when the user has not already scheduled an activity in his or her calendar. In some embodiments, the software application may set calendar alerts to alert the user when the user's selected timeframe 112 has been reached and possibly also when the timeframe has ended.

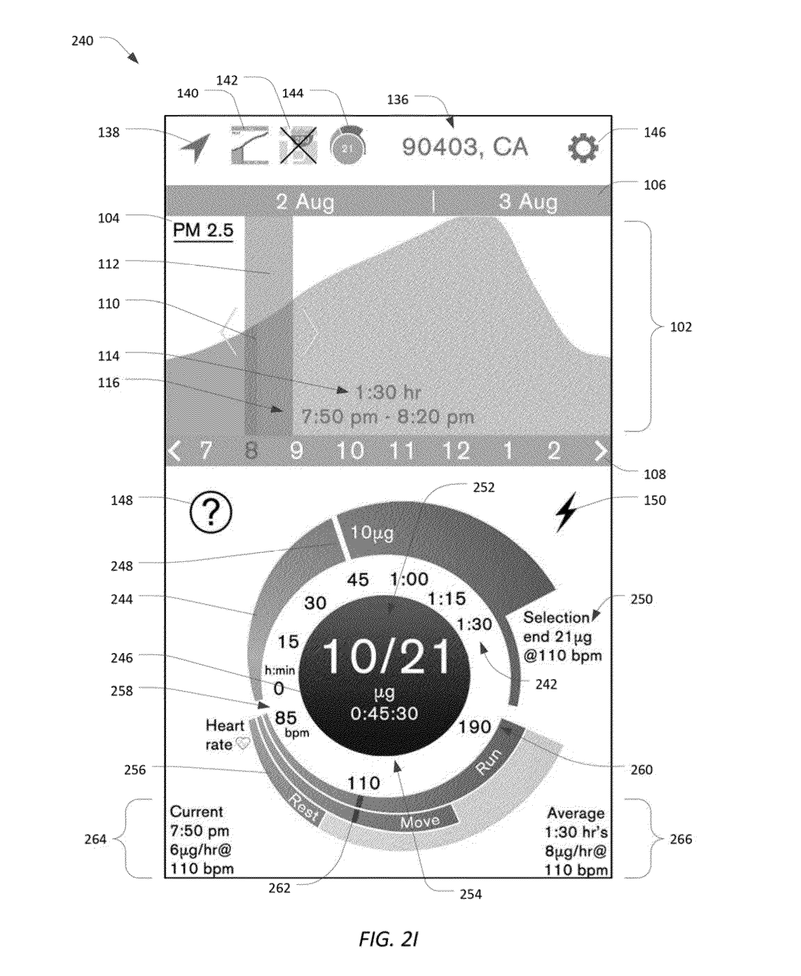

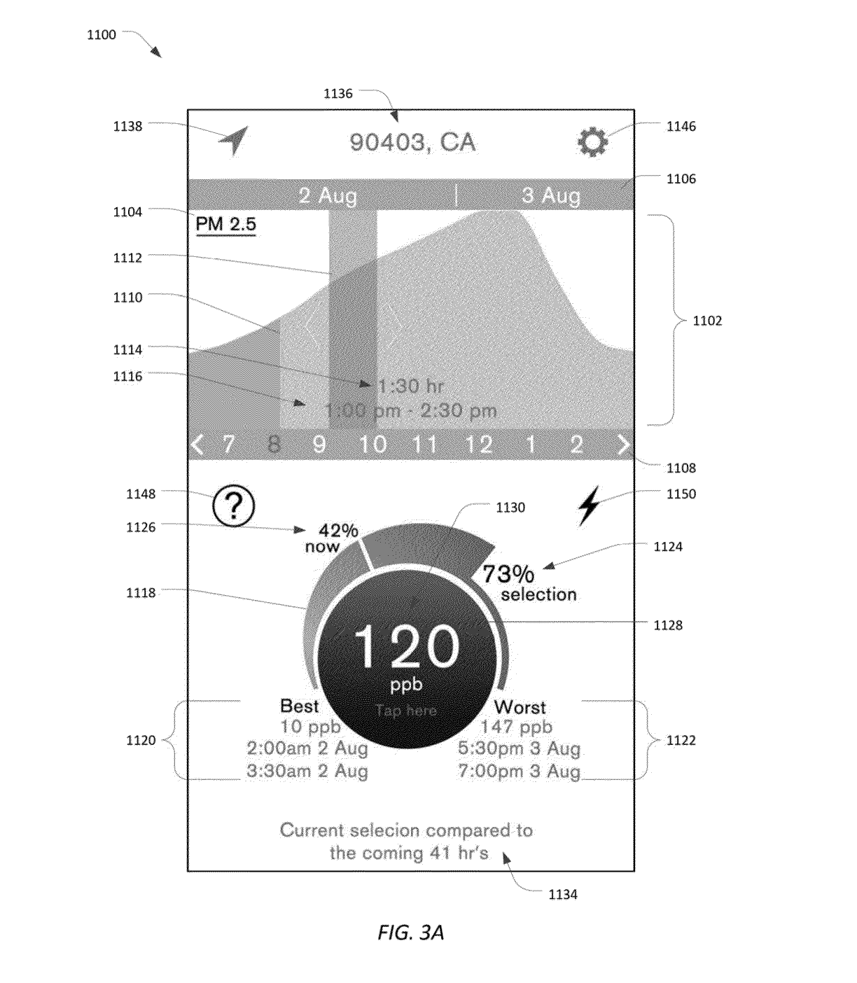

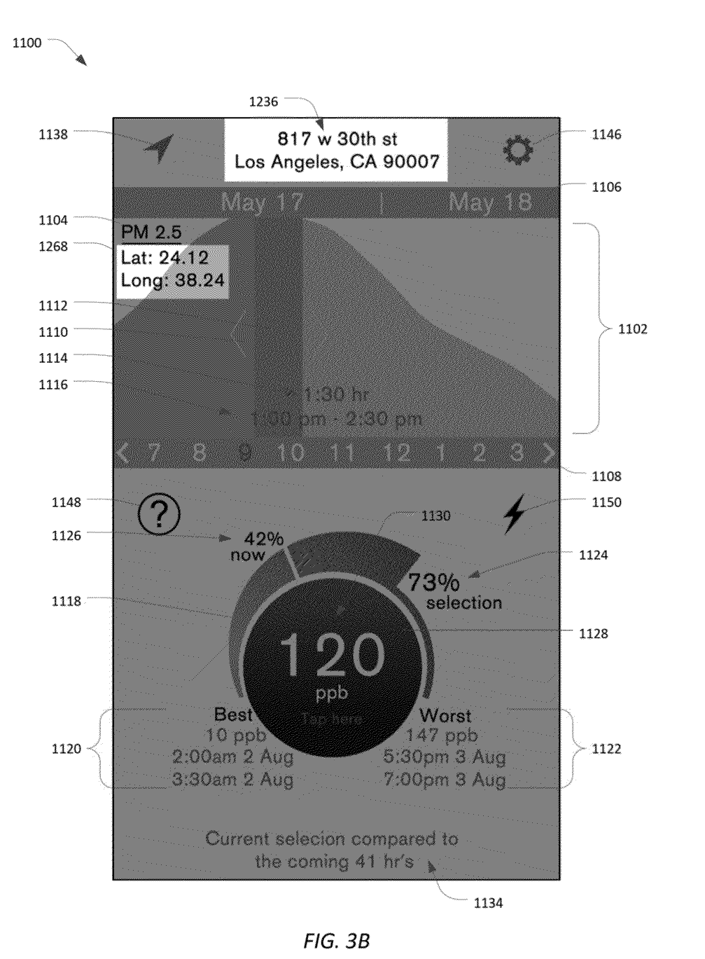

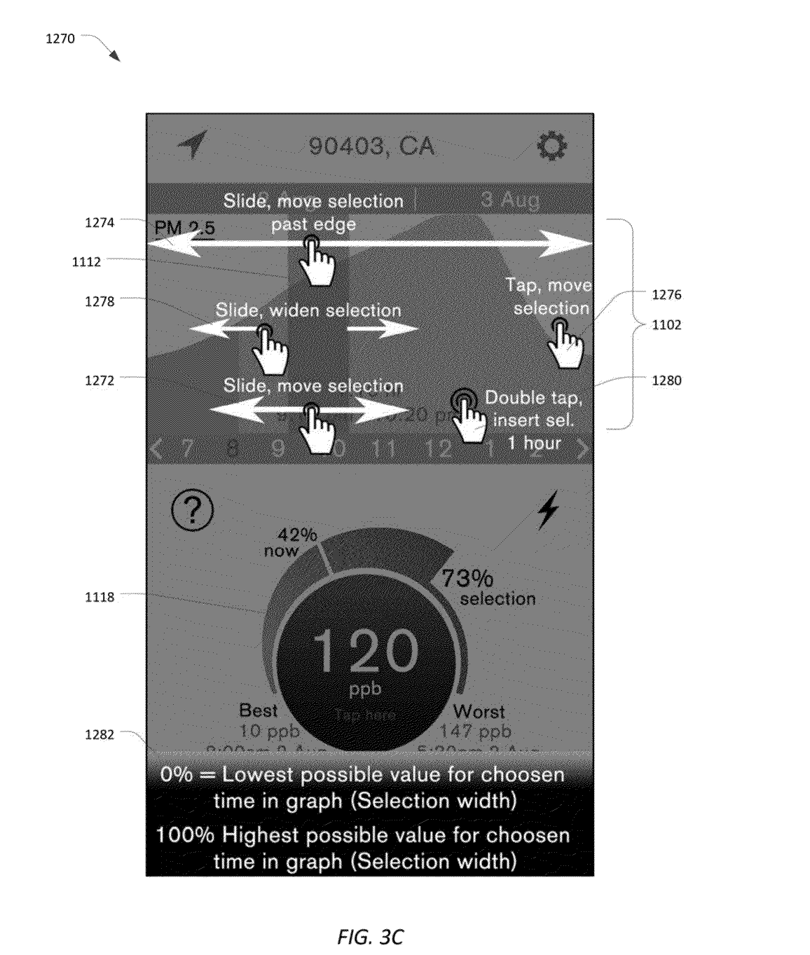

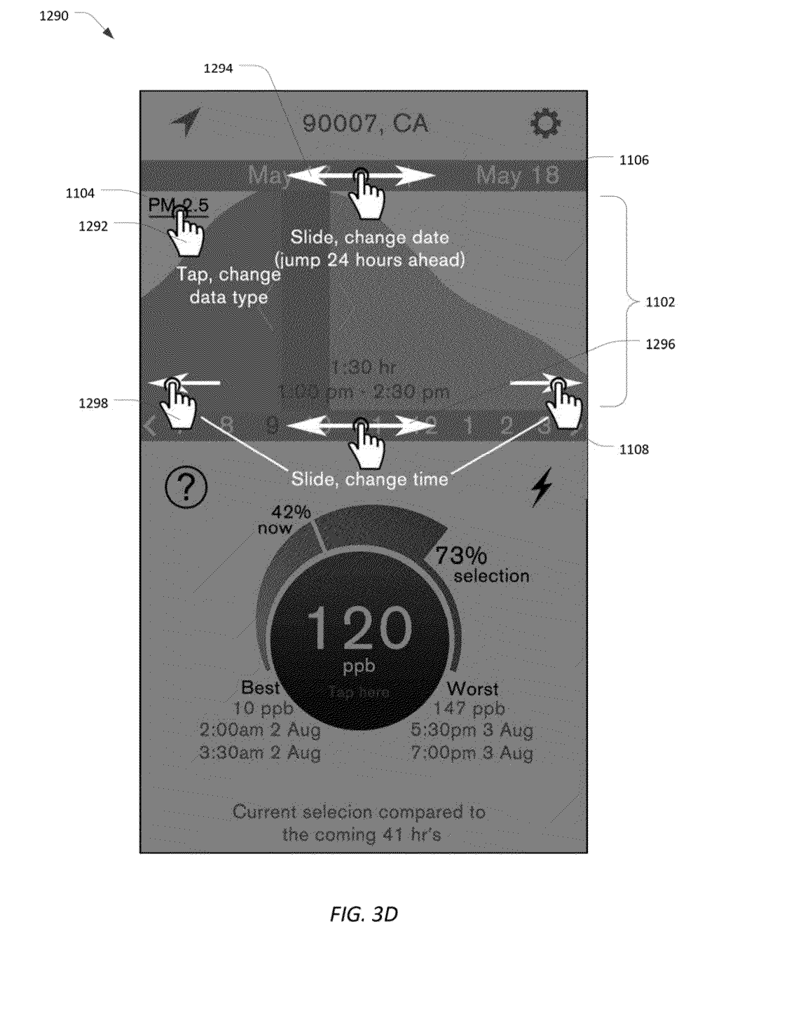

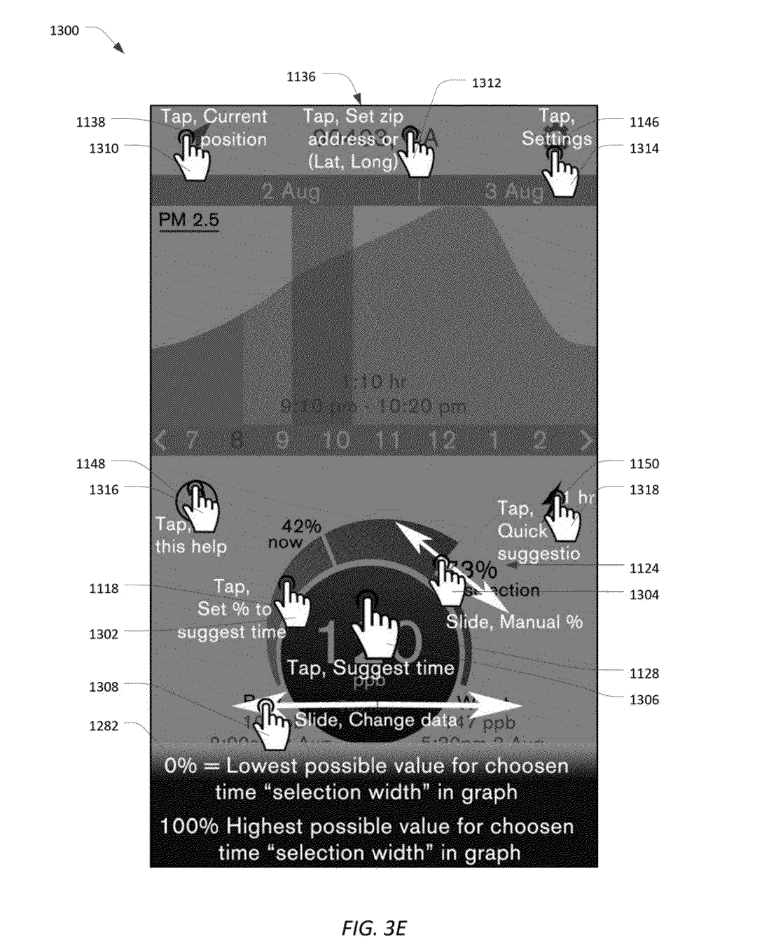

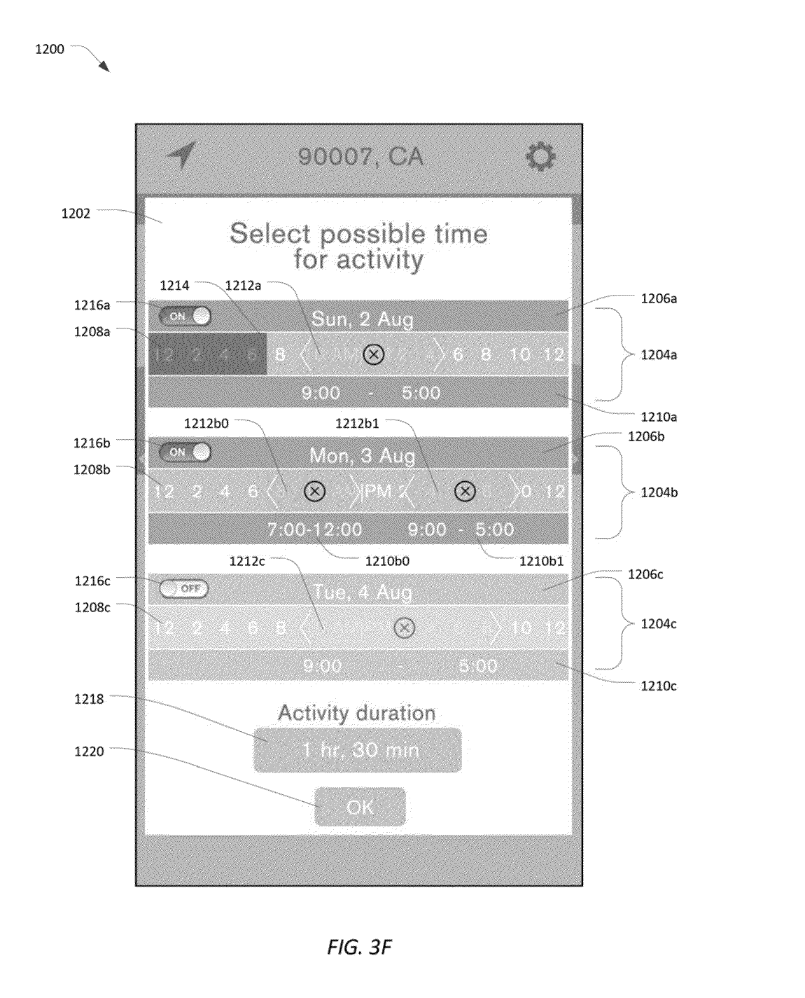

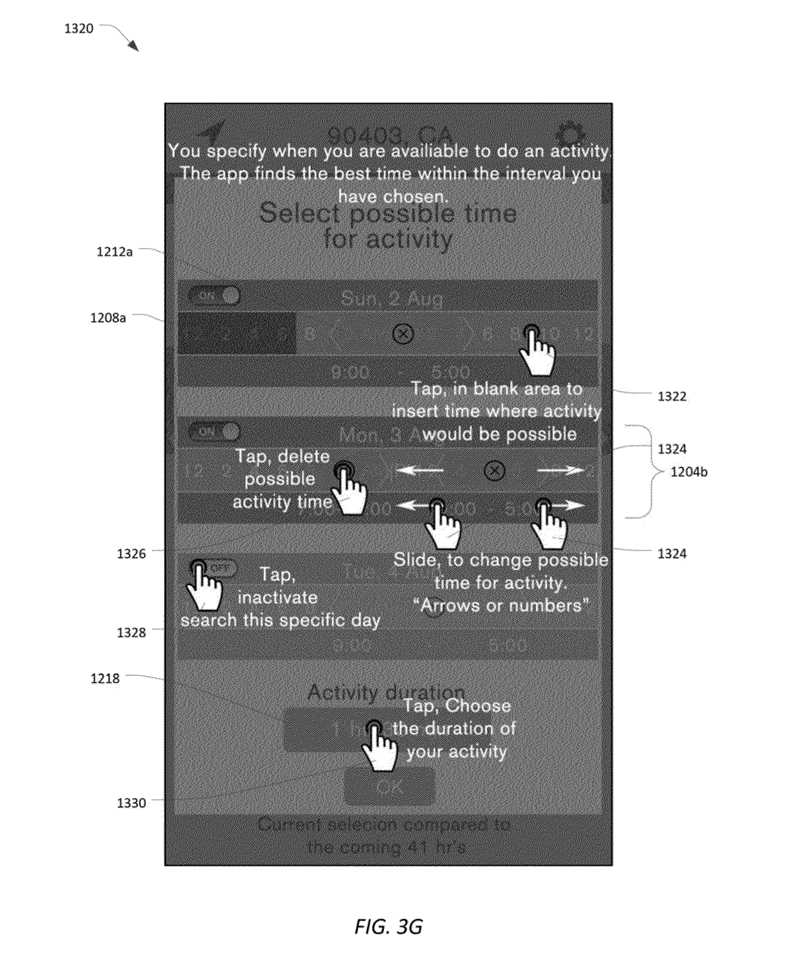

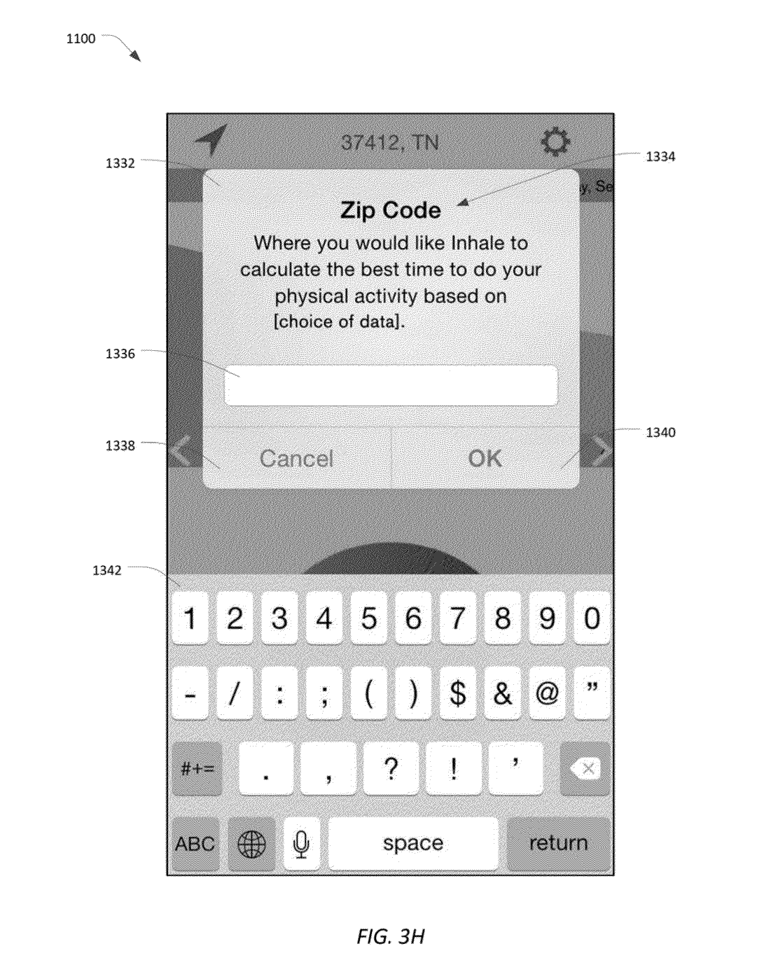

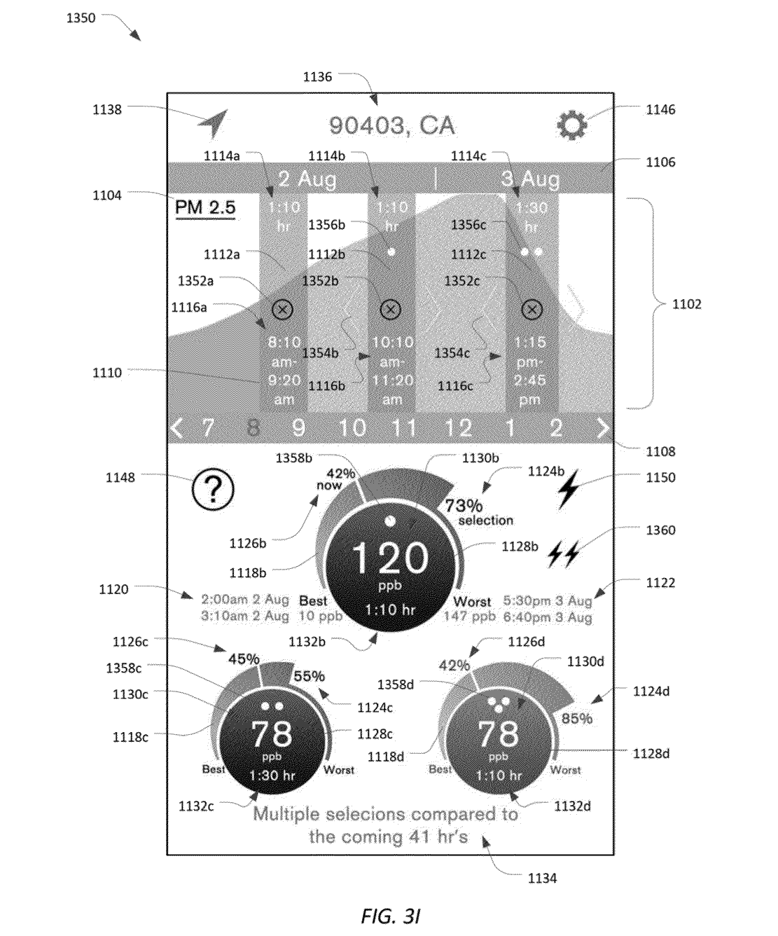

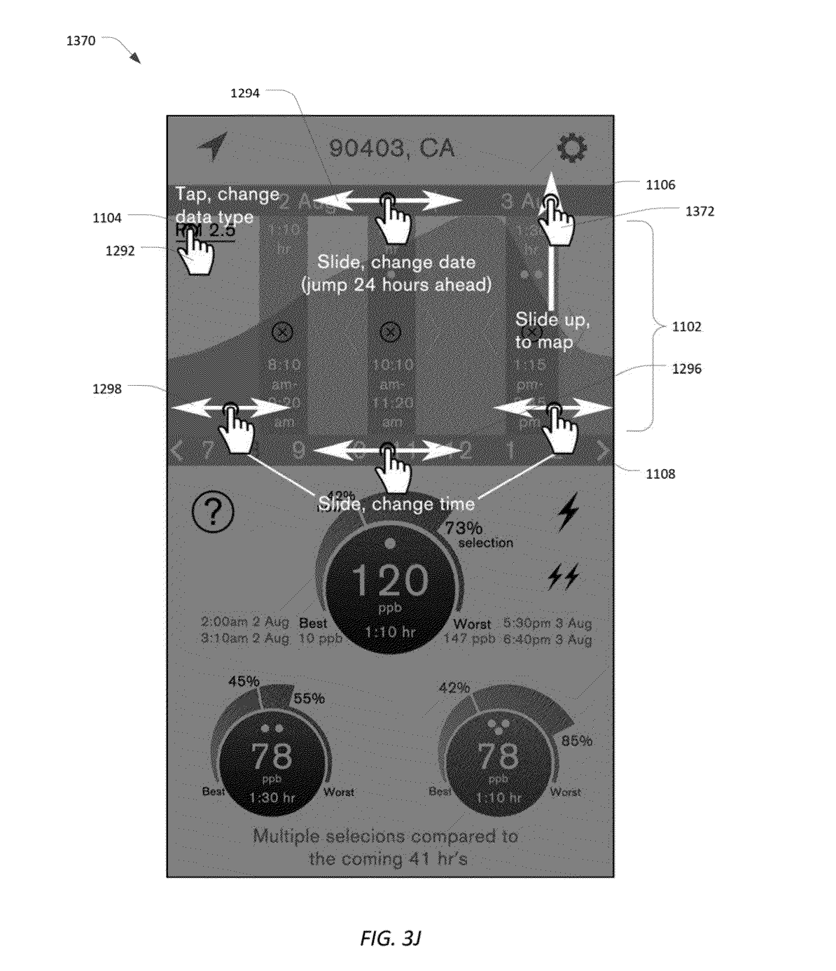

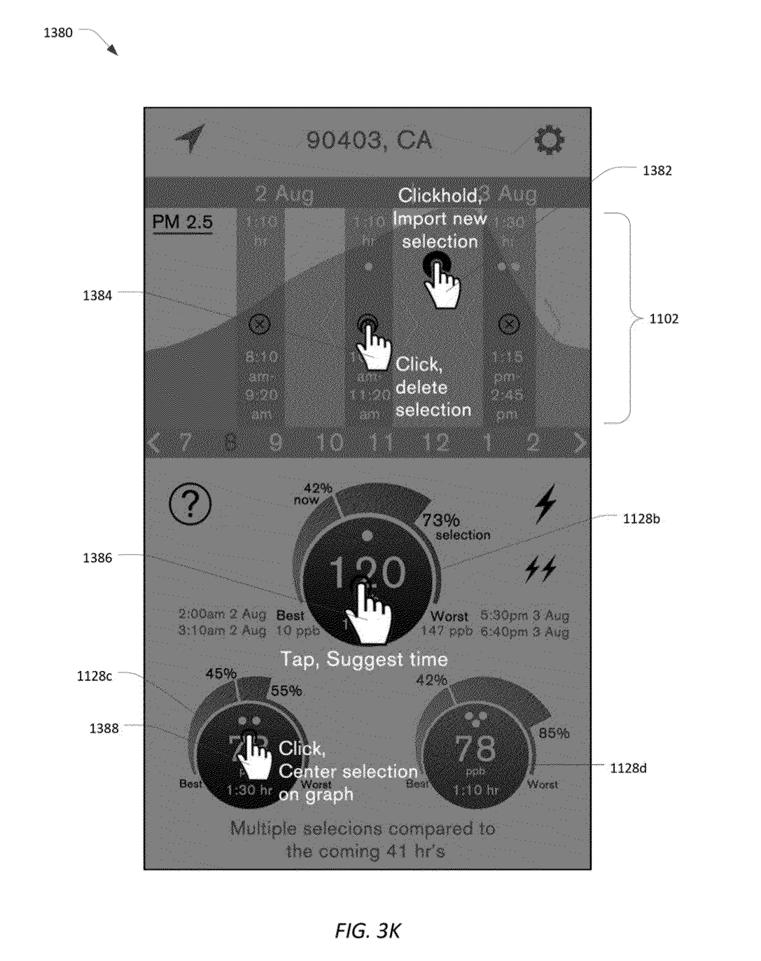

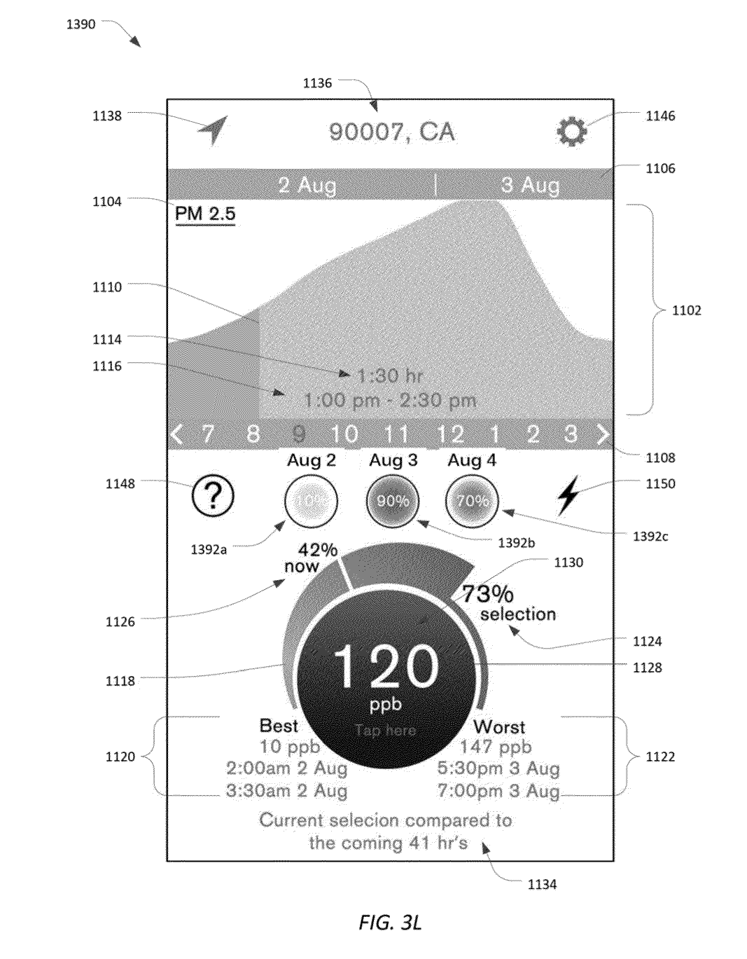

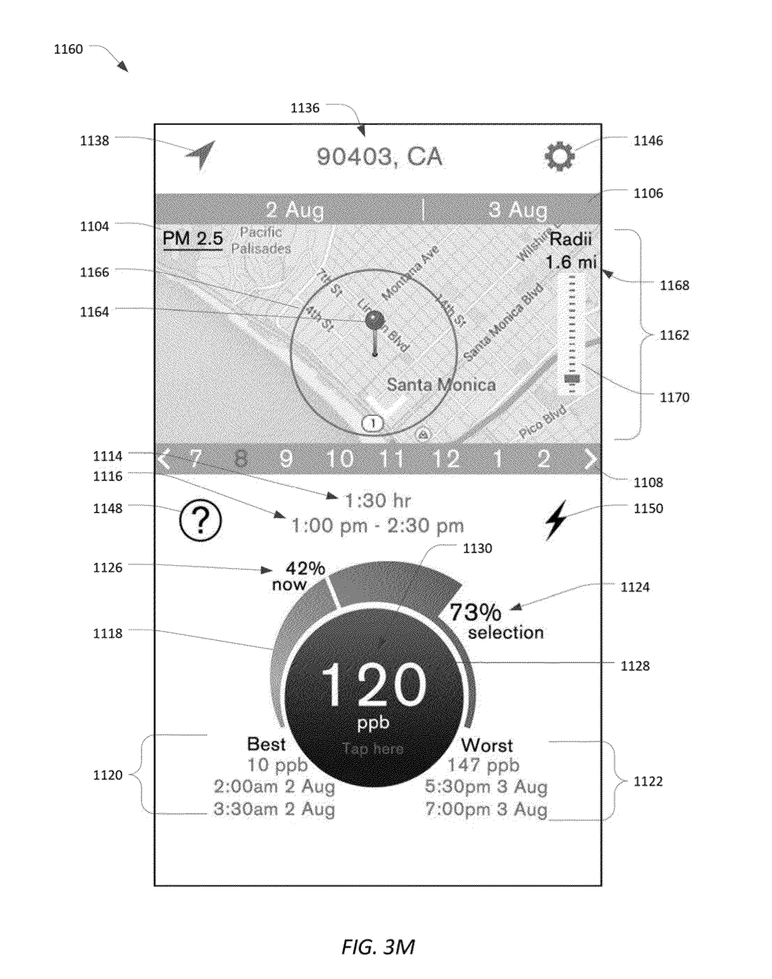

FIG. 3A illustrates another embodiment of a main screen 1100 of a software application for mobile devices that provides users with suggested times for engaging in an activity for a given duration and in a specified location based on outdoor conditions. The main screen 1100 of FIG. 3A is similar to the main screen 10100 of FIG. 1A except as described below. The main screen 1100 of FIG. 3A includes: a graph 1102, the graph's 1102 data type 1104, the date and/or range of dates 1106 displayed by the graph 1102, the hours 1108 displayed by the graph 1102, a current time 1110 indicator on the graph 1102, a selected time frame 1112 on the graph 1102, the duration 1114 of the selected timeframe 1112, and the start and end times 1114 of the timeframe 1112. The main screen 1100 also displays an exposure meter 1118, including the best 1120 accumulated level and timeframe over the selected days, the worst 1122 accumulated level and timeframe over the selected days, the percentage accumulated value 1124 for the selected timeframe 1112, and the percentage accumulated value 1126 for the current timeframe 1112. The exposure meter 1118 includes a multi-function button 1128, which displays the accumulated value 1130 for the selected timeframe 1112. The main screen 1100 also displays text 1134 indicating what is presently being displayed on the main screen 1100. The main screen 1100 also displays the location 1136 for the displayed data, and includes an update-to-current-location button 1138, a settings button 1146, a help button 1148, and a quick suggestion button 1150.

FIG. 3B illustrates an embodiment of the main screen 1100 with alternate location data 1236. As illustrated in FIG. 3B, the user's selected location can be displayed as an address 1236 instead of a zip code. The location display type may be toggled by selecting or tapping on the area displaying the location. The location can also be displayed as geographic coordinates 1268, in terms of latitude and longitude. The main screen 1100 of FIG. 3B otherwise displays the same or similar elements as in FIG. 3A.

FIG. 3C illustrates a first help or tutorial screen 1270 for the main screen 1100. The first help screen 1270 illustrates, among other things, help information for how to modify the selected timeframe 1112 on the graph 1102. As illustrated and explained by the first help screen 1270, the start and end time of the selected timeframe 1112 can be changed by selecting the selected timeframe 1112 and sliding 1272 left or right. Alternatively or additionally, the start and end time of the selected timeframe 1112 can be changed by tapping or selecting 1276 an area of the graph 1102. The selected timeframe 1112 can be moved 1274 to another day be sliding it past the edge of the screen; the days and hours displayed by the graph 1102 may update accordingly. The duration of the selected timeframe 1112 can be changed by selecting at or near the edge of the bar representing the selected timeframe 1112 and sliding 1278 left or right. In some embodiments, double-tapping or double-clicking 1280 on an area of the graph 1102 removes the selected timeframe 1112 and inserts a new timeframe of one hour at the selected time. In some embodiments a second or subsequent timeframe can be inserted onto the graph 1102 by double-tapping or double-clicking 1280 on an area of the graph 1102. The first help screen 1270 also may display information 1282 at the bottom of the screen, such as for instance what the percentages displayed by the meter 1118 represent.

FIG. 3D illustrates a second help or tutorial screen 1290 for the main screen 1100. The second help screen 1290 illustrates help information for how to change the data type 1104 and how to modify the range of data that is displayed by the graph 1102. The data type 1104 can be changed by selecting or tapping 1292 the displayed data type 1104. The data and elements represented on the main screen 1100 will subsequently be updated to reflect the selected data type 1104. The date range 1106 can be changed by selecting the displayed date range 1106 and sliding 1294 left or right; the displayed date range 1106 may change by one hour at a time and/or by twenty-four hours at a time. The data displayed by the main screen 1100 will update accordingly. The hours 1108 displayed by the graph 1102 can be changed by selecting the hours 1108 displayed and sliding 1296 left or right. The data displayed by the graph 1102, and possibly also the displayed date range 1106, will update accordingly. The date 1106 and hour 1108 range displayed by the graph 1102 can also be changed by selecting the graph 1102 itself and sliding 1298 left or right. The date range 1106 and hours 1108 may update accordingly.

FIG. 3E illustrates a third help or tutorial screen 1300 for the main screen 1100. The third help screen 1300 illustrates and explains, among other things, how to modify the value represented by the exposure meter 1118, how to use the multi-function button 1128, and how to use various other buttons on the main screen 1100. As illustrated and explained by the third help screen 1300, the exposure meter 1118 can be used to select 1302 a percentage 1124 such that the selected 1302 percentage 1124 is used by the software application to suggest a timeframe; that is, the software application will attempt to find a timeframe of the given duration that will result in an accumulated exposure according to the selected 1302 percentage 1124. Alternatively or additionally, a percentage 1124 can be selected by selecting the exposure meter 1118 and sliding 1304 along between the ends of the exposure meter 1118. The third help screen 1300 also illustrates that selecting or tapping 1306 the multi-function button 1128 directs the user to a suggestion screen, such as the suggestion screen 1200 described below. The third help screen 1300 also illustrates that sliding 1308 across the area including the exposure meter 1118 will change the display to another display, such as the active timeframe screen 240 illustrated in FIG. 2I. When an active timeframe screen is thus enabled, the active timeframe is set to the present, that is, starting at the current time and ending after the designated duration.

Returning to FIG. 3E, the third help screen 1300 also illustrates and explains that selecting or tapping 1310 on the current location button 1138 will change the displayed location 1136 to the user's current location, as given by a GPS receiver, cellular triangulation, Internet location, or some other system for determining location. Selecting or tapping 1312 the displayed location 1136 directs the user to a location selection pop-up, such as the location selection pop-up 332 described below. Selecting or tapping 1314 a settings button 1146 directs the user to a settings screen. Also illustrated by the third help screen 1300 is selecting or tapping 1316 of a help button 1148 to direct the user to this or other help screens, tutorials, or help/tutorial systems. Also illustrated is selecting or tapping 1318 of a quick suggestion button 1150 to activate a quick suggestion as described above. The third help screen 1300 may also display information 1282 near the bottom of the screen, such as for instance a description of what is represented by the percentages displayed by the exposure meter 1118.

The help and/or tutorial screens described in FIGS. 3C-3E may be incorporated into a single help screen. Alternatively or additionally, the various elements of each help and/or tutorial screen may each be displayed in individual screens. Alternatively or additionally, the help and/or tutorial screen may be displayed in an automated sequence, such as for instance in a video or slideshow. Alternatively or additionally, the help and/or tutorial screens may be interactive, such that the various elements highlight and/or respond to selection by the user.

FIG. 3F illustrates one embodiment of a suggestion screen 1200. The suggestion screen 1200 is similar to the suggestion screen 200 illustrated in FIG. 2E. As illustrated in FIG. 3F, the suggestion screen 1200 comprises a pop-up window 1202. The pop-up window 1202 includes one or more date and time selectors 1204a, 1204b, 1204c. The date and time selectors 1204a, 1204b, 1204c each include a date 1206a, 1206b, 1206c, a time bar 1208a, 1208b, 1208c, and display start and end times 1210 for the selected periods of the day 1212. Each date and time selector 1204a, 1204b, 1204c may include a selected period of the day 1212, and in some embodiments the date and time selectors 1204b may allow the user to select two or more periods of the day 1212b0, 1212b1. When a date and time selector 1204a includes the current time 1214, the current time 1214 is indicated on the time bar 1208a. Each date and time selector 1204a, 1204b, 1204c includes an on/off button 1216a, 1216b, 1216c that allows the user to remove that date and time selector 1204a, 1204b, 1204c from being included in the selected timeframes. The pop-up window 1202 also includes a duration button 1218 for selecting a desired time duration, and an “OK” button 1220 for accepting the selections and dismissing the pop-up window 1202.

FIG. 3G illustrates a help or tutorial screen 1320 for the suggestion screen 1200. The help screen 1320 illustrates that tapping 1322 on a time bar 1208 inserts a period of time into a date and time selector 1204. The help screen 1320 further illustrates that selecting and sliding 1324 the edge of a period of time 1212 will change the starting or ending time of the period of time 1212. The help screen 1320 also illustrates that tapping 1326 on the X on the timeframe 1212 will delete the timeframe. The help screen 1320 also illustrates that tapping 1328 on an on/off button 1216 will disable the date and time selector 1204 associated with that on/off button. The help screen 1320 also illustrates that selecting or tapping 1330 on the duration button 1218 allows the user to set the desired duration for his or her activity.

FIG. 3H illustrates one embodiment of a main screen 1100 with a pop-up window 1332 for setting a location. The location suggestion screen comprises a pop-up window 1332 that is present to the user when the user selects or taps the current location 1136 on the main screen 1100. The pop-up window 1332 indicates how 1334 the user can enter a location; for example, the user may be able to enter a zip code, street address, GPS coordinates, etc. The pop-up window 1332 includes a text box 1336 in which the user can enter his or her desired location. The pop-up window 1332 also includes a “Cancel” button 1338, which, if selected, will dismiss the pop-up window 1332 without accepting the entry in the text box 1336. The pop-up window 1332 also includes an “OK” button that will accept the user's entry and dismiss the pop-up window 1332. In embodiment where the mobile device supports on-screen keyboards, an on-screen keyboard 1342 may be presented to the user for entering text into the text box 1336.

FIG. 3I illustrates one embodiment of a multiple selections screen 1350. The multiple selections screen 1350 of FIG. 3I is similar to the multiple selections screen 10350 of FIG. 1D, except as described below. The multiple selections screen 1350 of FIG. 3I includes: one or more timeframes 1112 on the graph 1102, possibly not visible, and multiple exposure meters 1118, where identifiers 1356 on the timeframes 1112 and identifiers 1358 on the exposure meters 1118 indicate which timeframe 1112 is associated with which exposure meter 1118. Timeframes 1112 can be removed by selecting a delete selection button 1352. The active timeframe screen 1350 also includes a daily quick suggestion button 1360 that, when selected, will suggest timeframes 1112 for each of several days. In all other respects, the active timeframe screen 1350 includes similar elements and functionality as the active timeframe screen 101350 of FIG. 1d.

FIG. 3J illustrates a first help or tutorial screen 1370 for the multiple selections screen 1350. As illustrated and explained by the first help screen 1370, the data type 1104 of the data displayed by the graph 1102 can be changed by selecting or tapping 1292 the displayed data type 1104. The date range 1106 displayed by the graph 1102 can be changed by selecting the displayed date range 1106 and sliding 1294 left or right. The hours 1108 displayed by the graph 1102 can be changed by selecting the hours 1108 and sliding 1296 left or right. The data displayed by the graph 1102 can also be changed 1298 by selecting the graph 1102 and sliding 1298 left or right. The display can also be changed to a map by selecting the graph 1102 and sliding 1372 it up.

FIG. 3K illustrates a second help or tutorial screen 1380 for the multiple selections screen 1350. As illustrated and explained in the second help screen 1380, the user can insert a new timeframe by selecting and holding down 1382 on the graph 1102. The user can delete a timeframe by selecting 1384 a delete button that is associated with each timeframe. Also illustrated and explained is that selecting or tapping 1386 on the primary multi-function button 1128b will cause a suggestion screen, such as the suggestion screen 1200 illustrated in FIG. 3F, to be displayed. Also illustrated in FIG. 3F is that selecting or tapping 1388 on a secondary 1128c or tertiary 1128d multi-function button will cause the timeframe associated with the button to be centered on the graph 1102.

FIG. 3L illustrates an embodiment of a daily total value screen 1390. The daily total value screen 1390 displays a daily value 1392a, 1392b, 1392c for multiple days in advance, such as for instance for each day in the near future for which data is available. Each daily value 1392a, 1392b, 1392c includes a date and a value. The value may be relative to the best 1120 and worst 1122 accumulated values displayed with the exposure meter 1118. Alternatively or additionally, the value may be an absolute value for each day, such as for instance an accumulated value for each day. The daily value 1392a, 1392b, 1392c may also indicate a relative difference to the data displayed by the exposure meter 1118 with a different color or shading. Selecting or tapping on a daily value 1392a, 1392b, 1392c may allow the user to specify the start and/or end times that delineate the start and/or end of a day, for the selected day and/or all days. The daily total value screen 1390 otherwise includes similar elements as the main screen 1100.

FIG. 3M illustrates one embodiment of a small map screen 1160. The small map screen 1160 displays a small map 1162. The small map 1162 may include a pin 1164 indicating a selected location. The small map 1162 may also include a circle 1164 of a certain radius around the pin 1162 indicating an area a certain distance around the selected location 1162. The small map 1162 may display a numerical value 1168 of the radius of the circle 1166. The small map 1162 may also provide a slider bar 1170 to modify and set the radius of the circle 1166. In all other aspects, the small map screen 160 includes the same or similar elements as the main screen 1100.

FIG. 3N illustrates one embodiment of a large map screen 1180. The large map screen 1180 displays a large map 1182 displaying a larger area than is displayed by the small map 1162. The large map 1182 may display the same information that is displayed by the small map 1162. The large map 1182 may also display a general direction in which the accumulated levels (e.g., accumulated levels of fine particles) are decreasing 1192. The decreasing levels 1192 are indicated with arrows of a particular color and direction, as illustrated by a legend on the large map screen 1180. The large map 1182 may also display a general direction in which the accumulated levels are increasing 1194. The increasing levels 1194 are indicated with arrows of a particular color and direction, as illustrated by a legend on large map screen 1180. The large map 1182 may also display a numerical value 1188 of a duration set or selected from the main screen 1100. The large map 1182 may also display a slider bar 1190 to modify and set the duration value 1188. The large map 1182 may also display a grid button 1184 that toggles display of a grid overlaying the large map 182. In all other aspects, the large map screen 1180 includes the same or similar elements as the mains screen 1100, possibly reduced in size to accommodate the size of the large map 1182.

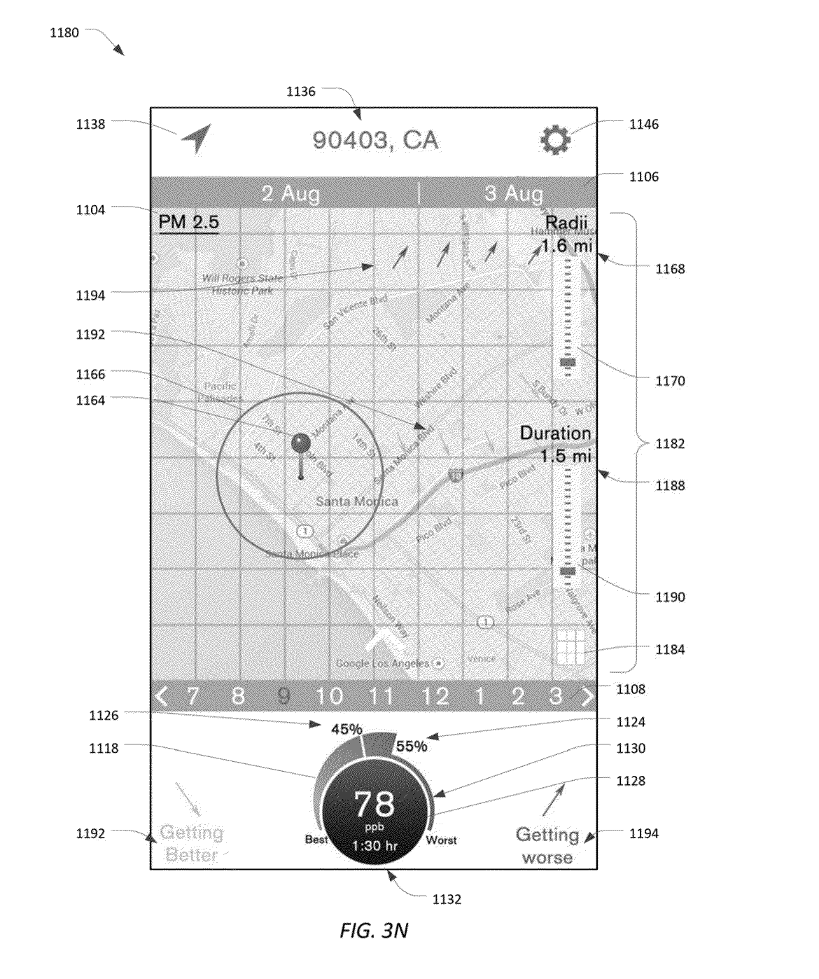

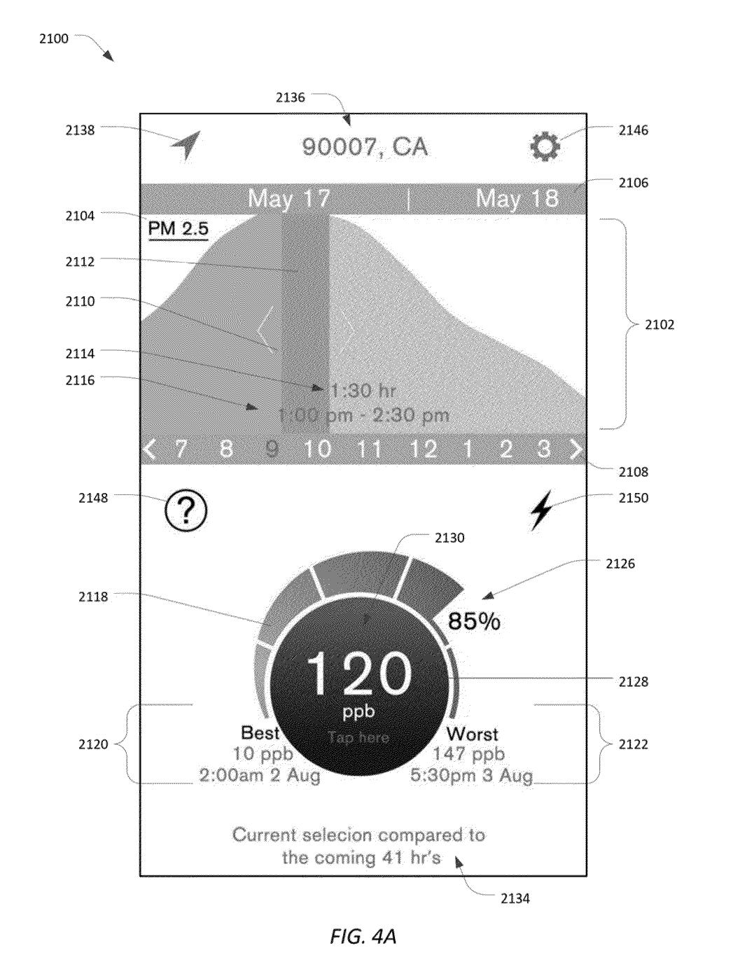

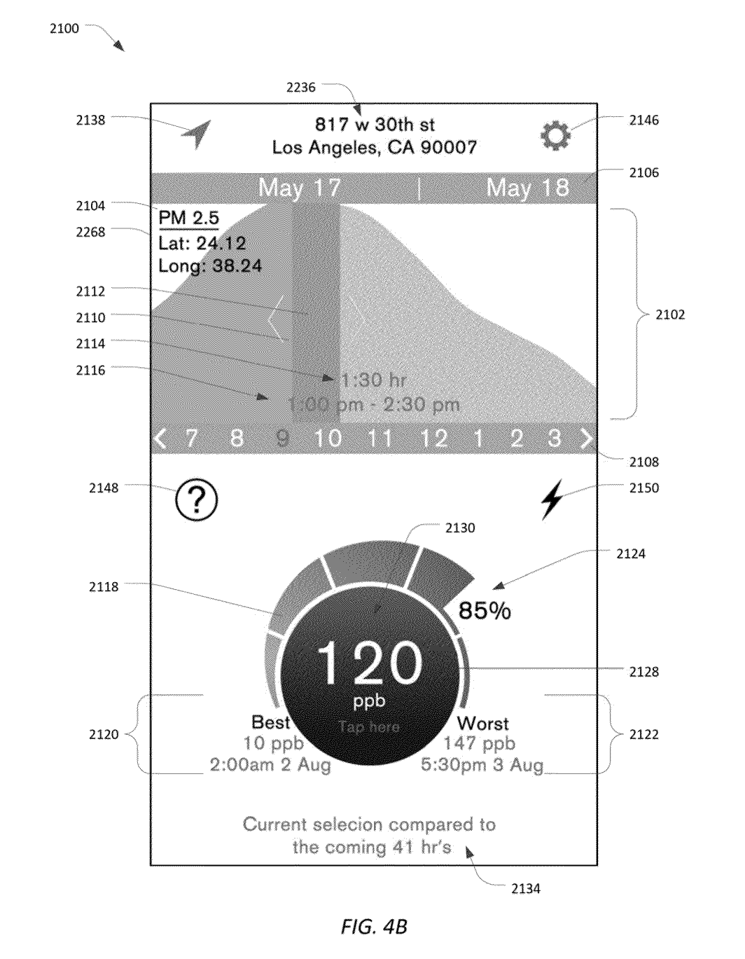

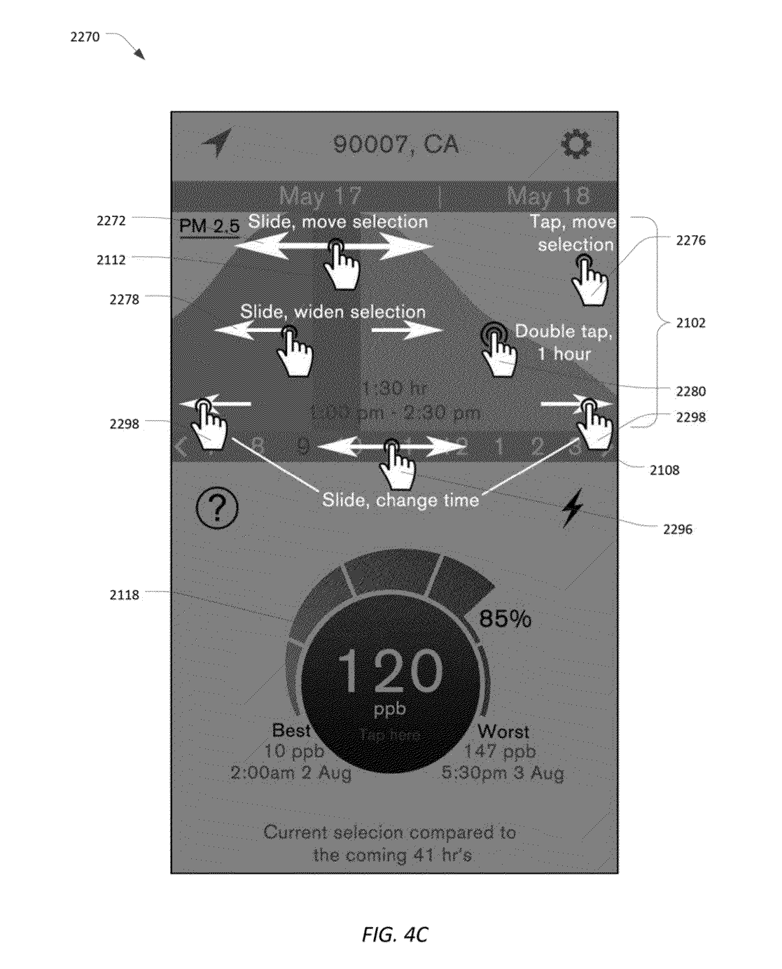

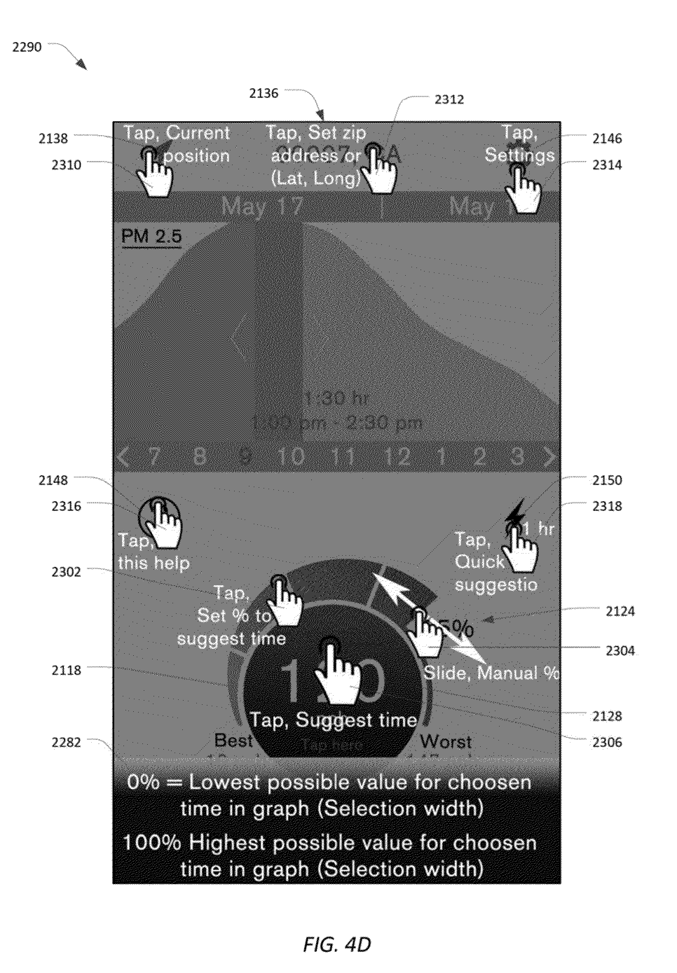

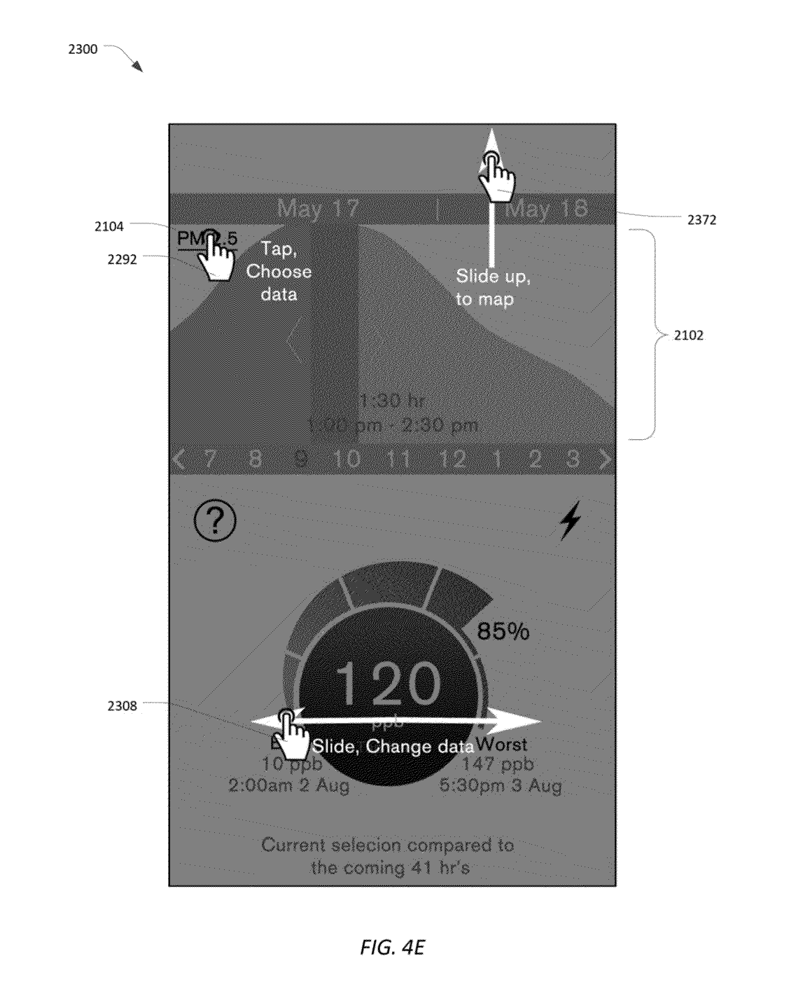

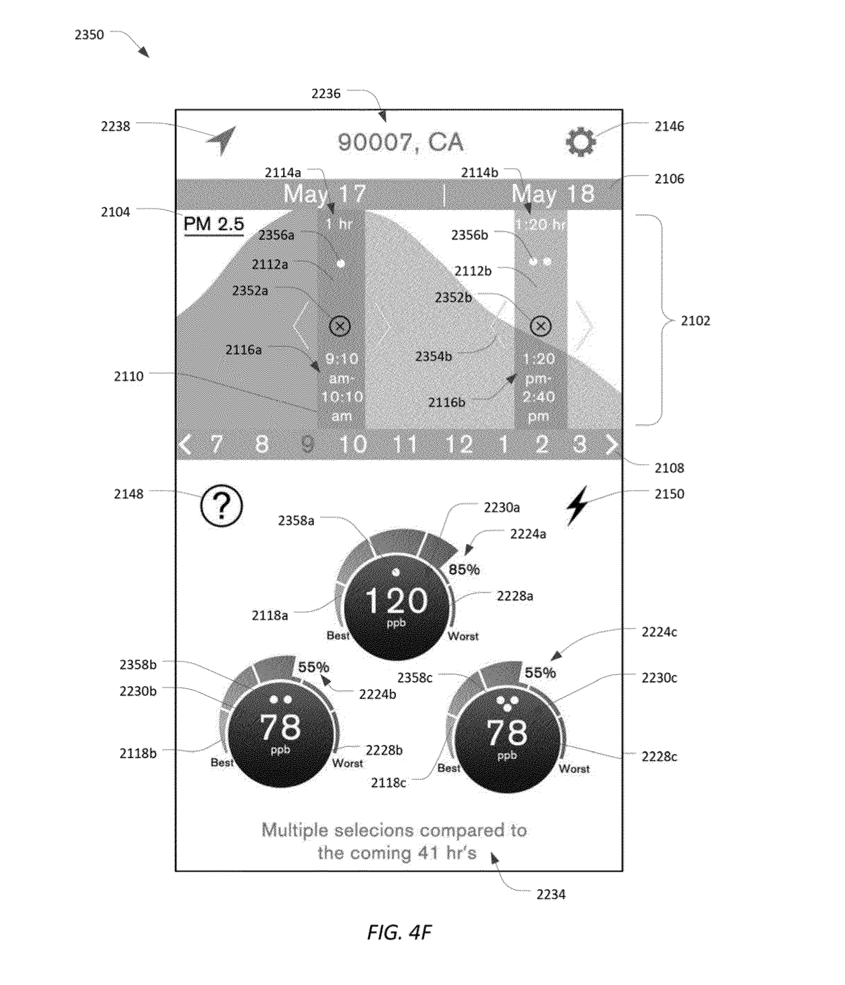

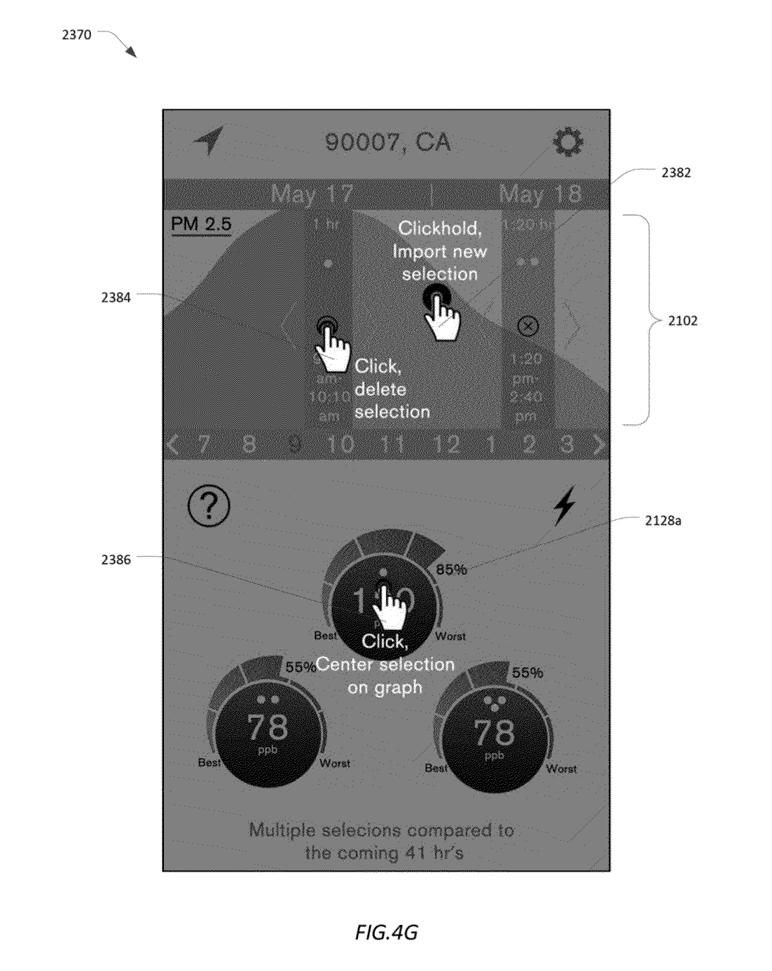

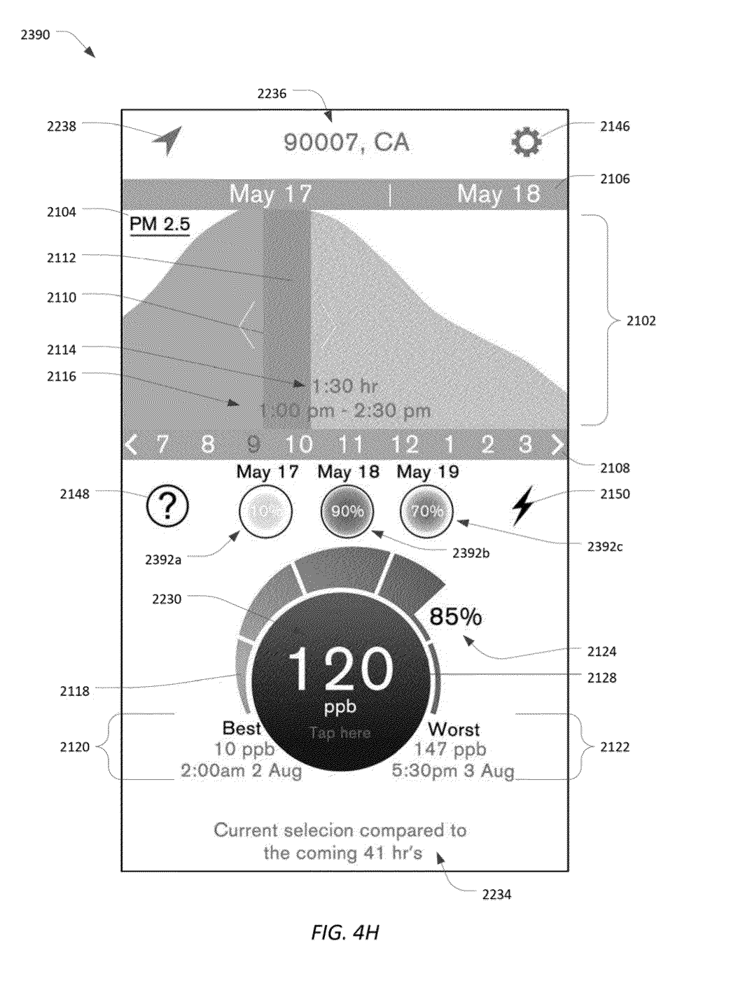

FIG. 4A illustrates another embodiment of the main screen 2100 of a software application for mobile devices that provides users with suggested times for engaging in an activity for a given duration and in a specified location based on outdoor conditions. The main screen 2100 of FIG. 4A is similar to the main screen 10100 of FIG. 1A except as described below. The main screen 2100 of FIG. 4A includes: a graph 2102, the graph's 2102 data type 2104, the date and/or range of dates 2106 displayed by the graph 2102, the hours 2108 displayed by the graph 2102, a current time 2110 indicator on the graph 2102, a selected time frame 2112 on the graph 2102, the duration 2114 of the selected timeframe 2112, and the start and end times 2114 of the timeframe 2112. The main screen 2100 also displays an exposure meter 2118, including the best 2120 accumulated level and start time over the selected days, the worst 2122 accumulated level and start time over the selected days, and the percentage accumulated value 2124 for the selected timeframe 2112. The exposure meter 2118 also includes a multi-function button 2128, which displays the accumulated value 2130 for the selected timeframe 2112. The main screen 2100 also displays text 2134 indicating what is presently being displayed on the main screen 2100. The main screen 2100 also displays a location 2136 for the data and includes an update-to-current-location button 2138, a settings button 2146, a help button 2148, and a quick suggestion button 2150.

FIG. 4B illustrates an embodiment of the main screen 2100 with alternate location data. As illustrated in FIG. 4B, the location for the data can be displayed as an address 2236 instead of a zip code. The display type may be toggled by selecting or tapping on the area displaying the location. The user's selected location can also be displayed as geographic coordinates 2268, in terms of latitude and longitude. The main screen 2100 of FIG. 4B otherwise includes similar elements and functionality as in FIG. 4A.

FIG. 4C illustrates a first help or tutorial screen 2270 for the main screen 2100. The first help screen 2270 illustrates, among other things, help information for how to modify the selected timeframe 2112 on the graph 2102. As illustrated and explained by the first help screen 2270, the start and end time of the selected timeframe 2112 can be changed by selecting the selected timeframe 2112 and sliding 2272 left or right. Alternatively or additionally, the start and end time of the selected timeframe 2112 can be changed by tapping or selecting 2276 an area of the graph 2102. The duration of the selected timeframe 2112 can be changed by selecting at or near the edge of the vertical bar representing the selected timeframe 2112 and sliding 2278 left or right. In some embodiments, double-tapping or double-clicking 2280 an area of the graph 2102 removes the selected timeframe 2112 and inserts a new timeframe of one hour at the selected time. In some embodiments, a second or subsequent timeframe can be inserted onto the graph 2102 by double-tapping or double-clicking 2280 on an area of the graph 2102; the new timeframe will have a default (possibly configurable) time period, such as one hour. The hours 2108 displayed by the graph 2102 can be changed by selecting the hours 2108 displayed and sliding 2296 left or right. The data displayed by the graph 2102, and possibly also the displayed date range 2106, will update accordingly.

FIG. 4D illustrates a second help or tutorial screen 2290 for the main screen 2100. As illustrated and explained by the second help screen 2290, the exposure meter 2118 can be used to select 2302 a percentage 2124 such that the selected 2302 percentage 2124 is used by the software application to suggest a timeframe; that is, the software application will attempt to find a timeframe of the given duration that will result in an accumulated exposure according to the selected 2302 percentage 2124. Alternatively or additionally, a percentage 2124 can be selected by selecting the exposure meter 2118 and sliding 2304 along between the ends of the exposure meter 2118. The second help screen 2290 also illustrates that selecting or tapping 2306 the multi-function button 2128 directs the user to a suggestion screen. The second help screen 2290 also illustrates and explains that selecting or tapping 2310 on the current location button 2138 will change the current location 2136 to the user's current location, as given by a GPS receiver, cellular triangulation, Internet location, or some other system for determining location. Selecting or tapping 2312 the selected location 2136 directs the user to a location selection screen. Selecting or tapping 2314 a settings button 2146 directs the user to a settings screen. Also illustrated by the second help screen 2290 is selecting or tapping 2316 of a help button 2148 to direct the user to this or other help screens, tutorials, or help/tutorial systems. Also illustrated is selecting or tapping 2318 of a quick suggestion button 2150 to activate a quick suggestion as described above. The second help screen 2290 may also display information 2282 near the bottom of the screen, such as for instance a description of what is represented by the percentages displayed by the exposure meter 2118.

FIG. 4E illustrates a third help or tutorial screen 2300. As illustrated and explained by the third help screen 2300, the data type 2104 of the data displayed by the graph 2102 can be changed by selecting or tapping 2292 the displayed data type 2104. The third help screen 2300 also illustrates that the graph 2102 display can be changed to a map by selecting the graph 2102 and sliding 2372 up. The third help screen 1300 also illustrates that sliding 2308 across the area including the exposure meter 2118 will change the display to another meter.

FIG. 4F illustrates one embodiment of a multiple selections screen 2350. The multiple selections screen 2350 may be displayed when the user inserts more than one timeframe 2112 on the graph 2102, for instance, from the main screen 2100. The user can insert additional timeframes 2112 onto the graph 2102 by selecting or tapping and holding down on the graph 2102; a new timeframe 2112 may be inserted at the selected time. Each timeframe 2112 is represented by a vertical bar or shaded area whose width approximates the time period of the timeframe 2112 and whose location on the graph indicates the start and end times of the timeframe. A numerical value of the time period 2114 is displayed with each timeframe. The start and times 2116 for each timeframe 2112 are also displayed. The start and end times 2116 for each timeframe 2112 can be changed by selecting and sliding arrow buttons 2354. Each timeframe 2112 also includes a delete button 2352 that, when selected or tapped, will remove the timeframe 2112 from the graph 2102. A timeframe 2112 may also include an identifier 2356 for associating the timeframe 2112 with an exposure meter 2118.

The multiple selections screen 2350 displays multiple exposure meters 2118. The primary exposure meter 2118a display a simplified version of the information displayed by the exposure meter 2118 of the main screen 2100, except that the primary exposure meter 2118a includes an identifier 2358a for associating the exposure meter 2118a with a timeframe 2112a on the graph 2102. In the illustrated example, the primary exposure meter 2118a are displaying the data for the timeframe 2112a identified 2356a with a single dot.

The secondary 2118b and tertiary 2118c exposure meters also display similar information as the primary exposure meter 2118a. The timeframe 2112 associated with an exposure meter 2118 and multi-function button 2128 may not be currently displayed by the graph 2102. In the illustrated example, the timeframe 2112 for the tertiary exposure meter 2118c and multi-function button 2128c is not displayed by the graph 2102; as illustrated, none of the timeframes 2112 have the same three-dot identifier 2358c as the tertiary multi-function button 2128c.

FIG. 4G illustrates a first help or tutorial screen 2370 for the multiple selections screen 2350. As illustrated and explained in the first help screen 2370, the user can insert 2382 a new timeframe by selecting and holding down on the graph 2102. The user can delete 2384 a timeframe by selecting a delete button that is associated with each timeframe. Also illustrated and explained is that selecting or tapping 2386 on the primary multi-function button 2128a will cause the timeframe associated with the button to be centered on the graph 2102.

FIG. 4H illustrates an embodiment of a daily total value screen 2390. The daily total value screen 2390 displays a daily value 2392a, 2392b, 2392c for multiple days in advance, such as for instance for each day in the near future for which data is available. Each daily value 2392a, 2392b, 2392c includes a date and a value. The value may be relative to the best 2120 and worst 2122 accumulated values displayed with the exposure meter 2118. Alternatively or additionally, the value may be an absolute value for each day, such as for instance an accumulated value for each day. The daily value 2392a, 2392b, 2392c may also indicate a relative difference to the data displayed by the exposure meter 2118 with a different color or shading. The daily total value screen 2390 otherwise includes similar elements as the main screen 2100.

FIG. 4I illustrates an embodiment of a help or tutorial screen 2400 for the daily total value screen 2390. The help screen 2400 illustrates that tapping 2402 on a daily value 2392a, 2392b, 2392c will direct the user to settings for the selected daily value and/or settings for all the daily values 2392a, 2392b, 2392c. The help screen 2400 also includes information 2404 explaining what is displayed by the daily values 2392a, 2392b, 2392c.

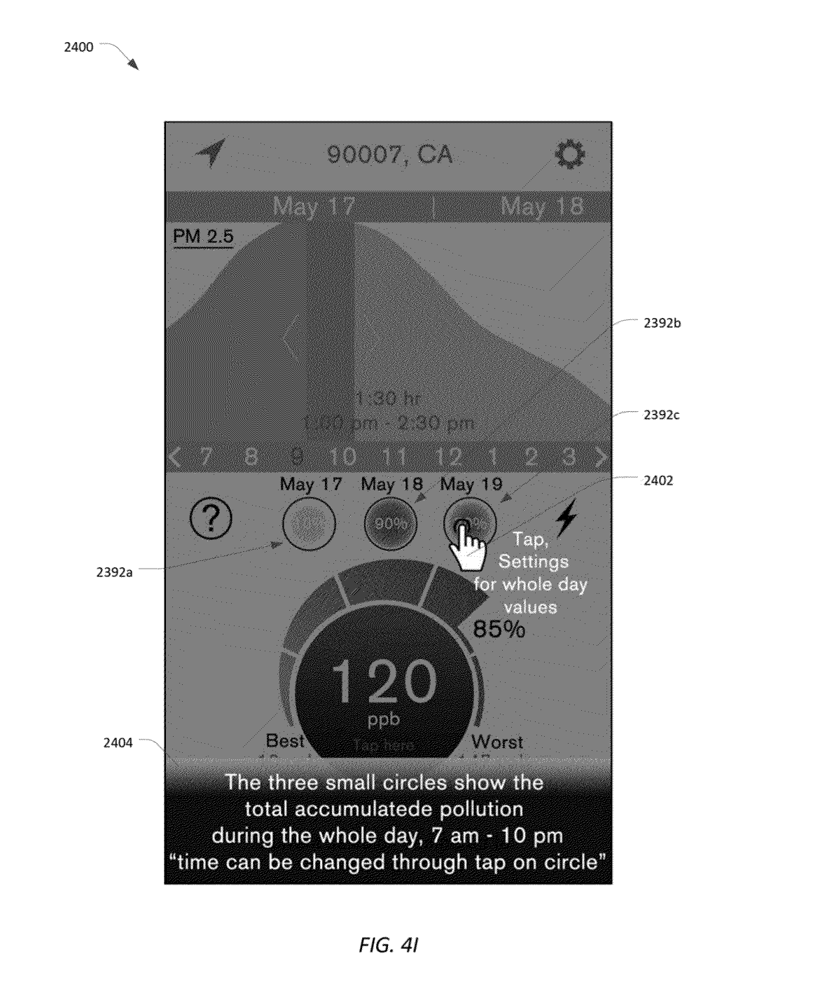

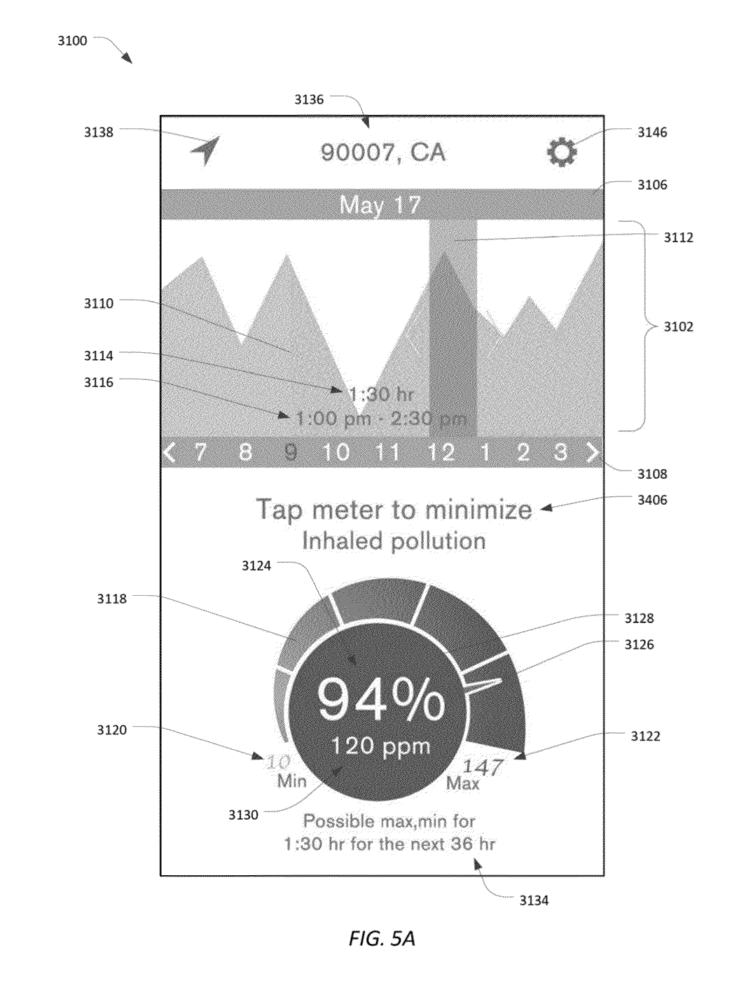

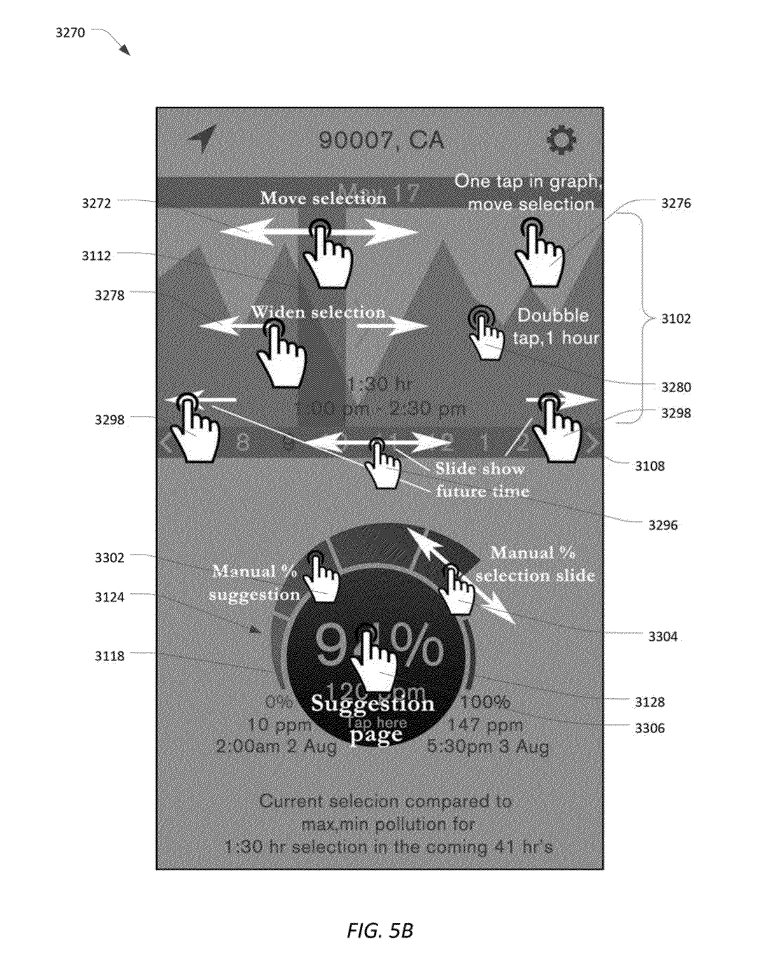

FIG. 5A illustrates another embodiment of the main screen 3100 of a software application for mobile devices that provides users with suggested times for engaging in an activity for a given duration and in a specified location based on outdoor conditions. The main screen 3100 of FIG. 5A is similar to the main screen 10100 of FIG. 1A except as described below. The main screen 3100 of FIG. 5A includes: a graph 3102, the date and/or range of dates 3106 displayed by the graph 3102, the hours 3108 displayed by the graph 3102, a current time 3110 indicator on the graph 3102, a selected time frame 3112 on the graph 3102, the duration 3114 of the selected timeframe 3112, and the start and end times 3114 of the timeframe 3112. The main screen 3100 also displays an exposure meter 3118, including the best 3120 or minimum accumulated level over the selected days, and the worst 3122 or maximum accumulated level over the selected days. The exposure meter 3118 also includes a multi-function button 3128, which displays the relative accumulated value 3124 and the absolute accumulated value 3130 for the selected timeframe. The main screen 3100 also displays text 3134 indicating what is presently being displayed on the main screen 3100. The main screen 3100 also provides instructive text 3406 to direct the user how to use the software application. The main screen 3100 also displays the a location 3136 for the data and includes an update-to-current-location button 3138, and a settings button 3146.

FIG. 5B illustrates a first help or tutorial screen 3270 for the main screen 3100. As illustrated and explained by the first help screen 3270, the start and end time of the selected timeframe 3112 can be changed by selecting the selected timeframe 3112 and sliding 3272 left or right. Alternatively or additionally, the start and end time of the selected timeframe 3112 can be changed by tapping or selecting 3276 an area of the graph 3102. The duration of the selected timeframe 3112 can be changed by selecting at or near the edge of the vertical bar representing the selected timeframe 3112 and sliding 3278 left or right. In some embodiments, double-clicking or double-tapping 3280 an area of the graph 3102 removes the selected timeframe 3112 and inserts a new timeframe of one hour at the selected time. In some embodiments, a second or subsequent timeframe can be inserted onto the graph 3102 by double-tapping or double-clicking 3280 on an area of the graph 3102; the new timeframe will have a default (possibly configurable) time period, such as one hour. The hours 3108 displayed by the graph 3102 can be changed by selecting the hours 3108 displayed and sliding 3296 left or right. The data displayed by the graph 3102, and possibly also the displayed date range 3106, will update accordingly. The exposure meter 3118 can be used to select 3302 a percentage 3124 such that the selected 3302 percentage 3124 is used by the software application to suggest a timeframe. Alternatively or additionally, a percentage 3124 can be selected by selecting the exposure meter 3118 and sliding 3304 along between the ends of the exposure meter 3118. The first help screen 3270 also illustrates that selecting or tapping 3306 the multi-function button 3128 directs the user to a suggestion screen.

FIG. 5C illustrates one embodiment of a suggestion screen 3200. The suggestion screen 3200 is similar to the suggestion screen 10200 illustrated in FIG. 2E. As illustrated in FIG. 5C, the suggestion screen 3200 comprises a pop-up window 3202. The pop-up window 3202 includes on or more date and time selectors 3204a, 3204b, 3204c. The date and time selectors 3204a, 3204b, 3204c each include a date 3206a, 3206b, 3206c and a time bar 3208a, 3208b, 3208c. Each date and time selector 3204a, 3204b, 3204c includes a selected period of the day 3212, and in some embodiments a date and time selector 3204b may allow the user to select more than one period 3212b0, 3212b1 in the same day. The date and time selectors 3204a, 3204b, 3204c also include one or more delete time buttons 3414. Selecting a delete time button 3414 removes time that has not been selected. For example, in the illustrated example, when the user selects or taps the middle delete time button 3414b1 in the second date and time selector 3204b, the unselected time will be deleted, such that the two selected time periods 3212b0, 3212b1 will be joined into a single time period The pop-up window 3202 also includes a duration button 3218 for selecting desired time duration, and an “OK” button 3220 for accepting the selections and dismissing the pop-up window 3202.

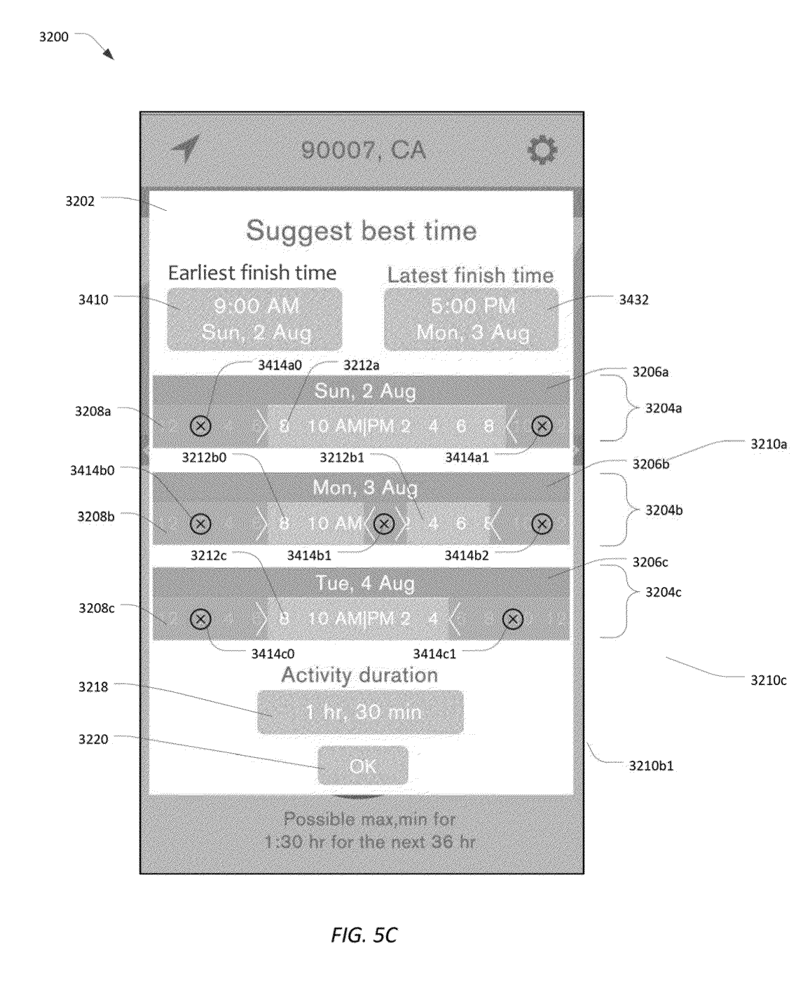

FIG. 6 illustrates another embodiment of a main screen 4100 of a software application for mobile devices. The main screen 4100 of FIG. 6 is similar to the main screen 3100 of FIG. 5A. The main screen 4100 of FIG. 6 includes: a graph 4102, the date and/or range of dates 4106 displayed by the graph 4102, the hours 4108 displayed by the graph 4102, a current time 4110 indicator on the graph 4102, a selected time frame 4112 on the graph 4102, the duration 4114 of the selected timeframe 4112, and the start and end times 4114 of the timeframe 4112. The main screen 4100 also displays an exposure meter 4118, including a best 4120 or minimum accumulated level over the selected days, and a worst 4122 or maximum accumulated level over the selected days. The exposure meter 4118 also includes a multi-function button 4128, which includes the relative accumulated value 4124 and the absolute accumulated value 4130 for the selected timeframe 4112. The main screen 4100 also displays text 4134 indicating what is presently being displayed on the main screen 4100. The main screen 4100 also provides instructive text 3406 to indicate what is being displayed. The main screen 4100 also displays a location 4136 for the data and includes an update-to-current-location button 4138, and a settings button 4146.

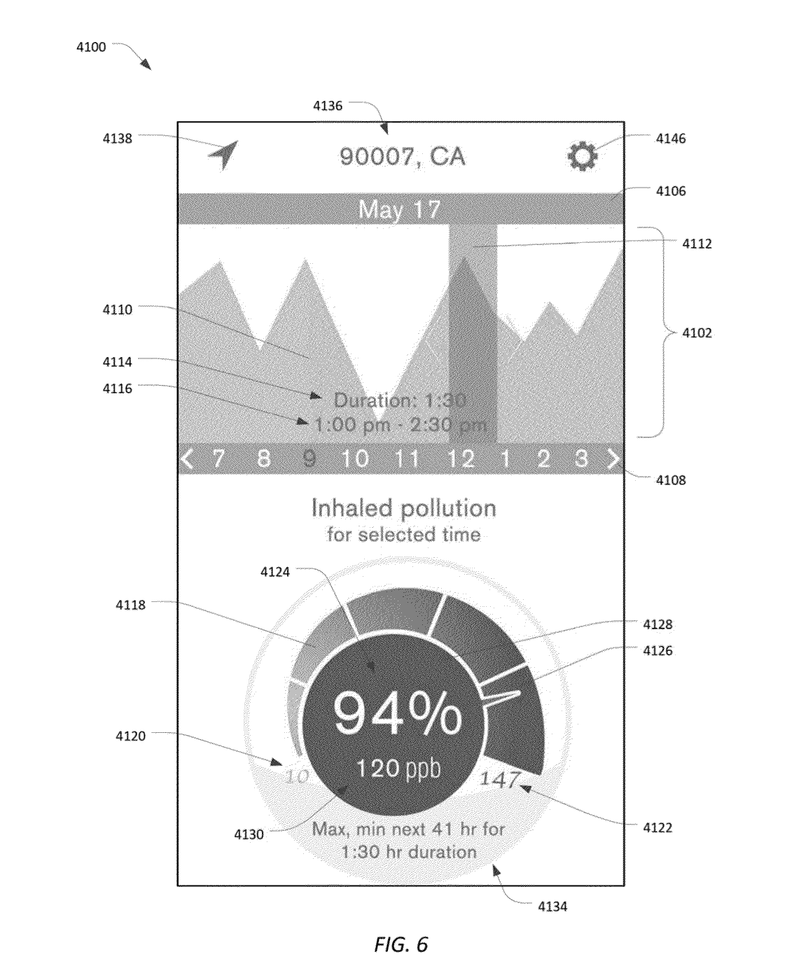

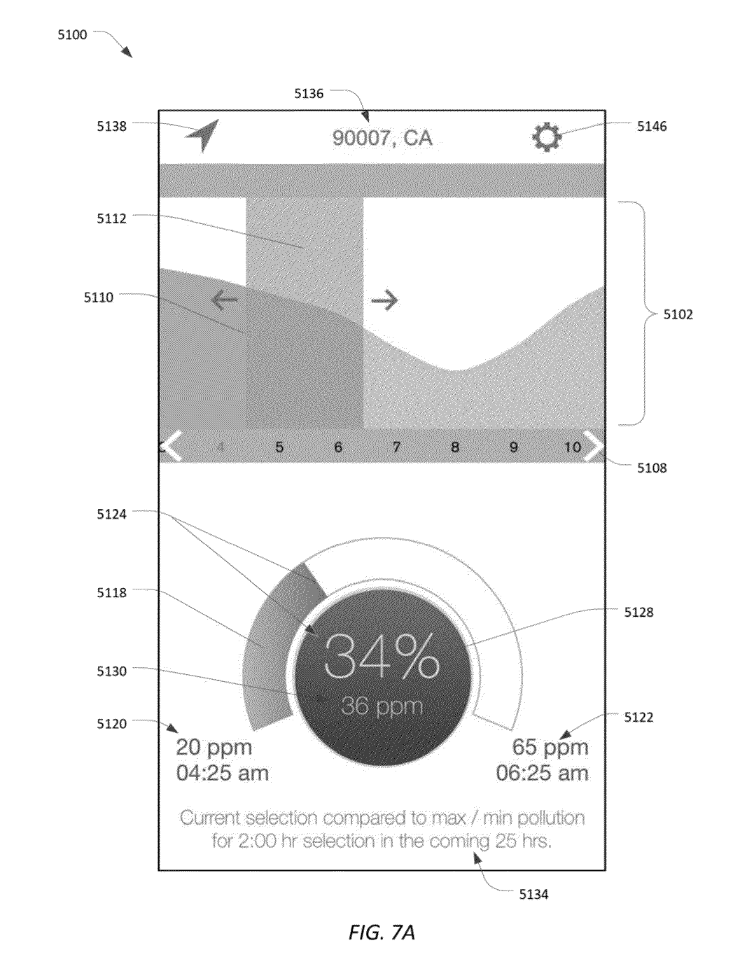

FIG. 7A illustrates an embodiment of a main screen 5100 of a software application for mobile devices. The main screen 5100 includes: a graph 5102 displaying data over time, the hours 5108 displayed by the graph, a current time 5110 indicator on the graph 5102, and a selected timeframe 5112 on the graph 5102. The main screen 5100 also includes an exposure meter 5118 that includes a best 5120 accumulated value and time and a worst 5122 accumulated value and time. The exposure meter 5118 also displays the relative accumulate value 5124 of the selected timeframe, as well as the absolute accumulated value 5130. The main screen 5100 also provides text 5134 indicating what is presently displayed by the main screen 5100. The main screen also displays a location 5136 for the data and includes an update-to-current location button 5138 a setting button 5146.

FIG. 7B illustrates one embodiment of a suggestion screen 5200. The suggestion screen 5200 comprises a pop-up window 5202 for entering time periods 5212 to include in suggesting a timeframe. The pop-up window includes one or more date and time selectors 5204a, 5204b, 5204c. The date and time selectors 5204a, 5204b, 5204c each include a date 5206a, 5206b, 5206c and display start and end times 5210 for the selected periods of the day 5212. Each date and time selector 5204a, 5204b, 5204c may include a selected period of the day 5212 to include in suggesting a timeframe. When a date and time selector 1204a includes the current time 1214, the current time 1214 is indicated on the time bar 1208a. The pop-up window 5202 also includes a duration button 5218 for selecting a desired time duration, and an “OK” button 5220 for accepting the selections and dismissing the pop-up window 5202.

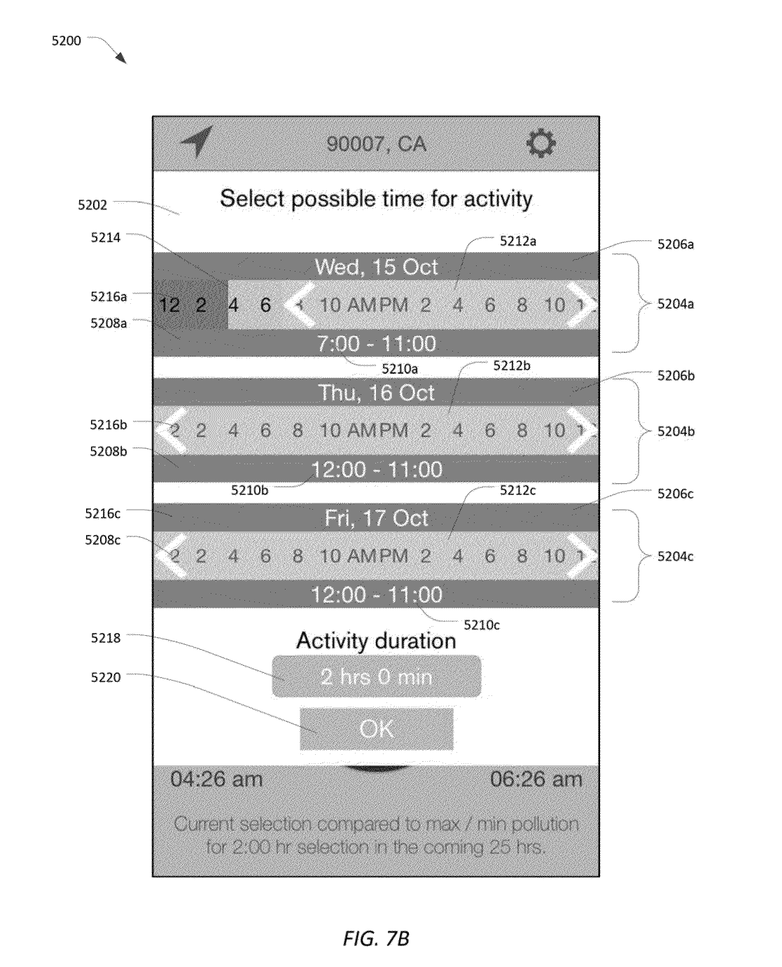

FIG. 8 illustrates an embodiment of a main screen 6100 of a software application for mobile devices. The main screen 6100 includes a graph 6102 for displaying the data, the date and/or range of dates 6108 displayed by the graph 6102, the hours 6108 displayed by the graph, a current time 6110 indicator on the graph 6102, a selected timeframe 6112 on the graph 6102, the duration 6114 of the selected timeframe 6112, and the start and end times 6114 of the timeframe 6112. The main screen 6100 also displays an exposure meter 6118, including the best 6120 or minimum accumulated level over some time period, such as the next forty-eight hours, and the worst 6122 or maximum accumulated level over some time period. The main screen 6100 also displays the accumulated value 6130 for the selected timeframe 6112. The main screen 6100 also displays text 6134 indicating what is presently being displayed on the main screen 6100. The main screen 6100 also provides instructive text 6406 to indicate what the accumulated value 6130 represents. The main screen 6100 also displays a location 6136 for the data and includes an update-to-current-location button 6138, and a settings button 6146.

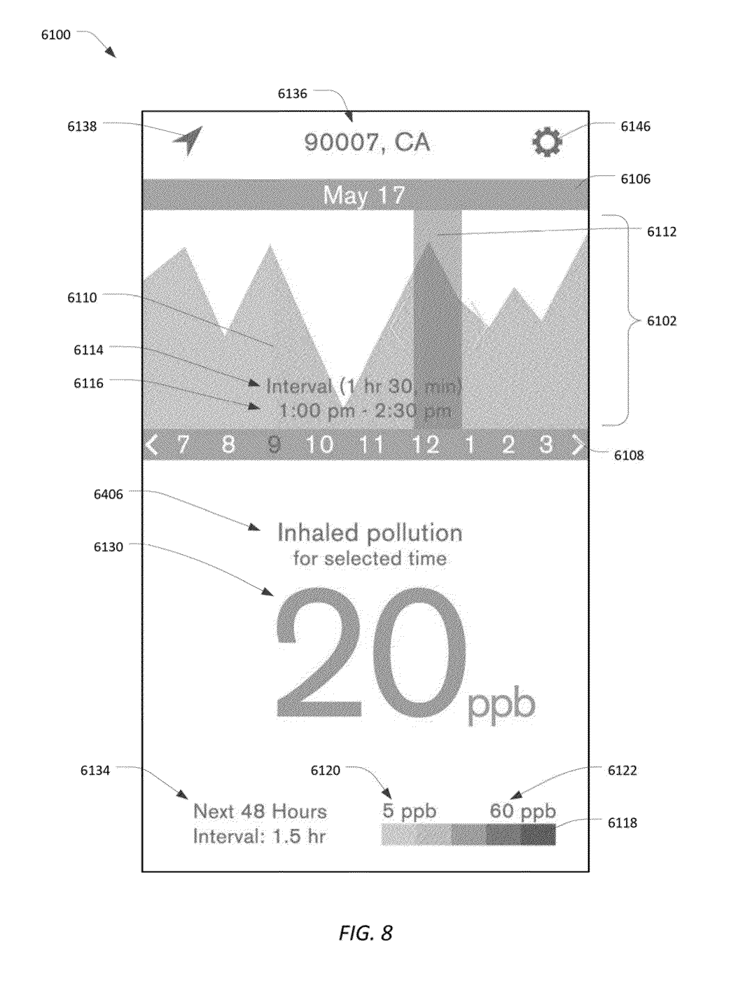

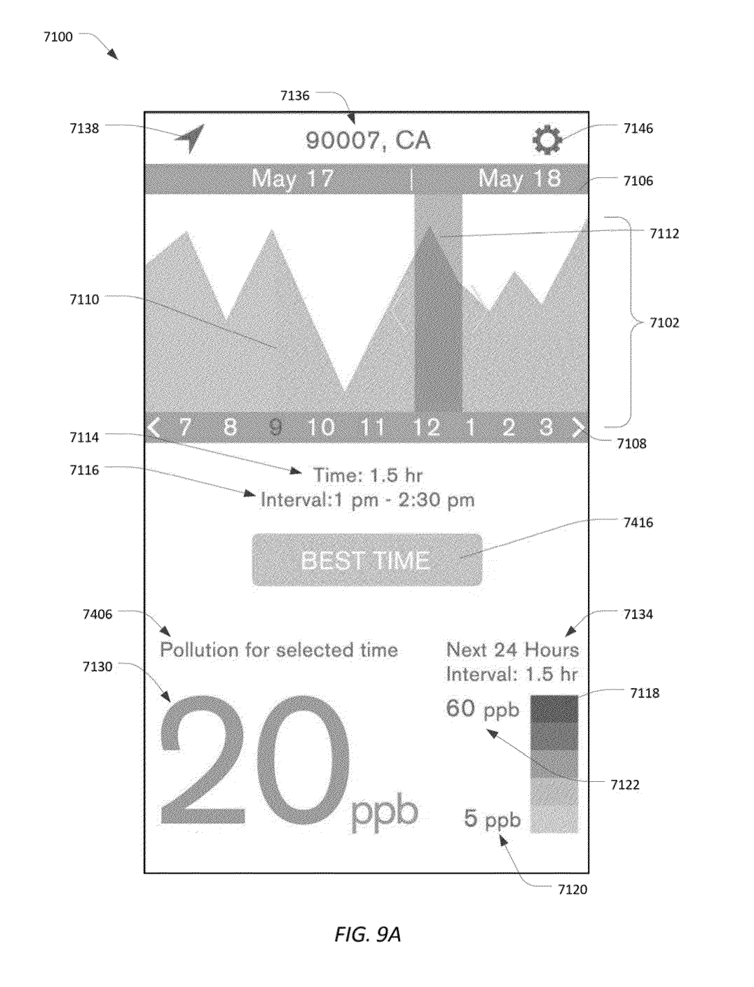

FIG. 9A illustrates another embodiment of a main screen 7100 of a software application for mobile devices. The main screen 7100 includes a graph 7102, the date and/or range of dates 7106 displayed by the graph 7102, the hours 7108 displayed by the graph 7102, a current time 7110 indicator on the graph 7102, a selected timeframe 7112 on the graph 7102, the duration 7114 of the selected timeframe 7112, and the start and end times 7114 of the timeframe 7112. The main screen 7100 also displays a suggestion button 7416 that, when selected or clicked, may suggest to the user the best time timeframe 7112 for an activity of the given duration 7114. The main screen 7100 also displays an exposure meter 7118, including the best 7120 or minimum accumulated level over some time period, such as the next twenty-four hours, and the worst 7122 or maximum accumulated level over the same time period. The main screen 7100 also displays the accumulated value 7130 for the selected timeframe 7112. The main screen 7100 also displays text 7134 indicating what is presently being displayed on the main screen 7100. The main screen 7100 also provides instructive text 7406 to indicate what the accumulated value 7130 represents. The main screen 7100 also displays a location 7136 for the data and includes an update-to-current-location button 7138, and a settings button 7146.

FIG. 9B illustrates one embodiment of a suggestion screen 7200. The suggestion screen 7200 includes a pop-up window 7202 for entering the time period within which the software application is to suggest a timeframe. The pop-up window 7202 includes an “Earliest start time” button 7210a that indicates the start time and date of the time period, and that, when selected, will direct the user to a date and/or time selection mechanism. The pop-up window 7202 also includes a “Latest stop time” button 7210b that indicates the end time and date of the time period that, when selected, will direct the user to a date and/or time selection mechanism. The pop-up window 7202 also includes a toggle switch 7216 that indicates whether the a specific period of time, typically the middle of the night, should be excluded. The pop-up window also includes an “OK” button that, when selected, will accept the user's entries and dismiss the pop-up window 7202.

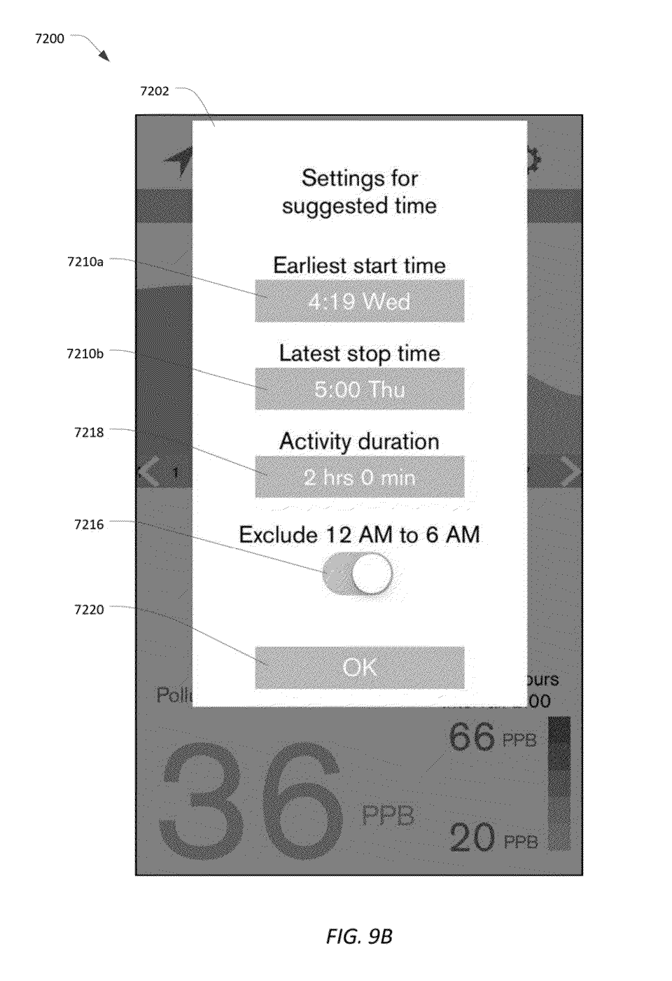

FIG. 10 illustrates another embodiment of a main screen 8100 for the software application for mobile devices. The main screen 8100 includes a graph 8102, the hours 8108 displayed by the graph 8102, a current time 8110 indicator on the graph 8102, a selected timeframe 8112 on the graph 8102, the duration 8114 of the selected timeframe 8112, and the start and end times and dates 8114 of the timeframe 8112. The main screen 8100 also displays a suggestion button 8416 that, when selected or clicked, may suggest to the user the best timeframe 8112 for an activity of the given duration 8114. The main screen 8100 also displays the best 8120 or minimum accumulated level over some time period, such as the next twenty-four hours, and the worst 8122 or maximum accumulated level over the same time period. The main screen 8100 also displays the accumulated value 8130 for the selected timeframe 8112. The main screen 8100 also provides instructive text 8406 to indicate what the accumulated value 8130 represents. The main screen 8100 also displays a location 8136 for the data and includes an update-to-current-location button 8138.

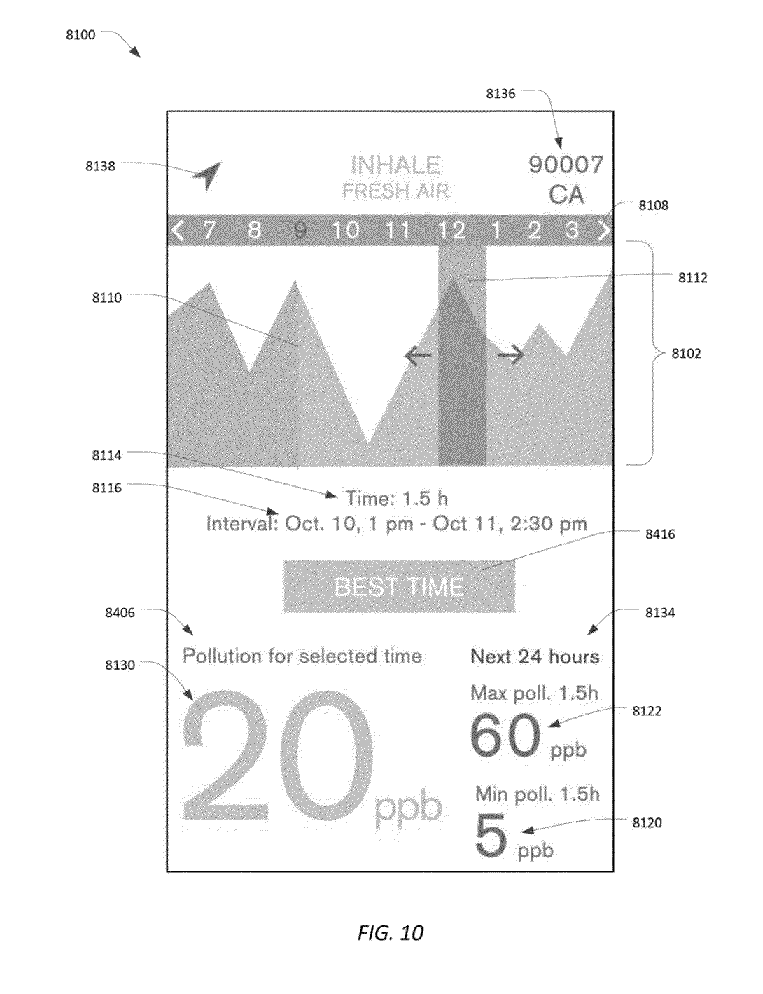

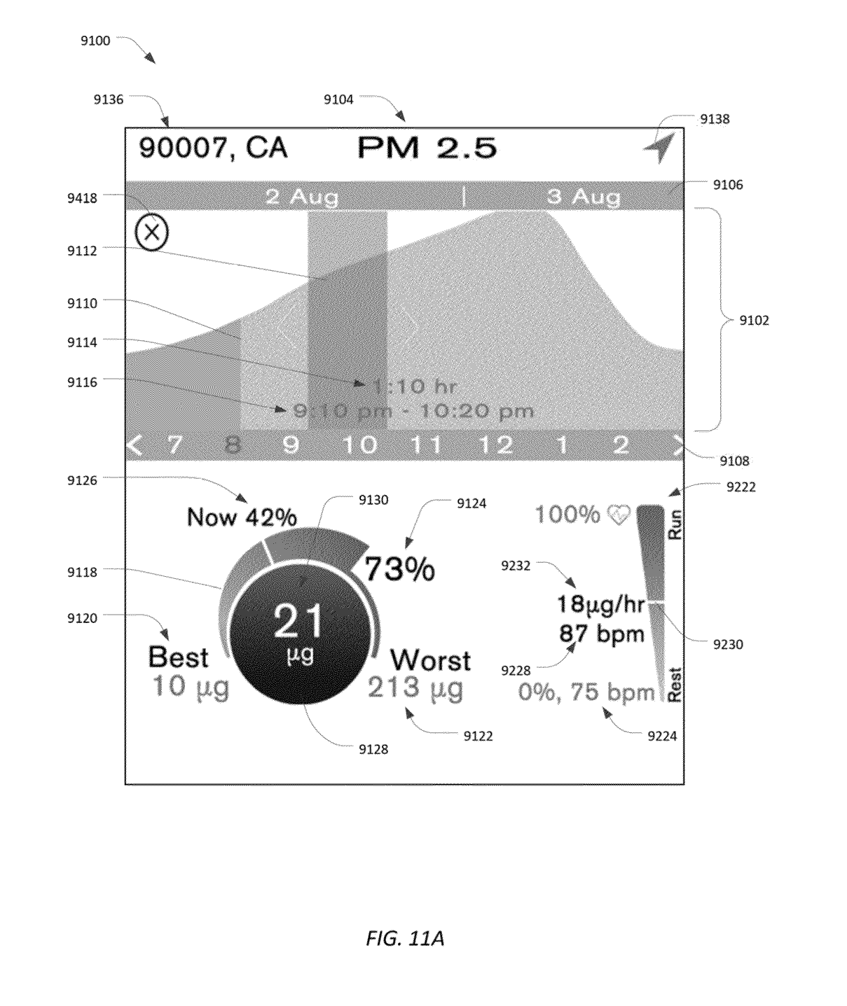

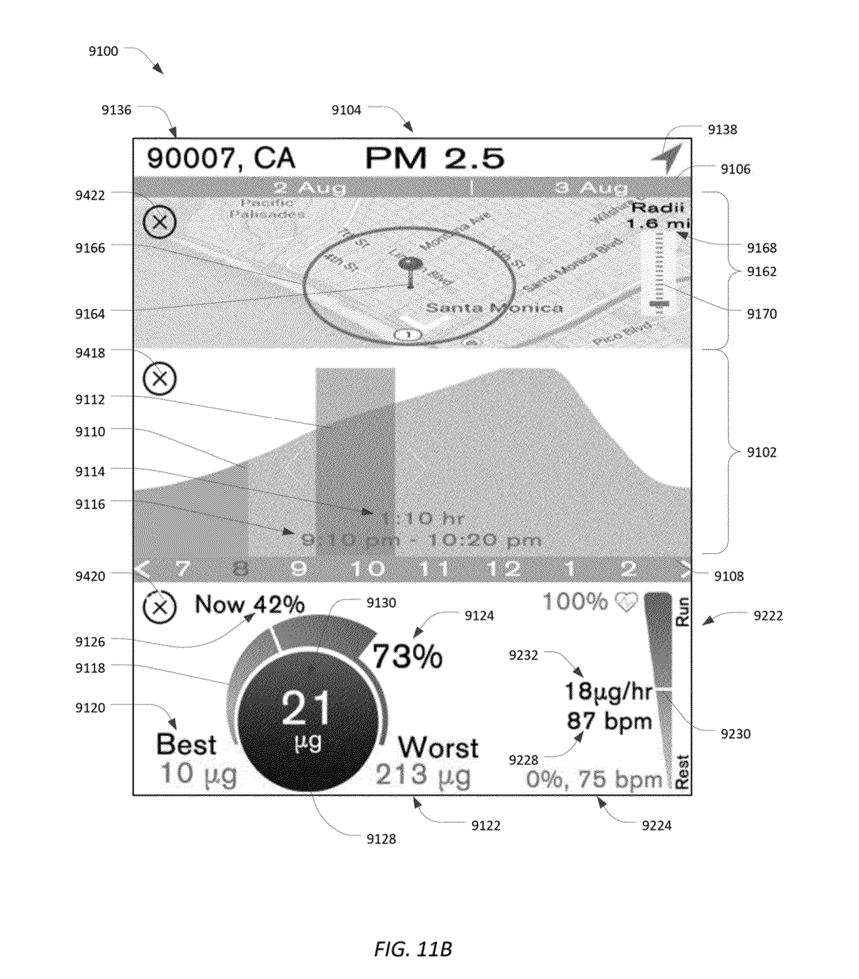

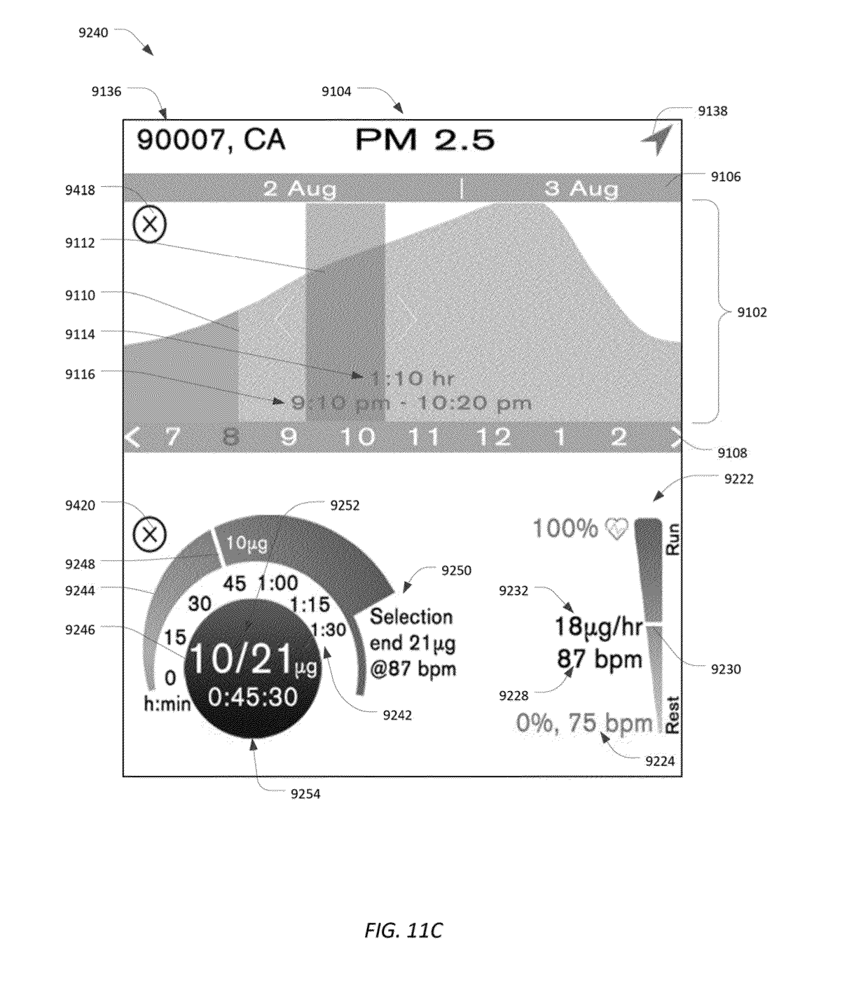

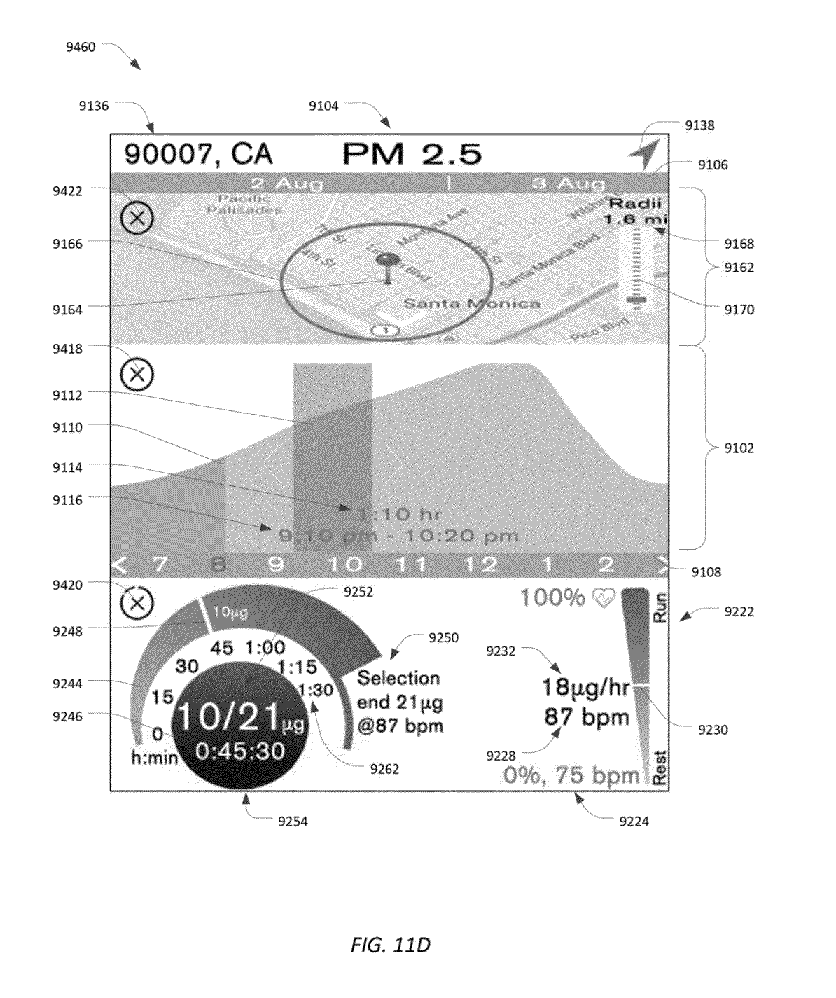

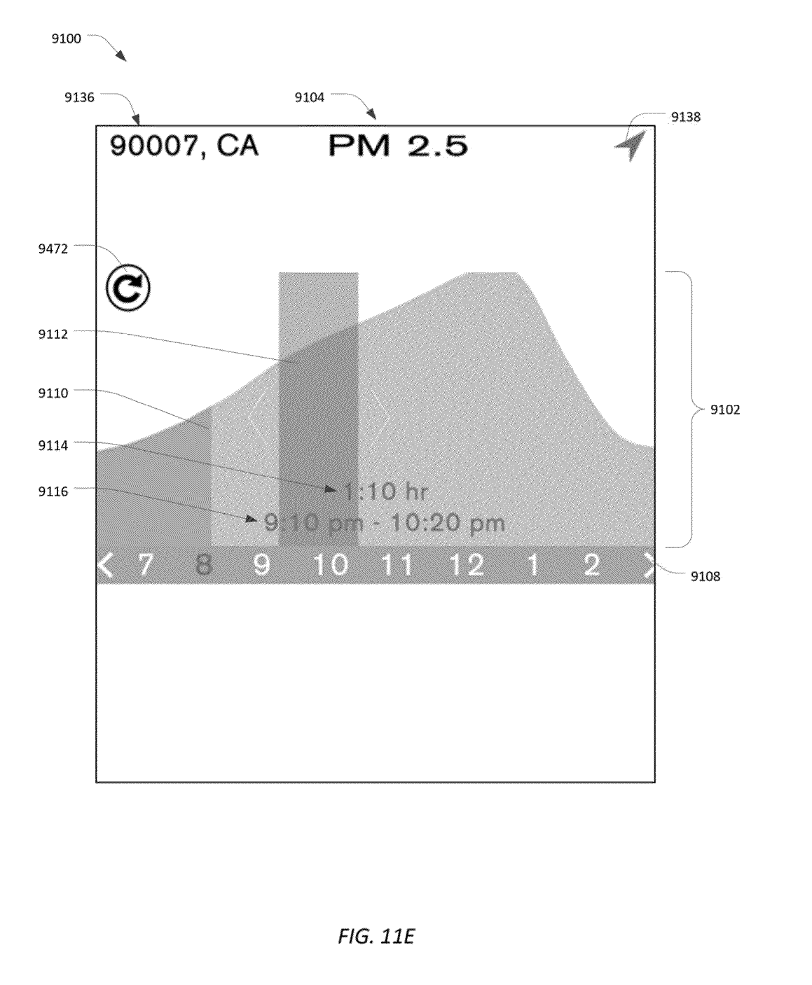

FIG. 11A illustrates one embodiment of a main screen 9100 of a software application for mobile devices that may have a lower resolution and/or smaller display area such as may be found, for example, on a wrist-worn mobile device. The main screen 9100 is similar to the main screen 10100 of FIG. 1A. As illustrated by FIG. 11A, the main screen 9100 includes a graph 9102, the graph's 9102 data type 9104, the date and/or range of dates 9106 displayed by the graph 9102, the hours 9108 displayed by the graph 9102, a current time 9110 indicator on the graph 9102, a selected time frame 9112 on the graph 9102, the duration 9114 of the selected timeframe 9112, and the start and end times 9114 of the timeframe 9112. The main screen 9100 also includes a graph delete button 9418 that, when selected, will remove the graph 9102, and the elements that accompany the graph 9102, from the screen. The main screen 9100 also displays an exposure meter 9118, including the best 9120 accumulated level over the selected days, the worst 9122 accumulated level over the selected days, and the relative accumulated value 9124 for the selected timeframe 9112. The exposure meter 9118 also includes a multi-function button 9128, which includes the accumulated value 9130 for the selected timeframe 9112. The main screen 9100 also displays a location 9136 for the data and includes an update-to-current-location button 9138.

In some embodiments, the main screen 9100 may also include a heart rate monitor display 9222. The heart rate monitor display 9222 includes the user's resting heart rate 9224 (assumed to be 0% heart rate); the user's maximum active heart rate is assumed to be 100% heart rate. The heart rate monitor display 9222 also displays the user's current heart rate 9228, as well as the user's relative heart rate 9232 between the user's resting heart rate 9224 and maximum active heart rate. The heart rate monitor display 9222 may also display the user's exposure over time 9232 to the element or quantity represented on the graph 9102.

FIG. 11B illustrates one embodiment of a main screen 9100 for mobile device that may have a lower resolution and/or smaller display area, with multiple displays. The main screen 9100 with multiple displays includes similar elements illustrated in FIG. 11A, though the elements may be compressed to allow for additional elements to be displayed. In the example illustrated by FIG. 11B, the main screen 9100 also includes a small map 9162. The small map 9162 may include a pin 9164 indicating a location. The small map 9162 may also include a circle 9166 of a certain radius around the pin 9142 indicating an area a certain distance around the user's location 9142. The small map 9162 may display a numerical value 9168 of the radius of the circle 9166. The small map 9162 may also provide a slider bar 9170 to modify and set the radius of the circle 9166. The small map 9162 may also include a map delete button 9422 that, when selected, will cause the map 9162 to be removed from the display. The graph 9102 includes a graph delete button 9418 that, when selected, will remove the graph 9102 from the main screen 9100. The exposure meter also includes a meter delete button 9420 that, when selected, will remove the exposure meter 9118 and heart rate monitor display 9222 from the screen. Removing elements from the screen may cause the remaining displays to resize to occupy more of the screen.

In some embodiments, the various data can be rearranged on the screen. For example, the map 9162 can be selected and slid towards the graph 9102, which will cause the graph 9102 and the map 9162 to exchange places. In another example, the user can select anywhere on the main screen 9100 and slide up, causing the displayed areas to scroll up, with the topmost display becoming the bottom most.

FIG. 11C illustrates one embodiment of an active timeframe screen 9240 for a mobile device that may have a lower resolution and/or smaller display area. The active timeframe screen 9240 replaces the exposure meter 9118 of the main screen 9100 with an active exposure meter 9244, which includes a lapsed time meter 9242 and an accumulated value indicator 9246. The lapsed time meter 9242 displays time intervals in minutes and/or hours, starting at zero and ending at the time duration 9114 selected by the user. Alternatively, the lapsed time meter 9242 may display time intervals in absolute time. The active exposure meter 9244 indicates the user's accumulated exposure 9248 to the element or quantity represented on the graph 9102, as a function of time. The accumulated exposure 9248 indicator may update continuously or periodically as time progresses. The exposure meter 9244 also displays an expected, estimated accumulated exposure value 9250 at a given heart rate. The accumulated value indicator 9246 also displays the user's current and expected exposure values 9252, as well as the lapsed time 9254 in hours, minutes, and/or seconds, either counting down or counting up.

FIG. 11D illustrates one embodiment of the active timeframe screen 9240 for a mobile device that may have a lower resolution and/or a smaller display area, with multiple displays. The active timeframe screen 9240 with multiple displays includes similar elements as illustrated in FIG. 11C, though the elements may be compressed to allow for additional elements to be displayed. As illustrated in FIG. 11D, the multiple display screen 9460 also includes a small map 9162 and may function in a similar fashion as the main screen 9100 of FIG. 11B.

FIG. 11E illustrates one embodiment of a main screen 9100 for a mobile device that may have a lower resolution and/or a smaller display area, with a single display. A single display may be displayed, for example, when the meter delete button 9420 and the map delete 9422 have been selected. In this example, selecting the meter delete button 9429 removes, for example, the active exposure meter 9244 and all other elements in the same area, and selecting the map delete button 9422 removes the small map 162 and associated elements resulting in a display containing only the graph 9102. In some embodiments, selecting anywhere on the screen and sliding up will cause other elements, such as the exposure meter 9118 or map 9162, to be displayed in turn. The main screen 9100 also includes return button 9472 that, when selected, will reset the display to a default, such as for instance the main screen 9100 of FIG. 11A.

FIG. 11F illustrates one embodiment of a suggestion screen 9200 for a mobile device that may have a lower resolution and/or a smaller display area. The suggestion screen 9200 includes one or more date and time selectors 9204a, 9204b. The date and time selectors 9204a, 9204b each include a date 9206a, 9206b, a time bar 9208a, 9208b, and display start and end times 9210a, 9210b of the selected periods of the day 9212. Each date and time selector 9204a, 9204b may include a selected timeframe 9212. A selected timeframe 9212 can be changed by selecting an end of the area that represents the selected timeframe 9212 and sliding the end up or down. A selected timeframe 9212 can be removed be selecting the X or delete button 9478 associated with the selected timeframe 9212. Each date and time selector 9204a, 9204b also includes and on/off button 9216a, 9216b that, when off, removes the associated date and time selector 9204a, 9204b from consideration in generating the suggestion. The suggestion screen 9200 also includes a previous day button 9474, which, when selected, changes the date and time selectors 9204a, 9204b to include an earlier day. The suggestion screen 9200 also includes a next day button 9476 that, when selected, changes the date and time selectors 9204a, 9204b to include a later day. The suggestion screen 9200 also includes a duration button that allows the user to set the desired duration for his or her activity, and an OK button 9220 that, when selected, causes the user's selections to be accepted, and dismisses the suggestion screen 9200.

While the various screens described above may have been described as associated with, or related to each other, it is understood that any of the above-described screens may be used in any combination, and that one implementation of the software application may use any version of any screen, and any variation thereof.

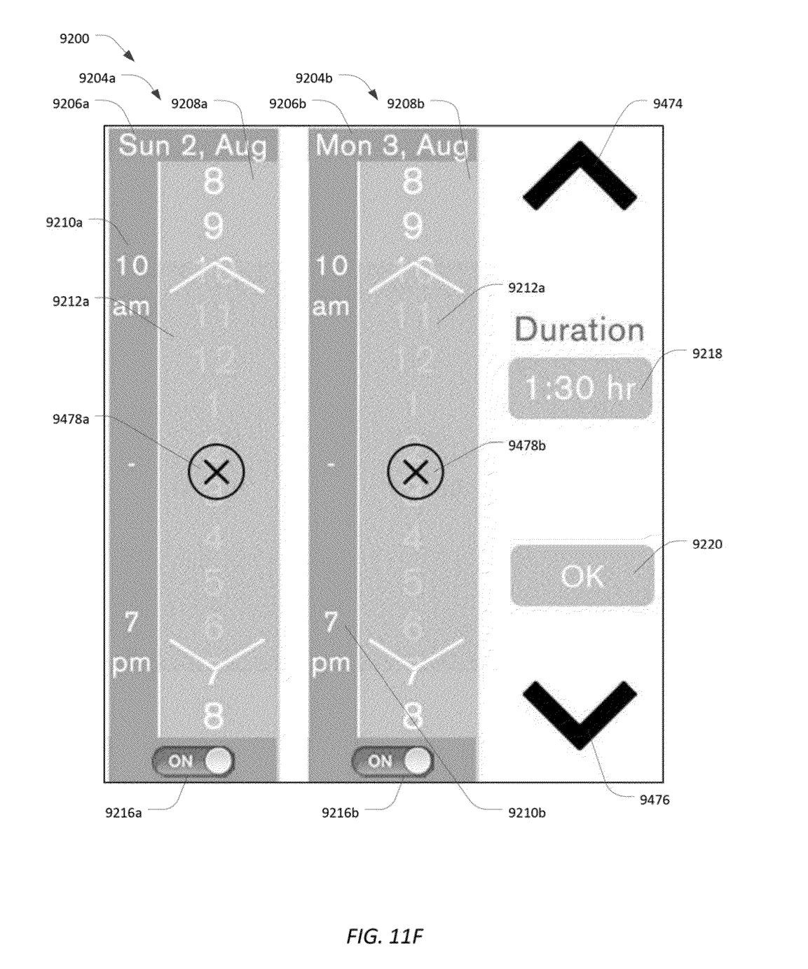

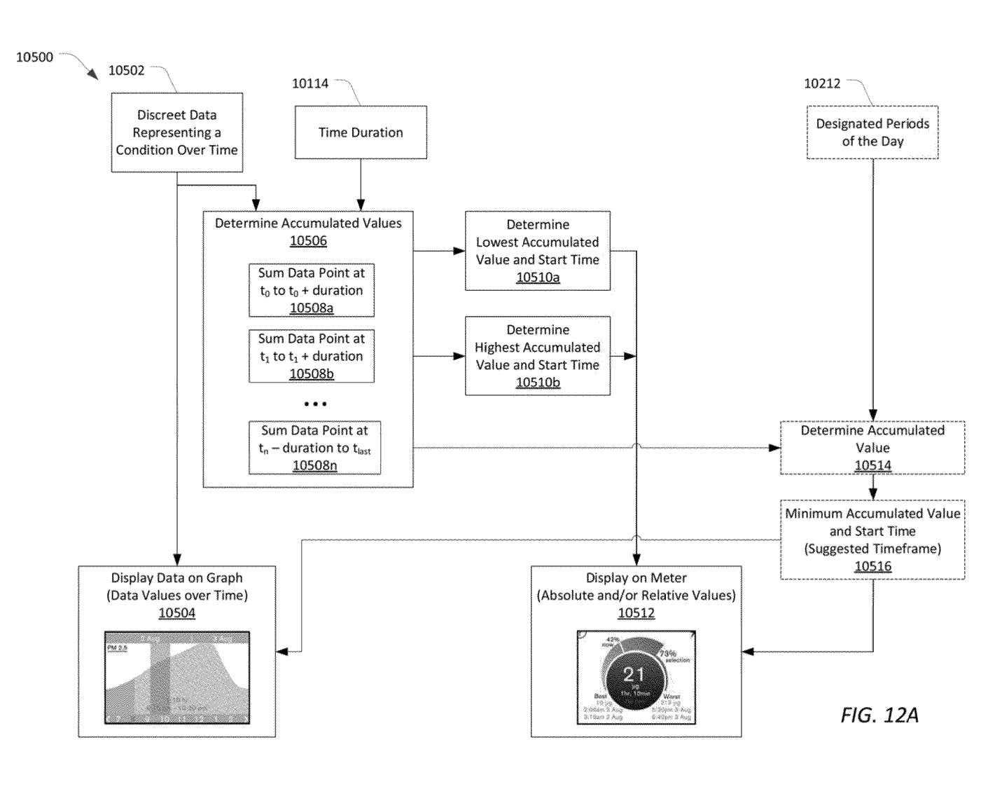

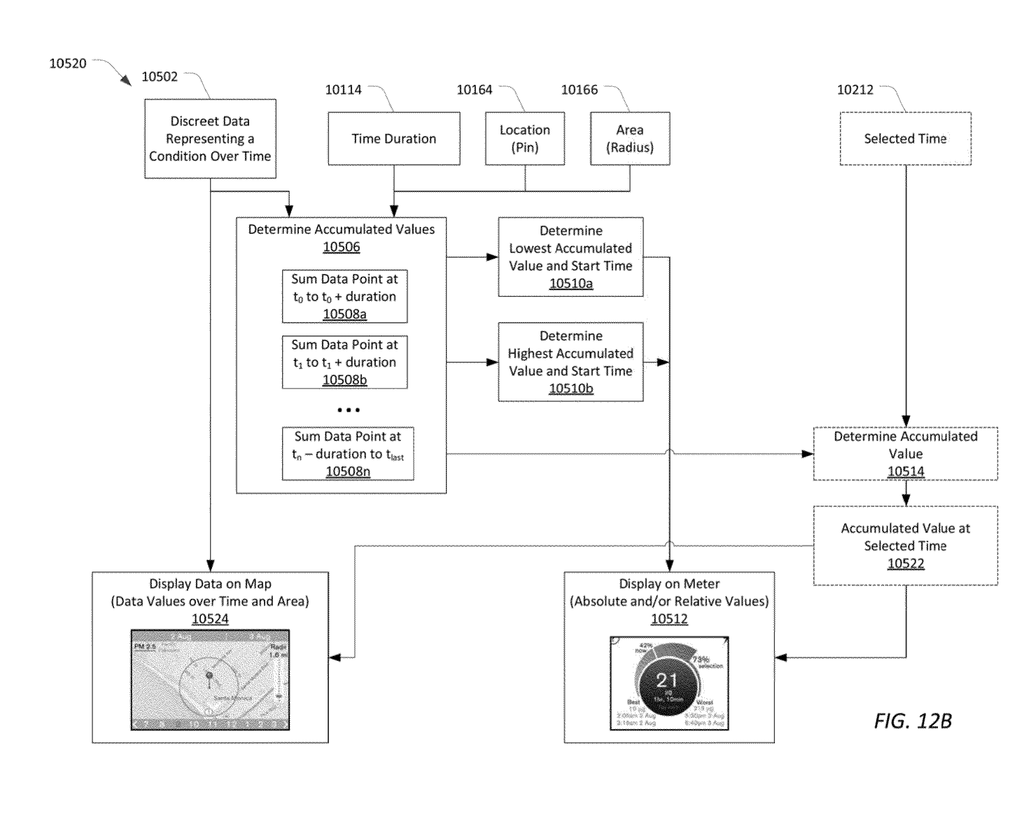

FIG. 12A illustrates one embodiment of a process 10500 that may be implemented by any of the main screens described herein, such as for instance the main screen 10100 of FIG. 1A. As illustrated in FIG. 12A, the process 10500 describes how discreet data representing a condition over time 10502 and a time duration 10114 may be displayed on a graph 10102 and/or exposure meter 10118, and how the discreet data 10502 may be used to generate accumulated values for display on the exposure meter 10118.

The discreet data representing condition over time 10502 may comprise, for example, ozone levels, fine particle levels, dust levels, fire levels, smoke levels, nitrogen dioxide levels, sulfur dioxide levels, carbon monoxide levels, particle pollution levels, pollen levels, sun exposure levels, precipitation levels, or temperatures, or any combination thereof. The discreet data over time 10502 is displayed 10504 by the graph 10102 of the main screen 10100. The time duration 10114 may be entered, for example, on a suggestion screen and/or on the graph 10102 of the main screen 10100.

The process 10500 determines 10506, for each data point in the discreet data over time 10502, the accumulated value of the data for the duration of time starting at the time of the data point. That is, for the first data point at time t₀, the determination process 10506 sums 10508a the data values from time t₀ to time t₀ plus the duration; the determination process 10506 then sums 10508b the data values from time t₁ to time t₁ plus the duration, and so on, until time tₙ—the duration, at which point the determination process 10506 sums 10508n the value at time tₙ—duration to time tₗₐₛₜ, that is, the last value.

Having determined 10506 the accumulated values, or concurrent with determining 10506 the accumulated values, the process 10500 determines 10510a the lowest accumulated value 10120 and the time at which this occurs. The process 10500 also determines 10510b the highest accumulated value 10122 and the time at which this occurs. Both the lowest 10120 and highest 10122 accumulated values and their times may then be displayed 10512 on the exposure meter 10118.

Optionally or additionally, the process 10500 may use a designated periods of the day 10212 to determine a suggested timeframe 10112. The periods of the day 10212 are one or more periods of time across one or more days. Such periods of time may be entered, for example, on the suggestion screen. The process 10500 determines 10514 when within the periods of the day 10212 the minimum accumulated value occurs, based on the calculated 10506 accumulated values 10508a-10508n. The minimum accumulated value and its start time 10516 may be displayed 10504 on the graph 10102 as the suggested timeframe 10112. The minimum accumulated value may also display the minimum accumulated value 10516 on the exposure meter 10118, as an absolute value and/or as a value relative to the lowest 10120 and highest 10122 accumulated values.

FIG. 12B illustrates one embodiment of a process 10520 that may be implemented by any of the map screens described above, such as for instance the small map screen 10160 of FIG. 1E. As illustrated in FIG. 12B, the process 10520 illustrates how discreet data representing a condition over time 10502, a time duration 10114, a location 10164, and an area 10166 around that location (determined by a radius 10168 of a certain distance from the location 10164) may be displayed on a map 10162 and/or an exposure meter 10118, and how they may be used to generate accumulated values for display on the exposure meter 10118.

In some embodiments, the discreet data over time 10502 is given as a function of location. In such embodiments, the data 10502 can be represented graphically on a map 10162. The map 10162 may be operable to display the data as a function of time, such that as time is wound forwards or backwards, the representation of the data 10502 on the map 10162 changes as the data values change with time. For example, areas with higher data values may be indicated with dark shading, while areas with lower data values may be indicated with light shading; as the displayed time changes, the shading can change accordingly. As another example, the direction in which the data values are changing may be indicated with arrows or gradients in the shading; as the displayed time changes, the gradients or arrow may move to show trends in the data values over time.

The location 10164 for determining an accumulated value may be specified on the small map 10162. The software application may determine the location 10164 using a GPS receiver or some method of determining location. Alternatively or additionally, the user may specify a location 10164 by selecting or tapping on the map 10162. The area 10166 is specified by a radius 10168 a certain distance from the location 10164. The radius 10166 may be set by the user. The duration of time 10114 may be a default or preset value, or may be entered as described above with respect to FIG. 11F. The discreet data over time 10502 is as described with respect to FIG. 11F.

Returning to FIG. 12B, the process 10520 determines 10506, for each data point in the discreet data over time 10502, the accumulated value of the data for the duration of time, as described above with respect to FIG. 11F, except that for the process 10520 of FIG. 11F, the summations 10508a-10508n are determined only for the given location 10164 and area 10166. Having determined 10506 the accumulated values, or concurrent with determining 10506 the accumulated values, the process 10500 determines 10510a, 10510b the lowest 10120 and highest 10122 accumulated values and the times at which they occur. Both the lowest 10120 and highest 122 accumulated values and their times may be displayed 10512 on the exposure meter 10118.

Optionally or additionally, the process 10500 may take a selected time 10108 and determine 10522 the accumulated value for that time. The selected time 10108 may be determined, for example, on the small map 10162 by time with which the location pin 10164 corresponds; that is, the cross section of the pin 10164 and the hours 10108 below the small map 10162 indicate the midpoint of the time period. The process 10502 determines 10514 the accumulated value for the selected time 10212 from calculated 10506 accumulated values 508a-508n for the designated location 10164 and area 10166. The accumulated value 10522 for the timeframe may be displayed 10524 on the map 10102. The accumulated value 10522 may also be displayed 10512 on the exposure meter 10118, as an absolute value and/or as a value relative to the lowest 10120 and the highest 10122 accumulated values.

While the process 10520 of FIG. 43 is described using the small map screen 10160 of FIG. 1E as an example, it is understood that the process 10520 may be implemented by any of the map screens described above.

FIG. 12C illustrates one embodiment of a process 10530 that may be implemented by any of the active timeframe screens described above, such as for instance the active timeframe screen 10240 of FIG. 1L. As illustrated in FIG. 12C, the process 10530 illustrates how a selected timeframe 10112 may be displayed on an active exposure meter 10244 when the timeframe 10112 becomes the current time. The process 10530 determines 10532 the expected accumulated value 10250 for the selected timeframe 10112 from the discreet data over time 10502 and given the start time and duration of the selected timeframe 10112. The expected accumulated value 10250 may be displayed 10540 on the active exposure meter 10244.

The process 10530 may also determine 10534 the current accumulated value 10248. The current accumulated value 10248 may be represented by the sum of the data points of the discreet data over time 10502 starting at the start time of the selected timeframe 10112 to the present time. In some embodiments, the current accumulated value 10248 may be adjusted for the intensity of the user's activity. The current accumulated value may be displayed 10540 on the active exposure meter 10244. If the time duration has not yet ended 10536, the current accumulated value may be updated 10538 and the updated value may be displayed 10540 on the active exposure meter 10244. Once the time duration has ended 10536, this may be indicated on the active exposure meter 10244.

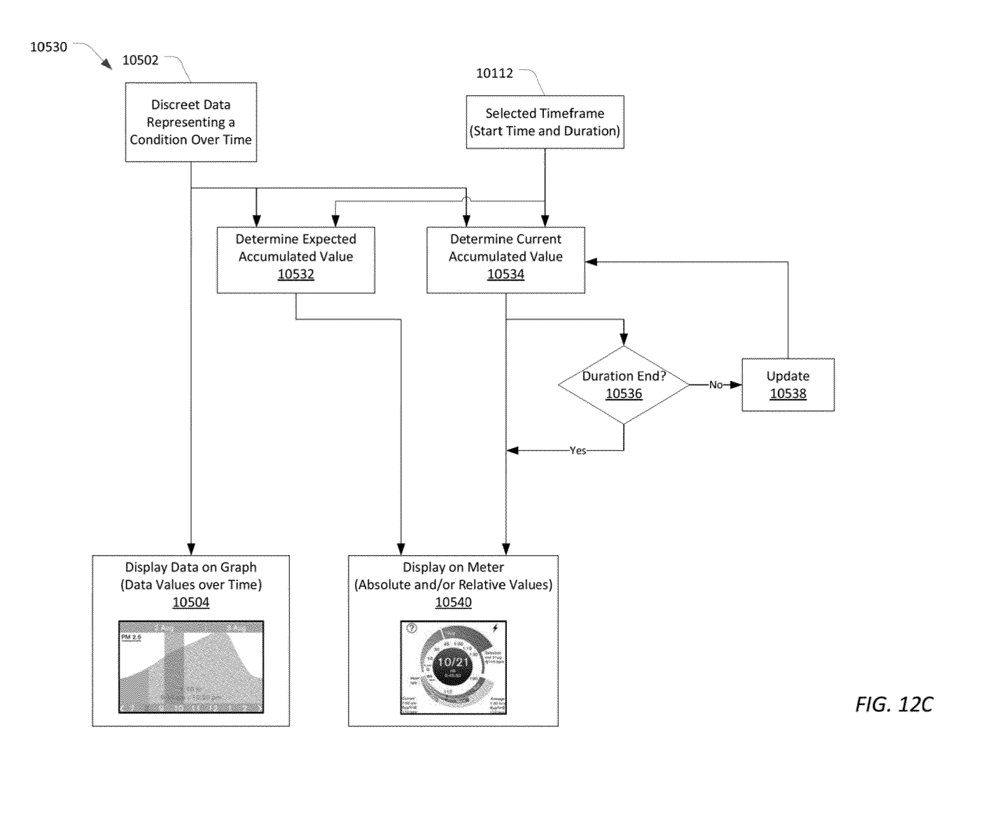

In some areas or at some times for some areas air quality data, may not be available. In such cases, the software application may us an image of the sky to extrapolate values for the data, and uses these extrapolated values for the various determinations described above. Alternatively or additionally, an image of the sky can be used to improve the accuracy of determinations made using given data. FIG. 13 illustrates one embodiment of a process 11600 for using an image of the sky 11616 to extrapolate the air quality of a location. The process 11600 determines the position of the mobile device 11602, using Internet data, a GPS receiver, or any other mechanism for determining a current location. The process 11600 also determines the current time 11604 using an Internet connection and/or a date and time maintained by the mobile device. The mobile device's position 11602 and current time 11604 can be used to determine the current position of the sun 11606, regardless of whether the sun is currently visible.

The process 11600 also determines the current compass direction 11608 of the mobile device, that is, determines which way is north, using a gyroscope or compass or GPS receiver in the mobile device. The process 11600 also determines the current vertical elevation of the mobile device 11610 using an altimeter or GPS receiver or similar device. The compass direction 11608 and vertical elevation 11610 can be used to determine the current orientation 11612 of the mobile device.

The position of the sun 11606 at the designated location and the current orientation 11612 of the mobile device can be input into a Perez Sky Diffuse Model 11614. The Perez Sky Diffuse Model 11614 estimates short time step irradiance, that is, the incident flux of radiant energy per unit area, on tilted planes based on global and direct (or diffuse) irradiance. The Model 11614 is commonly used to extract cloud indices and describe local clear sky climatology. The output of the Model 11614 is entered into a least square estimation 11622 process, described in further detail below.

The process 11600 includes an image of the sky 11616 at the designated location. The image of the sky 11616 may undergo radiometric correction 11618 to improve the accuracy of surface spectral reflectance, emittance, or back-scatter. The result of radiometric correction 11618 undergoes a sky segmentation 11620 process to eliminate, as best as possible, objects and obstructions obscuring the sky. The result of the sky segmentation process 11620 is entered into a least squares estimation process 11622. The least squares estimation process 11622 estimates parameters by minimizing the squared discrepancies between observed data on the one hand and their expected values on the other. The result of the least squares estimation process 11622 is turbidity 11624, that is, an estimation of the cloudiness or haziness of the sky. The turbidity 11624 value can be used to estimate the air quality of the designated locale and substitute for, or enhance, given air quality data.

### Indoor Conditions

In some embodiments, the software application includes indoor pollution and/or pollen data. In such embodiments, the indoor pollution and/or pollen levels can be displayed on the graph described above. The user may be able to specify, for example, how many windows are open in the designated space, or otherwise provide information about the airflow to the outdoors. The graph and/or meter may indicate at what time(s) the outdoor air quality is such that windows can be opened to circulate fresh air. In some embodiments, the mobile device system includes indoor condition sensors, operable to measure, for example, the quality of the air, and able to exchange data with the mobile device. In some embodiments, the mobile device system may also be able to automatically open or close windows; for example, the user may be able to set a threshold level of outdoor air quality at which the windows should be closed.

### Runkeeper

In some embodiments, the software applications includes features to provide route suggestions to users who are engaged in outdoor exercise, as well as tracking statistics related to the user's activities. The suggested route may be based on the air quality data described above (pollution, pollen, etc.). The route thus may direct the user along paths with the best overall air quality. In some embodiments, the route may also incorporate traffic data, and thus direct the user along routes with, for example, the least amount of traffic. The route can start at the user's current location or at a location designated by the user.

In some embodiments, the software application may also use image data to determine the suggested route. For example, the software may use street-level views and/or satellite images to select a route through green, that is, vegetated areas. In such embodiments, the degree of greenness may be displayed on the map as a percentage.

The software application may also track statistics related to the user's activities. For example, the software application may track the user's route so far (using, for example, a GPS receiver in the mobile device), the duration of the user's activity, the user's current and average speed, how many calories the user has burned, and the user's heart rate (using, for example, a heart rate monitor in the mobile device or mobile device system).

### Images

In some embodiments, the software application may incorporate street or satellite views of an area. The street views may be obtained, for example, from a web camera. Street and/or satellite views provide the user with an image of the current conditions at a location.

### Bicycle Tool

Bicyclist seeking to avoid flat tires may wish to know the current ozone level when filling air in a tire. Flat tires can be avoided by maintaining a low ozone level inside the tire. In some embodiments, the software application provides a suggested time for filling tires with air, based on ozone levels. The software application may also provide the user with a suggested tire pressure, based on the size of the tire, the weight of the bicycle and the rider, and/or the tire's usage conditions.

### Advertising

In some embodiments, the software application displays health and safety advice and directed advertising. The software application may display, for instance, daily suggestions for how the user can improve his or her health and/or lifestyle. The health and safety advice may include suggested products and/or articles or papers on pollution, pollen, and/or crime.

The directed advertising suggests products and services to the user when such products and services are suitable to the user. For example, if the user is jogging on a hot day and is near a convenience store, the software application may suggest that the user stop at the convenience store to buy water. The advertisement can be supplied and paid for by the convenience store and/or the producer of the water.

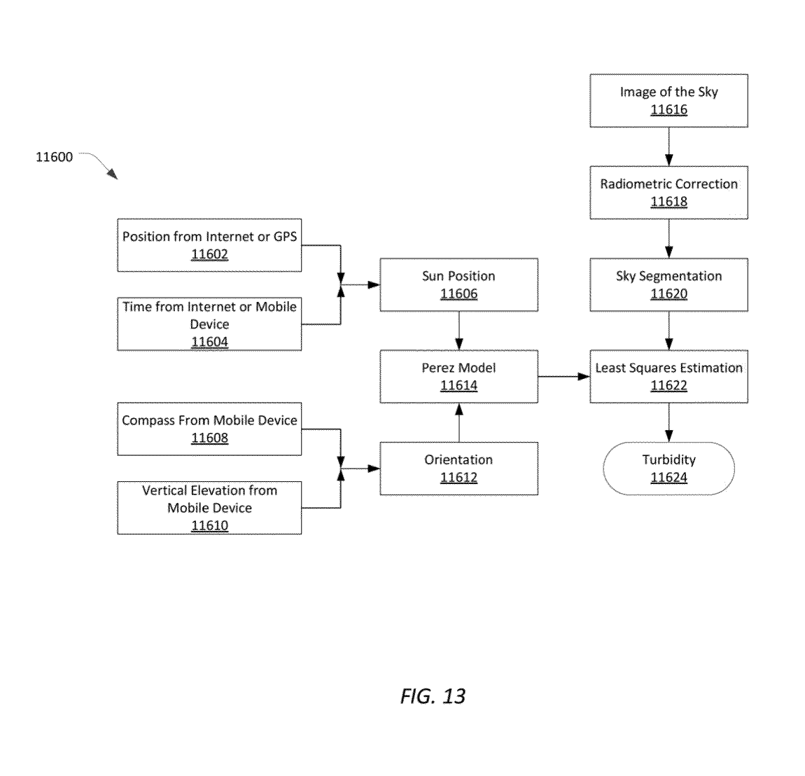

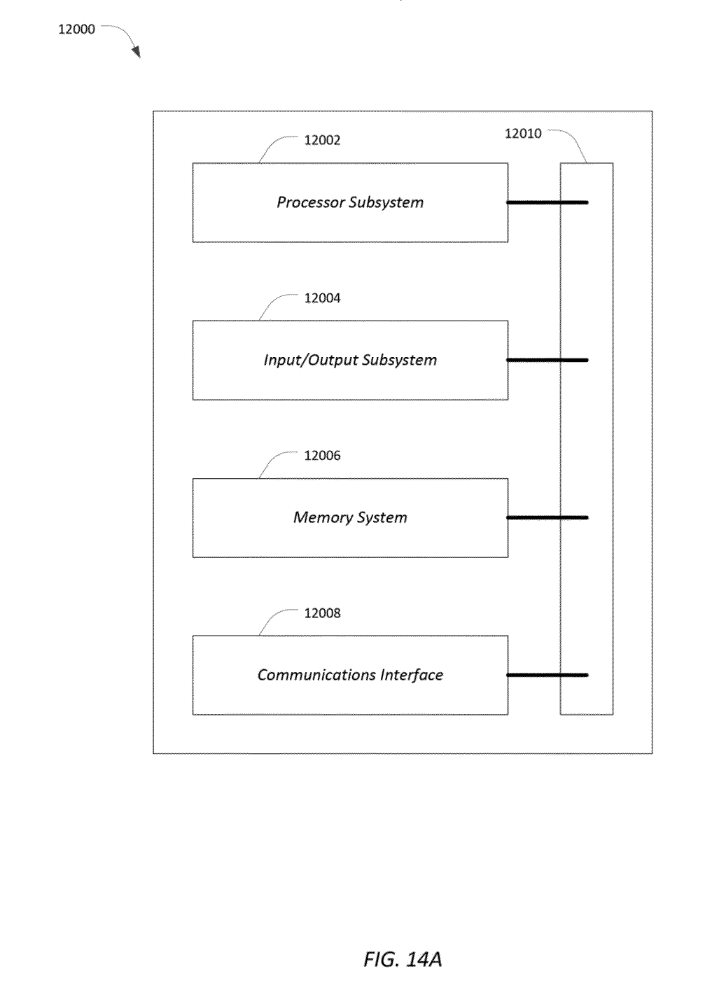

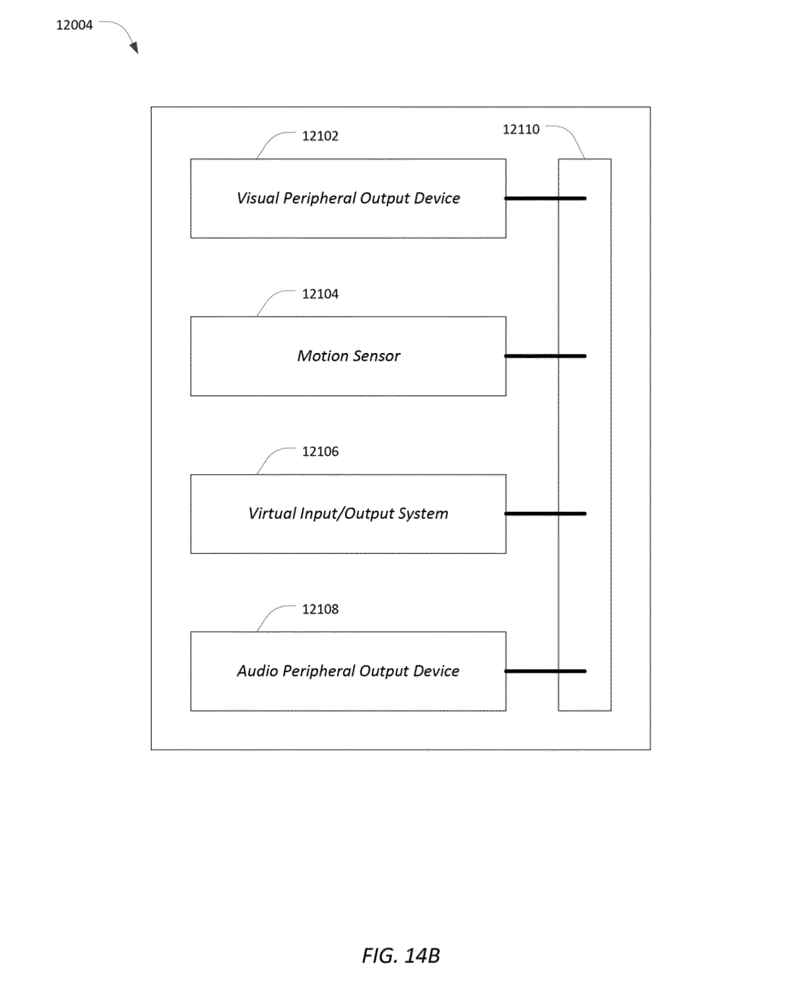

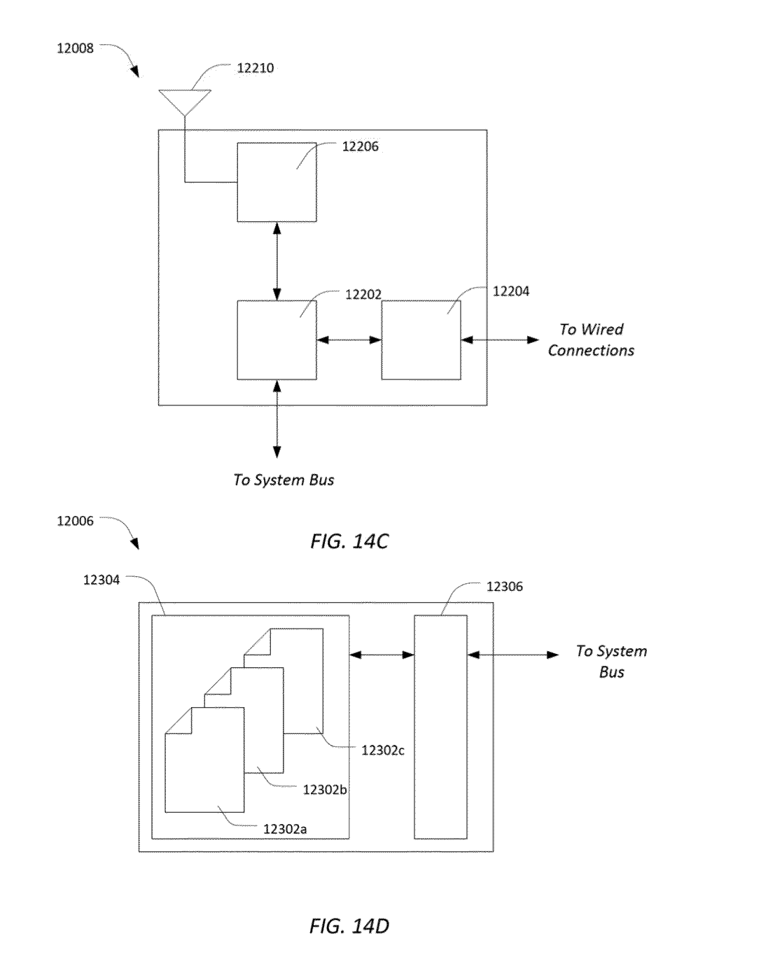

FIG. 14A is a schematic view of an illustrative electronic device 12000 capable of implementing the systems and methods described herein. Electronic device 12000 may comprise a processor subsystem 12002, an input/output subsystem 12004, a memory subsystem 12006, a communications interface 12008, and a system bus 12010. In some embodiments, one or more than one of the electronic device 12000 components may be combined or omitted such as, for example, not including the communications interface 12008. In some embodiments, the electronic device 12000 may comprise other components not combined or comprised in those shown in FIG. 14A. For example, the electronic device 12000 also may comprise a power subsystem. In other embodiments, the electronic device 12000 may comprise several instances of the components shown in FIG. 14A. For example, the electronic device 12000 may comprise multiple memory subsystems 12006. For the sake of conciseness and clarity, and not limitation, one of each of the components is shown in FIG. 14A.

The processor subsystem 12002 may comprise any processing circuitry operative to control the operations and performance of the electronic device 12000. In various aspects, the processor subsystem 12002 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 12002 also may be implemented by a controller, a microcontroller, an application specific integrated circuit (ASIC), a field programmable gate array (FPGA), a programmable logic device (PLD), and so forth.

In various aspects, the processor subsystem 12002 may be arranged to run an operating system (OS) and various mobile applications. Examples of an OS comprise, for example, operating systems generally known under the trade name of Apple OS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, the electronic device 12000 may comprise a system bus 12010 that couples various system components including the processing subsystem 12002, the input/output subsystem 12004, and the memory subsystem 12006. The system bus 12010 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

FIG. 14B shows one embodiment of the input/output subsystem 12004 of the electronic device 12000 shown in FIG. 14A. The input/output subsystem 12004 may comprise any suitable mechanism or component to at least enable a user to provide input to the electronic device 12000 and the electronic device 12000 to provide output to the user. For example, the input/output subsystem 12004 may comprise any suitable input mechanism, including but not limited to, a button, keypad, keyboard, click wheel, touch screen, or motion sensor. In some embodiments, the input/output subsystem 12004 may comprise a capacitive sensing mechanism, or a multi-touch capacitive sensing mechanism. Descriptions of capacitive sensing mechanisms can be found in U.S. Patent Application Publication No. 2006/0026521, entitled “Gestures for Touch Sensitive Input Device” and U.S. Patent Publication No. 2006/0026535, entitled “Mode-Based Graphical User Interfaces for Touch Sensitive Input Device,” both of which are incorporated by reference herein in their entirety. It will be appreciated that any of the input mechanisms described herein may be implemented as physical mechanical components, virtual elements, and/or combinations thereof.

In some embodiments, the input/output subsystem 12004 may comprise specialized output circuitry associated with output devices such as, for example, an audio peripheral output device 12108. The audio peripheral output device 12108 may comprise an audio output including on or more speakers integrated into the electronic device. The speakers may be, for example, mono or stereo speakers. The audio peripheral output device 12108 also may comprise an audio component remotely coupled to audio peripheral output device 12108 such as, for example, a headset, headphones, and/or ear buds which may be coupled to the audio peripheral output device 12108 through the communications subsystem 12008.

In some embodiments, the input/output subsystem 12004 may comprise a visual peripheral output device 12102 for providing a display visible to the user. For example, the visual peripheral output device 12102 may comprise a screen such as, for example, a Liquid Crystal Display (LCD) screen, incorporated into the electronic device 12000. As another example, the visual peripheral output device 12102 may comprise a movable display or projecting system for providing a display of content on a surface remote from the electronic device 12000. In some embodiments, the visual peripheral output device 12102 can comprise a coder/decoder, also known as a Codec, to convert digital media data into analog signals. For example, the visual peripheral output device 12102 may comprise video Codecs, audio Codecs, or any other suitable type of Codec.

The visual peripheral output device 12102 also may comprise display drivers, circuitry for driving display drivers, or both. The visual peripheral output device 12102 may be operative to display content under the direction of the processor subsystem 12002. For example, the visual peripheral output device 12102 may be able to play media playback information, application screens for application implemented on the electronic device 12000, information regarding ongoing communications operations, information regarding incoming communications requests, or device operation screens, to name only a few.

In some embodiments, the input/output subsystem 12004 may comprise a motion sensor 12104. The motion sensor 204 may comprise any suitable motion sensor operative to detect movements of electronic device 12000. For example, the motion sensor 12104 may be operative to detect acceleration or deceleration of the electronic device 12000 as manipulated by a user. In some embodiments, the motion sensor 12104 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 12104 may comprise one or more two-axis acceleration motion sensors which may be operative to detect linear acceleration only along each of x or left/right and y or up/down directions (or any other pair of directions). In some embodiments, the motion sensor 12104 may comprise an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some embodiments, the motion sensor 12104 may be operative to directly detect rotation, rotational movement, angular displacement, tilt, position, orientation, motion along a non-linear (e.g., arcuate) path, or any other non-linear motions. For example, when the motion sensor 12104 is a linear motion sensor, additional processing may be used to indirectly detect some or all of the non-linear motions. For example, by comparing the linear output of the motion sensor 12104 with a gravity vector (i.e., a static acceleration), the motion sensor 12104 may be operative to calculate the tilt of the electronic device 12000 with respect to the y-axis. In some embodiments, the motion sensor 12104 may instead or in addition comprise one or more gyro-motion sensors or gyroscopes for detecting rotational movement. For example, the motion sensor 12104 may comprise a rotating or vibrating element.

In some embodiments, the motion sensor 12104 may comprise one or more controllers (not shown) coupled to the accelerometers or gyroscopes. The controllers may be used to calculate a moving vector of the electronic device 12000. The moving vector maybe determined according to one or more predetermined formulas based on the movement data (e.g., x, y, and z axis moving information) provided by the accelerometers or gyroscopes.

In some embodiments, the input/output subsystem 12004 may comprise a virtual input/output system 12106. The virtual input/output system 12106 is capable of providing input/output options by combining one or more input/output components to create a virtual input type. For example, the virtual input/output system 12106 may enable a user to input information through an on-screen keyboard which utilizes the touch screen and mimics the operation of a physical keyboard or using the motion sensor 12104 to control a pointer on the screen instead of utilizing the touch screen. As another example, the virtual input/output system 12106 may enable alternative methods of input and output to enable use of the device by persons having various disabilities. For example, the virtual input/output system 12106 may convert on-screen text to spoken words to enable reading-impaired persons to operate the device.

FIG. 14C shows one embodiment of the communication interface 12008. The communications interface 12008 may comprises any suitable hardware, software, or combination of hardware and software that is capable of coupling the electronic device 12000 to one or more networks and/or devices. The communications interface 12008 may be arranged to operate with any suitable technique for controlling information signals using a desired set of communications protocols, services or operating procedures. The communications interface 12008 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 12008 may comprise one or more interfaces such as, for example, a wireless communications interface 12206, a wired communications interface 12204, a network interface, a transmit interface, a receive interface, a media interface, a system interface, a component interface, a switching interface, a chip interface, a controller, and so forth. When implemented by a wireless device or within wireless system, for example, the communications interface 12008 may comprise a wireless interface 12206 comprising one or more antennas 12210, transmitters, receivers, transceivers, amplifiers, filters, control logic, and so forth.

In various aspects, the communications interface 12008 may provide voice and/or data communications functionality in accordance with different types of cellular radiotelephone systems. In various implementations, the described aspects may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described aspects may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

FIG. 14D shows one embodiment of the memory subsystem 12006. The memory subsystem 12006 may comprise any machine-readable or computer-readable media capable of storing data, including both volatile/non-volatile memory and removable/non-removable memory. The memory subsystem 12006 may comprise at least one non-volatile memory unit 12304. The non-volatile memory unit 12304 is capable of storing one or more software programs 12302a-12302c. The software programs 12302a-12302c may contain, for example, applications, user data, device data, and/or configuration data, or combinations therefore, to name only a few. The software programs 12302a-12302c may contain instructions executable by the various components of the electronic device 12000.

In various aspects, the memory subsystem 12006 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 12006 may contain a software program for interactive phonic learning using the capabilities of the mobile computing device 100 and the motion sensor 12104, as discussed in connection with FIGS. 14A-14B. In one embodiment, the memory subsystem 12006 may contain an instruction set, in the form of a file 12304n for executing a method of phonic learning on the mobile computing device. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 12002.

Examples of handheld mobile devices suitable for implementing the system and method of phonic learning using a mobile computing device comprise, but are not limited to: the Apple iPhone™ and iPod™; RIM Blackberry® Curve™, Pearl™, Storm™, and Bold™; Hewlett Packard Veer; Palm® (now HP) Pixi™, Pre™; Google Nexus S™, Motorola DEFY™, Droid (generations 1-3), Droid X, Droid X2, Flipside™, Atrix™, and Citrus™; HTC Incredible™, Inspire™, Surround™, EVO™, G2™, HD7, Sensation™, Thunderbolt™, and Trophy™; LG Fathom™, Optimus T™, Phoenix™, Quantum™, Revolution™, Rumor Touch™, and Vortex™; Nokia Astound™; Samsung Captivate™, Continuum™, Dart™, Droid Charge™, Exhibit™, Epic™, Fascinate™, Focus™, Galaxy S™, Gravity™, Infuse™, Replenish™, Seek™, and Vibrant™; Pantech Crossover; T-Mobile® G2™, Comet™, myTouch™; Sidekick®; Sanyo Zio™; Sony Ericsson Xperia™ Play.

Examples of tablet computing devices suitable for implementing the system and method of phonic learning using a mobile computing device comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

In embodiments as discussed, the computer devices, systems, and apparatus described herein each contain a memory that will configure associated processors to implement the methods, steps, and functions disclosed herein. Such methods, steps, and functions can be carried out, e.g., by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the terms “memory”, “memory storage”, “memory device”, or similar terms should be construed broadly enough to encompass any information able to be read from or written to an address in the addressable space accessed by an associated processor.

The computer devices, systems and apparatus described herein may take a variety of forms including a circuit, such as for example a combinational logic circuit or a sequential logic circuit (either synchronous or asynchronous), a finite state machine, a computer, tablet, processor, microprocessor, ASIC, etc. In one embodiment, at least one of the computer devices, systems and apparatus may be include a processor and/or appropriate hardware to carry out the functions described. The processor may be configured to execute operating logic in a storage medium, the operating logic regarding the methods described herein in whole or in part. The processor may also be any one of a number of single or multi-core processors known in the art. The storage may comprise volatile and non-volatile storage media configured to store persistent and temporal (working) copy of the operating logic.

In various embodiments, operating logic may be implemented in instructions supported by the instruction set architecture (ISA) of the processor, or in higher level languages and compiled into the supported ISA. The operating logic may comprise one or more logic units or modules. The operating logic may be implemented in an object oriented manner. The operating logic may be configured to be executed in a multi-tasking and/or multi-thread manner. In other embodiments, the operating logic may be implemented in hardware such as a gate array. For various embodiments, the processor may be packaged together with the operating logic. In various embodiments, the processor may be packaged together with the operating logic to form a System in Package (SiP). In various embodiments, the processor may be integrated on the same die with the operating logic. In various embodiments, the processor may be packaged together with the operating logic 166 to form a System on Chip (SoC).

In another embodiment, at least one of the computer devices, systems and apparatus may comprise a non-transitory computer readable medium such that data regarding a flow rate of fluid through the fluid passage or fluid pressure in is stored in the non-transitory computer readable medium. The data stored in the non-transitory computer readable medium may be provided to the communication module at some point for transmitting the data to another device that receives the data. In addition, a communications module (not shown) may also be included that is configured to transmit information signals.

The functions described regarding the at least one of the computer devices, systems and apparatus and other appropriate components may be performed by hardware or software. If the functions are performed by software, the software may reside in software memory (not shown) in the controller. The software in software memory may include an ordered listing of executable instructions for implementing logical functions (i.e., “logic” that may be implement either in digital form such as digital circuitry or source code or in analog form such as analog circuitry or an analog source such an analog electrical, sound or video signal), may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions.

In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples “a non-exhaustive list” of the computer-readable medium would include the following: an electrical connection “electronic” having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

While various details have been set forth in the foregoing description, it will be appreciated that the various aspects of a software application for mobile devices that provides users with suggested times for engaging in an activity for a given duration and in a specified location, based on outdoor conditions may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

Some or all of the embodiments described herein may generally comprise technologies for various aspects of the software application, or otherwise according to technologies described herein. In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. Those skilled in the art will recognize, however, that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Various aspects of the subject matter described herein are set out in the following numbered clauses:

1. A computer-implemented method for determining the optimal time to engage in an activity, the computer comprising a processor, a non-transitory memory, a display device for displaying information to the user, and an input device for receiving information and commands from the user, the method comprising: acquiring discreet data representing a condition over time, wherein the data includes data for one or more days; determining, by the processor, for each discreet data point from the data representing a condition over time, an accumulated value of the data points for a duration of time starting at the time of the data point; determining, by the processor, a lowest accumulated value and the timeframe at which the lowest accumulated value occurs, and a highest accumulated value and the timeframe at which the highest accumulated value occurs; displaying the data on a graph on the display device, wherein the graph includes the days and hours represented by the data; and displaying the lowest accumulated value and the highest accumulated value on a meter on the display device, wherein the meter includes the times at which the lowest accumulated value and the highest accumulated value occur.

2. The method of clause 1, comprising: determining, by the processor, a minimum accumulated value for the duration of time within one or more periods of time selected from the one or more days; displaying the start and end times of the timeframe at which the minimum accumulated value occurs on the graph; and displaying the minimum accumulated value on the meter.

3. The method of clause 2, further comprising displaying the minimum accumulated value relative to the lowest accumulated value and the highest accumulated value on the meter.

4. The method of clause 2, wherein the minimum accumulated value is adjusted for an expected level of activity.

5. The method of clause 2, comprising sharing, by the processor, the minimum accumulated value, the duration of time, and the start and end times with one or more of an email application, an text messaging application, an internet browser application, or a social media application.

6. The method of clause 1, comprising determining, by the processor, an accumulated value for the duration of time at a selected start time, and displaying the accumulated value on the meter.

7. The method of clause 6, further comprising displaying the accumulated value for the selected start time relative to the lowest accumulated value and the highest accumulated value on the meter.

8. The method of clause 6, wherein the accumulated value for the selected start time is adjusted for an expected level of activity.

9. The method of clause 6, comprising sharing, by the processor, the minimum accumulated value, the duration of time, and the start and end times with one or more of an email application, an text messaging application, an internet browser application, or a social media application.

10. The method of clause 6, comprising determining, by the processor, an accumulated value for the duration of time at more than one selected start time, and displaying each accumulated value on a separate meter.

11. The method of clause 6, comprising determining, by the processor, a minimum accumulated value for each of the one or more days, displaying the start and end times for each minimum accumulated value on the graph, and displaying each minimum accumulated value on the separate meters.

12. The method of clause 1, comprising determining, by the processor, a minimum accumulated value for the remainder of the current day or, when insufficient time is left in the current day, for the next day, displaying the start and end times for the minimum value for the current day or next day on the graph, and displaying the minimum value for the current day or next day on the meter.

13. The method of clause 1, wherein the data includes one or more of ozone levels, fine particle levels, dust levels, fire levels, smoke levels, nitrogen dioxide levels, sulfur dioxide levels, carbon monoxide levels, particle pollution levels, pollen levels, sun exposure levels, precipitation levels, or temperatures.

14. The method of clause 1, comprising acquiring data for the air quality of an indoor space and displaying the indoor air quality data on the graph.

15. The method of clause 14, comprising determining, by the processor, times when the outdoor air quality is such that openings to the indoor space should be opened or closed.

16. The method of clause 1, comprising determining, by the processor, relevant information based on a current location and discreet data point for the current time and displaying the information on the display device.

17. The method of clause 16, wherein the relevant information comprises health and safety information.

18. The method of clause 17, wherein the relevant information comprises products and services.

19. A computer-implemented method for determining the optimal time to engage in an activity, the computer comprising a processor, a non-transitory memory, a display device for displaying information to the user, and an input device for receiving information and commands from the user, the method comprising: acquiring discreet data representing a condition over time, wherein the data includes data for one or more days; displaying, the data on a map on the display device, wherein the map is operable to display the data over time and geographic area; determining, by the processor, for each discreet data point, an accumulated value of the data for a duration of time and for a distance around a point on the map; determining, by the processor, a lowest accumulated value and the time at which the lowest accumulated value occurs, and a highest accumulated value and the time at which the highest accumulated value occurs; determining, by the processor, an accumulated value at a timeframe represented by the map for the point on the map and the distance around that point; and displaying, by the processor, the accumulated at the time represented by the map, the lowest accumulated value, and the highest accumulated value on a meter on the display device, wherein the meter includes the times at which the lowest accumulated value and the highest accumulated value occur.

20. The method of clause 19, further comprising displaying the accumulated value at the time represented by the map relative to the lowest accumulated value and the highest accumulated value on the meter.

21. The method of clause 19, wherein the accumulated value at the time represented by the map is adjusted for an expected level of activity.

22. The method of clause 19, comprising sharing, by the processor, the accumulated value at the time represented by the map, the duration of time, and the start and end times with one or more of an email application, an text messaging application, an internet browser application or a social media application.

23. The method of clause 19, comprising determining, by the processor, an accumulated value of the data at a time represented by the map for more than one point on the map and a distance around the point, and displaying, by the processor, each accumulated value on a separate meter.

24. The method of clause 19, comprising displaying where on the map the data values are increasing in value or decreasing in value.

25. The method of clause 19, comprising determining, by the processor, a location on the map, defined by a point and a distance around the point, where the accumulated value of the data at the current time is a minimum.

26. The method of clause 19, comprising determining, by the processor, a route along which the values of the data are a minimum.

27. The method of clause 26, comprising: acquiring image data; acquiring, via the input device, a visual quality from the user; determining, by the processor, an amount of the visual quality present in the image data; and determining, by the processor, the route to the destination location, wherein the visual quality along the route is at maximum values.

28. The method of clause 19, comprising providing, by the processor, images of locations on the map for determining the present conditions at the locations.

29. A computer-implemented method for determining the optimal time to engage in an activity, the computer comprising a processor, a non-transitory memory, a display device for displaying information to the user, and an input device for receiving information and commands from the user, the method comprising: acquiring discreet data representing a condition over time, wherein the data includes data for one or more days; determining, by the processor, an expected accumulated value for a start time and for a duration of time; determining, by the processor, a current accumulated value from the start time to the present time; displaying the data on a graph on the display device, wherein the graph includes the days and hours represented by the data; displaying the start time and duration of time on the graph; displaying the current accumulated value as a function time lapsed since the start time on a lapsed time meter, and displaying the current accumulated value and the expected accumulated value on a meter on the display device.

30. The method of clause 29, wherein the expected accumulated value and current accumulated value are adjusted for a measured level of activity.

31. The method of clause 29, comprising displaying, by the processor, a measured heart rate.

32. A mobile device system comprising: a mobile device, comprising: an input device; a display device; a processor; and a memory coupled to the processor, wherein the memory stores program instructions that when executed from the memory cause the processor to: acquire discreet data representing a condition over time, wherein the data includes data for one or more days; determine for each discreet data point from the data representing a condition over time, an accumulated value of the data points for a duration of time starting at the time of the data point; determine a lowest accumulated value and the timeframe at which the lowest accumulated value occurs, and a highest accumulated value and the timeframe at which the highest accumulated value occurs; display the data on a graph on the display device, wherein the graph includes the days and hours represented by the data; and display the lowest accumulated value and the highest accumulated value on a meter on the display device, wherein the meter includes the times at which the lowest accumulated value and the highest accumulated value Occur.

33. The mobile device system of clause 32, wherein stored program instructions, when executed by the processor, cause the processor to: determine a minimum accumulated value for the duration of time within one or more periods of time selected from the one or more days; display the start and end times of the timeframe at which the minimum accumulated value occurs on the graph; and display the minimum accumulated value on the meter.

34. The mobile device system of clause 32, wherein stored program instructions, when executed by the processor, cause the processor to determine an accumulated value for the duration of time at a selected start time, and display the accumulated value on the meter.

35. The mobile device system of clause 32, wherein the data includes one or more of ozone levels, fine particle levels, dust levels, fire levels, smoke levels, nitrogen dioxide levels, sulfur dioxide levels, carbon monoxide levels, particle pollution levels, pollen levels, sun exposure levels, precipitation levels, or temperatures.

36. The mobile device system of clause 32, comprising a heart rate monitor operable to communicate with the mobile device, and wherein stored program instructions, when executed by the processor, cause the processor to display heart rate information on the display device.

37. The mobile device system of clause 32, comprising one or more atmospheric sensors operable to communicate with the mobile device, and wherein stored program instructions, when executed by the processor, cause the processor to display air quality data acquired by the one or more atmospheric quality sensors on the graph.

38. The mobile device system of clause 33, comprising a window opening device, and wherein stored program instructions, when executed by the processor, cause the processor to determine times when the outdoor air quality is such that windows to an indoor space should be opened or closed.

39. A mobile device system comprising: a mobile device, comprising: an input device; a display device; a processor; and a memory coupled to the processor, wherein the memory stores program instructions that when executed from the memory cause the processor to: acquire discreet data representing a condition over time, wherein the data includes data for one or more days; display the data on a map on the display device, wherein the map is operable to display the data over time and geographic area; determine for each discreet data point, an accumulated value of the data for a duration of time and for a distance around a point on the map; determine a lowest accumulated value and the time at which the lowest accumulated value occurs, and a highest accumulated value and the time at which the highest accumulated value occurs; determine an accumulated value at a timeframe represented by the map for the point on the map and the distance around that point; and display the accumulated at the time represented by the map, the lowest accumulated value, and the highest accumulated value on a meter on the display device, wherein the meter includes the times at which the lowest accumulated value and the highest accumulated value occur.

40. The mobile device system of clause 39, wherein stored program instructions, when executed by the processor, cause the processor to determine a location on the map, defined by a point and a distance around the point, where the accumulated value of the data at the current time is a minimum.

41. The mobile device system of clause 39, wherein stored program instructions, when executed by the processor, cause the processor to determine a route along which the values of the data are a minimum.

42. The mobile device system of clause 41, wherein stored program instructions, when executed by the processor, cause the processor to: acquire image data; acquire, via the input device, a visual quality from the user; determine an amount of the visual quality present in the image data; and determine the route to the destination location, wherein the visual quality along the route is at maximum values.

43. A mobile device system comprising: a mobile device, comprising: an input device; a display device; a processor; and a memory coupled to the processor, wherein the memory stores program instructions that when executed from the memory cause the processor to: acquire discreet data representing a condition over time, wherein the data includes data for one or more days; determine, an expected accumulated value for a start time and for a duration of time; determine by the processor, a current accumulated value from the start time to the present time; display the data on a graph on the display device, wherein the graph includes the days and hours represented by the data; display the start time and duration of time on the graph; display the current accumulated value as a function time lapsed since the start time on a lapsed time meter, and display the current accumulated value and the expected accumulated value on a meter on the display device.

What is claimed is:

1. A computer-implemented method for determining the optimal time to engage in an activity, the computer comprising a processor, a non-transitory memory, a display device for displaying information to the user, and an input device for receiving information and commands from the user, the method comprising:
acquiring discreet data representing a condition over time, wherein the data includes data for one or more days;
determining, by the processor, for each discreet data point from the data representing a condition over time, an accumulated value of the data points for a duration of time starting at the time of the data point;
determining, by the processor, a lowest accumulated value and the timeframe at which the lowest accumulated value occurs, and a highest accumulated value and the timeframe at which the highest accumulated value occurs;
displaying the data on a graph on the display device, wherein the graph includes the days and hours represented by the data; and
displaying the lowest accumulated value and the highest accumulated value on a meter on the display device, wherein the meter includes the times at which the lowest accumulated value and the highest accumulated value occur.

2. The method of claim 1, comprising:
determining, by the processor, a minimum accumulated value for the duration of time within one or more periods of time selected from the one or more days;
displaying the start and end times of the timeframe at which the minimum accumulated value occurs on the graph; and
displaying the minimum accumulated value on the meter.

3. The method of claim 2, further comprising displaying the minimum accumulated value relative to the lowest accumulated value and the highest accumulated value on the meter.

4. The method of claim 2, wherein the minimum accumulated value is adjusted for an expected level of activity.

5. The method of claim 2, comprising sharing, by the processor, the minimum accumulated value, the duration of time, and the start and end times with one or more of an email application, an text messaging application, an internet browser application, or a social media application.

6. The method of claim 1, comprising determining, by the processor, an accumulated value for the duration of time at a selected start time, and displaying the accumulated value on the meter.

7. The method of claim 6, further comprising displaying the accumulated value for the selected start time relative to the lowest accumulated value and the highest accumulated value on the meter.

8. The method of claim 6, wherein the accumulated value for the selected start time is adjusted for an expected level of activity.

9. The method of claim 6, comprising sharing, by the processor, the minimum accumulated value, the duration of time, and the start and end times with one or more of an email application, an text messaging application, an internet browser application, or a social media application.

10. The method of claim 6, comprising determining, by the processor, an accumulated value for the duration of time at more than one selected start time, and displaying each accumulated value on a separate meter.

11. The method of claim 6, comprising determining, by the processor, a minimum accumulated value for each of the one or more days, displaying the start and end times for each minimum accumulated value on the graph, and displaying each minimum accumulated value on the separate meters.

12. The method of claim 1, comprising determining, by the processor, a minimum accumulated value for the remainder of the current day or, when insufficient time is left in the current day, for the next day, displaying the start and end times for the minimum value for the current day or next day on the graph, and displaying the minimum value for the current day or next day on the meter.

13. The method of claim 1, wherein the data includes one or more of ozone levels, fine particle levels, dust levels, fire levels, smoke levels, nitrogen dioxide levels, sulfur dioxide levels, carbon monoxide levels, particle pollution levels, pollen levels, sun exposure levels, precipitation levels, or temperatures.

14. The method of claim 1, comprising acquiring data for the air quality of an indoor space and displaying the indoor air quality data on the graph.

15. The method of claim 14, comprising determining, by the processor, times when the outdoor air quality is such that openings to the indoor space should be opened or closed.

16. The method of claim 1, comprising determining, by the processor, relevant information based on a current location and discreet data point for the current time and displaying the information on the display device.

17. The method of claim 18, wherein the relevant information comprises health and safety information.

18. The method of claim 17, wherein the relevant information comprises products and services.

19. A computer-implemented method for determining the optimal time to engage in an activity, the computer comprising a processor, a non-transitory memory, a display device for displaying information to the user, and an input device for receiving information and commands from the user, the method comprising:
acquiring discreet data representing a condition over time, wherein the data includes data for one or more days;
displaying, the data on a map on the display device, wherein the map is operable to display the data over time and geographic area;
determining, by the processor, for each discreet data point, an accumulated value of the data for a duration of time and for a distance around a point on the map;
determining, by the processor, a lowest accumulated value and the time at which the lowest accumulated value occurs, and a highest accumulated value and the time at which the highest accumulated value occurs;
determining, by the processor, an accumulated value at a timeframe represented by the map for the point on the map and the distance around that point; and
displaying, by the processor, the accumulated at the time represented by the map, the lowest accumulated value, and the highest accumulated value on a meter on the display device, wherein the meter includes the times at which the lowest accumulated value and the highest accumulated value occur.

20. The method of claim 19, further comprising displaying the accumulated value at the time represented by the map relative to the lowest accumulated value and the highest accumulated value on the meter.

21. The method of claim 19, wherein the accumulated value at the time represented by the map is adjusted for an expected level of activity.

22. The method of claim 19, comprising sharing, by the processor, the accumulated value at the time represented by the map, the duration of time, and the start and end times with one or more of an email application, an text messaging application, an internet browser application or a social media application.

23. The method of claim 19, comprising determining, by the processor, an accumulated value of the data at a time represented by the map for more than one point on the map and a distance around the point, and displaying, by the processor, each accumulated value on a separate meter.

24. The method of claim 19, comprising displaying where on the map the data values are increasing in value or decreasing in value.

25. The method of claim 19, comprising determining, by the processor, a location on the map, defined by a point and a distance around the point, where the accumulated value of the data at the current time is a minimum.

26. The method of claim 19, comprising determining, by the processor, a route along which the values of the data are a minimum.

27. The method of claim 26, comprising:
acquiring image data;
acquiring, via the input device, a visual quality from the user;
determining, by the processor, an amount of the visual quality present in the image data; and
determining, by the processor, the route to the destination location, wherein the visual quality along the route is at maximum values.

28. The method of claim 19, comprising providing, by the processor, images of locations on the map for determining the present conditions at the locations.

29. A computer-implemented method for determining the optimal time to engage in an activity, the computer comprising a processor, a non-transitory memory, a display device for displaying information to the user, and an input device for receiving information and commands from the user, the method comprising:
acquiring discreet data representing a condition over time, wherein the data includes data for one or more days;
determining, by the processor, an expected accumulated value for a start time and for a duration of time;
determining, by the processor, a current accumulated value from the start time to the present time;
displaying the data on a graph on the display device, wherein the graph includes the days and hours represented by the data;
displaying the start time and duration of time on the graph;
displaying the current accumulated value as a function time lapsed since the start time on a lapsed time meter, and
displaying the current accumulated value and the expected accumulated value on a meter on the display device.

30. The method of claim 29, wherein the expected accumulated value and current accumulated value are adjusted for a measured level of activity.

31. The method of claim 29, comprising displaying, by the processor, a measured heart rate.

32. A mobile device system comprising:
a mobile device, comprising:
an input device;
a display device;
a processor; and
a memory coupled to the processor, wherein the memory stores program instructions that when executed from the memory cause the processor to:
acquire discreet data representing a condition over time, wherein the data includes data for one or more days;
determine for each discreet data point from the data representing a condition over time, an accumulated value of the data points for a duration of time starting at the time of the data point;
determine a lowest accumulated value and the timeframe at which the lowest accumulated value occurs, and a highest accumulated value and the timeframe at which the highest accumulated value occurs;
display the data on a graph on the display device, wherein the graph includes the days and hours represented by the data; and
display the lowest accumulated value and the highest accumulated value on a meter on the display device, wherein the meter includes the times at which the lowest accumulated value and the highest accumulated value occur.

33. The mobile device system of claim 32, wherein stored program instructions, when executed by the processor, cause the processor to:
determine a minimum accumulated value for the duration of time within one or more periods of time selected from the one or more days;
display the start and end times of the timeframe at which the minimum accumulated value occurs on the graph; and
display the minimum accumulated value on the meter.

34. The mobile device system of claim 32, wherein stored program instructions, when executed by the processor, cause the processor to determine an accumulated value for the duration of time at a selected start time, and display the accumulated value on the meter.

35. The mobile device system of claim 32, wherein the data includes one or more of ozone levels, fine particle levels, dust levels, fire levels, smoke levels, nitrogen dioxide levels, sulfur dioxide levels, carbon monoxide levels, particle pollution levels, pollen levels, sun exposure levels, precipitation levels, or temperatures.

36. The mobile device system of claim 32, comprising a heart rate monitor operable to communicate with the mobile device, and wherein stored program instructions, when executed by the processor, cause the processor to display heart rate information on the display device.

37. The mobile device system of claim 32, comprising one or more atmospheric sensors operable to communicate with the mobile device, and wherein stored program instructions, when executed by the processor, cause the processor to display air quality data acquired by the one or more atmospheric quality sensors on the graph.

38. The mobile device system of claim 33, comprising a window opening device, and wherein stored program instructions, when executed by the processor, cause the processor to determine times when the outdoor air quality is such that windows to an indoor space should be opened or closed.

39. A mobile device system comprising:
a mobile device, comprising:
an input device;
a display device;
a processor; and
a memory coupled to the processor, wherein the memory stores program instructions that when executed from the memory cause the processor to:
acquire discreet data representing a condition over time, wherein the data includes data for one or more days;
display the data on a map on the display device, wherein the map is operable to display the data over time and geographic area;
determine for each discreet data point, an accumulated value of the data for a duration of time and for a distance around a point on the map;
determine a lowest accumulated value and the time at which the lowest accumulated value occurs, and a highest accumulated value and the time at which the highest accumulated value occurs;
determine an accumulated value at a timeframe represented by the map for the point on the map and the distance around that point; and
display the accumulated at the time represented by the map, the lowest accumulated value, and the highest accumulated value on a meter on the display device, wherein the meter includes the times at which the lowest accumulated value and the highest accumulated value occur.

40. The mobile device system of claim 39, wherein stored program instructions, when executed by the processor, cause the processor to determine a location on the map, defined by a point and a distance around the point, where the accumulated value of the data at the current time is a minimum.

41. The mobile device system of claim 39, wherein stored program instructions, when executed by the processor, cause the processor to determine a route along which the values of the data are a minimum.

42. The mobile device system of claim 41, wherein stored program instructions, when executed by the processor, cause the processor to:
acquire image data;
acquire, via the input device, a visual quality from the user;
determine an amount of the visual quality present in the image data; and
determine the route to the destination location, wherein the visual quality along the route is at maximum values.

43. A mobile device system comprising:
a mobile device, comprising:
an input device;
a display device;
a processor; and
a memory coupled to the processor, wherein the memory stores program instructions that when executed from the memory cause the processor to:
acquire discreet data representing a condition over time, wherein the data includes data for one or more days;
determine, an expected accumulated value for a start time and for a duration of time;
determine by the processor, a current accumulated value from the start time to the present time;
display the data on a graph on the display device, wherein the graph includes the days and hours represented by the data;
display the start time and duration of time on the graph;
display the current accumulated value as a function time lapsed since the start time on a lapsed time meter, and
display the current accumulated value and the expected accumulated value on a meter on the display device.
